(19) United States
(12) Patent Application Publication
(10) Pub. No.: US 2024/0313557 A1
(43) Pub. Date: Sep. 19, 2024

(54) MULTI-PORT BATTERY PACK CHARGER

(71) Applicant: BLACK & DECKER INC., New Britain, CT (US)

(72) Inventors: Hussein M. NOSAIR, Parkville, MD (US); Brian K. WOHLTMANN, Shrewsbury, PA (US); John Kenrick Hans FUERTE, Bel Air, MD (US)

(21) Appl. No.: 18/605,785

(22) Filed: Mar. 14, 2024

Related U.S. Application Data
(60) Provisional application No. 63/490,161, filed on Mar. 14, 2023.

(51) Int. Cl. H02J 7/00; H02J 7/02

(52) U.S. Cl. CPC H02J 7/0044; H02J 7/0013; H02J 7/02; H02J 2207/20

(57) ABSTRACT

The present disclosure is directed to a multi-port battery pack charger. The charger includes at least two receptacles for coupling with and charging at least two battery packs. The charge includes at least two AC to DC power supplies for providing a DC charging current to charge the at least two battery packs. The charger also includes a bridge assembly circuit to enable the charger to share the charging current provided by the at least two power supplies amongst the at least two receptacles.

### RELATED APPLICATIONS

This application claims priority under 35 U.S.C. § 119(e) to U.S. Provisional Patent Application No. 63/490,161, filed Mar. 14, 2023, titled “Multi-Port Battery Pack Charger.”

### TECHNICAL FIELD

This application relates to a multi-port battery pack charger and a method for charging a plurality of battery packs. In one implementation, the battery pack includes two-ports for receiving two battery packs.

### BACKGROUND

The time it takes to recharge a battery pack can limit the amount of work a user can perform. The ability to quickly recharge a battery pack is a highly desirable feature in a charger.

Typically, battery pack chargers for charging rechargeable battery packs include a single AC-DC power supply to provide power to one or more receptacles for the battery packs or a plurality of AC-DC power supplies in which each of the AC-DC power supplies provide power to only one of an equal plurality of receptacles. Such configurations limit the amount of charging current that can be supplied to each individual receptacle to the amount of charging current that the power supply can produce. This limitation limits the time it will take to charge the battery pack. If a battery pack is capable of receiving a given amount of charging current and a power supply is incapable of providing that maximum charging current, the charger will not be able to charge the battery pack in its fastest time.

The instant application describes an exemplary battery pack charger for charging a battery pack at its maximum charge rate.

### SUMMARY

An aspect of the present invention includes a battery pack charger, including a housing; a first receptacle incorporated in the housing for receiving a battery pack; a second receptacle incorporated in the housing for receiving a battery pack; a first AC to DC power supply housed within the housing; a second AC to DC power supply housed within the housing; a processing unit housed within the housing, the processing unit electrically coupled to the first power supply to enable the processing unit to configure the first power supply to provide an amount of charging current and electrically coupled to the second power supply to configure the second power supply to provide an amount of charging current; and a bridge assembly circuit housed within the housing, the bridge assembly circuit electrically coupled to the first power supply and the second power supply to receive the amount charging current from the first power supply and the amount of charging current from the second power supply and electrically coupled to the processing unit to enable the processing unit to configure the bridge assembly circuit to direct all of or less than all of the amount of charging current from the first power supply to the first receptacle and all of or less than all of the amount of charging current from the second power supply to the first receptacle and all of or less than all of the amount of charging current from the first power supply to the second receptacle and all of or less than all of the amount of charging current from the second power supply to the second receptacle.

Another aspect of the present invention includes a battery pack charger, wherein the bridge assembly circuit directs all of the amount of charging current from the first power supply and all of the amount of charging current from the second power supply to the first receptacle.

Another aspect of the present invention includes a battery pack charger, wherein the bridge assembly circuit directs all of the amount of charging current from the first power supply and less than all of the amount of charging current from the second power supply to the first receptacle and less than all of the amount of charging current from the second power supply to the second receptacle.

Another aspect of the present invention includes a battery pack charger, wherein the bridge assembly circuit comprises at least one current limiting circuit.

Another aspect of the present invention includes a battery pack charger, wherein the at least one current limiting circuit is a buck converter circuit.

Another aspect of the present invention includes a battery pack charger, wherein the bridge assembly circuit comprises a first switch and a second switch to direct the amount of charging current from the first power supply and the amount of charging current from the second power supply to the first receptacle and/or the second receptacle.

Implementations of this aspect may include one or more of the following features.

Advantages may include one or more of the following.

These and other advantages and features will be apparent from the description and the drawings.

### BRIEF DESCRIPTION OF THE DRAWINGS

FIG. 1A illustrates an example single port battery pack charger and FIG. 1B illustrates an example basic block diagram of the battery pack charger of FIG. 1A.

FIG. 2A illustrates an example multi-port battery pack charger and FIG. 2B illustrates an example basic block diagram of the battery pack charger of FIG. 2A.

FIG. 3 illustrates an example set of removable, rechargeable battery packs.

FIGS. 4A and 4B illustrate an example multi-port battery pack charger.

FIG. 5 illustrates the example battery pack charger of FIGS. 4A and 4B and a pair of example battery packs coupled to the battery pack charger.

FIG. 6 illustrates an example block diagram of the example battery pack charger of FIGS. 4A and 4B.

FIG. 7A illustrates a first example of a bridge circuit, FIG. 7B illustrates a second example of a bridge circuit of the battery pack charger of FIG. 6, FIG. 7C illustrates a block diagram of an example current limiting circuit, and FIG. 7D illustrates a block diagram of another example current limiting circuit.

FIG. 8A illustrates a first example truth table for controlling the bridge circuit of the example battery pack charger of FIG. 6, FIG. 8B illustrates a block diagram of a first example driver circuit, and FIG. 8C illustrates a second example truth table for controlling the bridge circuit of FIG. 8B.

FIG. 9A illustrates block diagram of a second example driver circuit and FIG. 9B illustrates an example truth table for controlling the example driver circuit of FIG. 9A.

FIG. 10A illustrates another example truth table for controlling the bridge circuit of the battery pack charger of FIG. 17, FIG. 10B illustrates another example driver circuit of the example battery pack charger of FIG. 6 and FIG. 10C illustrates an example truth table for controlling the example driver circuit of FIG. 10B.

FIG. 11A illustrates an example driver circuit of the example battery pack charger of FIG. 6 and FIG. 11B illustrates an example truth table for controlling the example driver circuit of FIG. 11A.

FIG. 12 illustrates the example battery pack charger of FIG. 6 coupled to a first example battery pack and a scheme for charging the first example battery pack.

FIG. 13 illustrates the example battery pack charger of FIG. 6 coupled to a second example battery pack and a scheme for charging the second example battery pack.

FIG. 14 illustrates the example battery pack charger of FIG. 6 coupled to a first example battery pack and a second example battery pack and a scheme for charging the first example battery pack and the second example battery pack.

FIG. 15 illustrates the example battery pack charger of FIG. 6 coupled to a first example battery pack and a scheme for charging the first example battery pack.

FIG. 16 illustrates the example battery pack charger of FIG. 6 coupled to a second example battery pack and a scheme for charging the second example battery pack.

FIG. 17 illustrates the example battery pack charger of FIG. 6 coupled to a first example battery pack and a second example battery pack and a scheme for charging the first example battery pack and the second example battery pack.

FIG. 18 illustrates the example battery pack charger of FIG. 6 coupled to a first example battery pack and a second example battery pack and a scheme for charging the first example battery pack and the second example battery pack.

FIG. 19 illustrates the example battery pack charger of FIG. 6 coupled to a first example battery pack and a second example battery pack and a scheme for charging the first example battery pack and the second example battery pack.

FIG. 20 illustrates the example battery pack charger of FIG. 6 coupled to a first example battery pack and a second example battery pack and a scheme for charging the first example battery pack and the second example battery pack.

FIG. 21A illustrates a simplified block diagram of the example battery pack charger of FIG. 6 coupled to a first example battery pack and a scheme for charging the first example battery pack; FIG. 21B illustrates a simplified block diagram of the example battery pack charger of FIG. 6 coupled to a first example battery pack and a scheme for charging the first example battery pack; FIG. 21C illustrates a simplified block diagram of the example battery pack charger of FIG. 6 coupled to a first example battery pack and a scheme for charging the first example battery pack; and FIG. 21D illustrates a simplified block diagram of the example battery pack charger of FIG. 6 coupled to a first example battery pack and a second example battery pack and a scheme for charging the first example battery pack and the second example battery pack.

FIG. 22 illustrates a simplified block diagram of the example battery pack charger of FIG. 6 coupled to a first example battery pack and a second example battery pack and a scheme for charging the first example battery pack and the second example battery pack.

FIGS. 23A-23D illustrate a simplified block diagram of the example battery pack charger of FIG. 6 coupled to various first and second example battery packs and a various schemes for charging the various first and second example battery packs.

FIG. 24 illustrates a simplified block diagram of the example battery pack charger of FIG. 6 coupled to a first example battery pack and a second example battery pack and a scheme for charging the first example battery pack and the second example battery pack.

FIG. 25 illustrates a simplified block diagram of the example battery pack charger of FIG. 6 coupled to a first example battery pack and a second example battery pack and a scheme for charging the first example battery pack and the second example battery pack.

FIG. 26 illustrates a simplified block diagram of the example battery pack charger of FIG. 6 coupled to a first example battery pack and a second example battery pack and a scheme for charging the first example battery pack and the second example battery pack.

FIG. 27 illustrates a simplified block diagram of the example battery pack charger of FIG. 6 coupled to a first example battery pack and a second example battery pack and a scheme for charging the first example battery pack and the second example battery pack.

FIG. 28 illustrates a simplified block diagram of the example battery pack charger of FIG. 6 coupled to a first example battery pack and a second example battery pack and a scheme for charging the first example battery pack and the second example battery pack.

FIG. 29 illustrates a simplified block diagram of the example battery pack charger of FIG. 6 coupled to a first example battery pack and a second example battery pack and a scheme for charging the first example battery pack and the second example battery pack.

FIG. 32 illustrates a simplified block diagram of an example embodiment of battery pack charger coupled to a first example battery pack and a second example battery pack and a scheme for charging the first example battery pack and the second example battery pack.

FIG. 33 illustrates a simplified block diagram of an example embodiment of battery pack charger coupled to a first example battery pack and a second example battery pack and a scheme for charging the first example battery pack and the second example battery pack.

FIG. 34 illustrates a simplified block diagram of an example embodiment of battery pack charger coupled to a first example battery pack and a second example battery pack and a scheme for charging the first example battery pack and the second example battery pack.

FIG. 35 illustrates a simplified block diagram of an example embodiment of battery pack charger coupled to a first example battery pack and a second example battery pack and a scheme for charging the first example battery pack and the second example battery pack.

FIG. 36 illustrates a charging times and state of charge (SOC) of various example battery packs using various charging schemes.

FIGS. 37A-37 H illustrate tables describing various example charging schemes using the example battery pack charger of FIGS. 6 and 15-20.

FIGS. 38-133 illustrate various example of charging schemes detailed in FIGS. 37A—37H.

FIGS. 134-138 illustrate a block diagram of another example bridge assembly circuit.

FIGS. 139-143 illustrate a block diagram of another example bridge assembly circuit.

FIGS. 144-145 illustrate a block diagram of another example bridge assembly circuit.

FIGS. 146-147 illustrate a block diagram of another example bridge assembly circuit.

### DETAILED DESCRIPTION

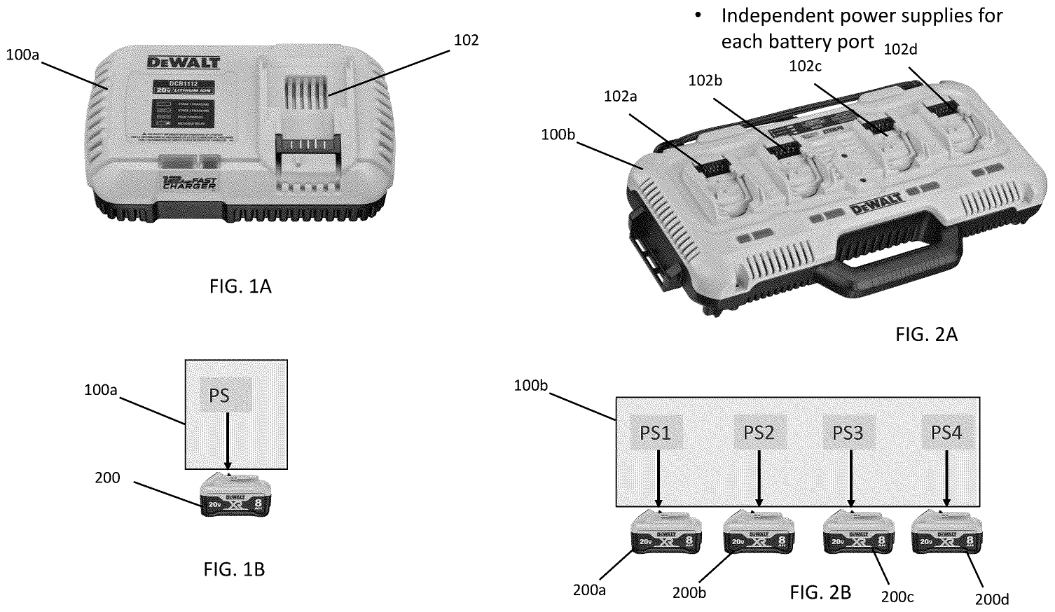

Referring to FIGS. 1A and 1B, there is illustrated an example battery pack charger 100a. This example battery pack charger 100a includes a single port (also referred to as a receptacle) 102 for receiving and coupling (mating) with a removable, rechargeable battery pack 200. As illustrated in FIG. 1B, this example battery pack charger 100a includes a single power supply (PS) for providing power to a port 102 when a battery pack 200 is coupled to the port. More specifically, the charger 100a receives AC power (alternating current and voltage) from a source, for example, a mains power line-a wall socket, a generator, etc. The power supply PS converts the AC power to DC power (direct current and voltage) to charge the battery pack 200.

Referring to FIGS. 2A and 2B, there is illustrated another example battery pack charger 100b. This example battery pack charger 100b includes four ports 102a, 102b, 102c, 102d for receiving and coupling with one to four removable, rechargeable battery packs 200a, 200b, 200c, 200d at any one time. As illustrated in FIG. 2B, this example battery pack charger 100b includes an independent power supply for each battery pack port. Specifically, this battery pack charger includes four power supplies (PS1, PS2, PS3, PS4) for providing power to the ports 102a, 102b, 102c, 102d, respectively, when a battery pack is coupled to the port. Each power supply is coupled to one and only one port and therefore, each power supply is only capable of providing power to a single port.

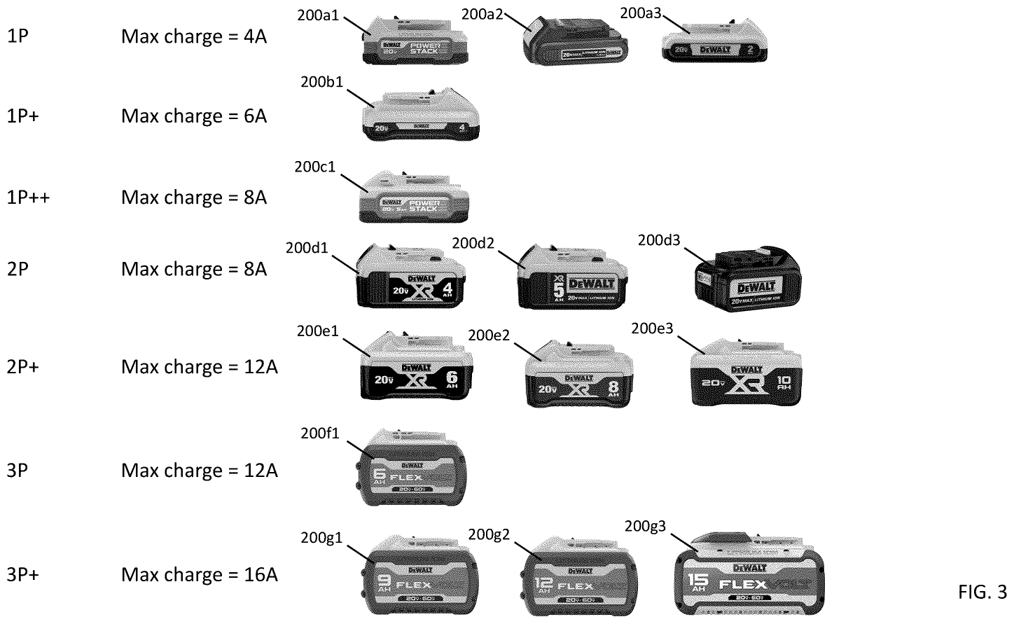

Referring to FIG. 3, there is illustrated an example set of example removable, rechargeable battery packs. The example set of includes subsets of example battery pack. A first subset 200a of battery packs may include one or more battery packs having a plurality of battery cells wherein the plurality of battery cells is connected in one string of battery cells connected in series (1P) and the battery pack having this plurality of battery cells connected in this configuration is capable of being charged at a first maximum charging current, for example 4 amperes (A), i.e., receiving a maximum charging current of 4 A. The battery packs in this first subset 200a are sometimes referred to as 1P battery packs.

A second subset 200b of battery packs may include one or more battery packs having a plurality of battery cells wherein the plurality of battery cells is connected in one string of battery cells connected in series (1P) and the battery pack having this plurality of battery cells connected in this configuration is capable of being charged at a second maximum charging current that is greater than the first maximum charging current, for example 6 amperes (A), i.e., receiving a maximum charging current of 6 A. The battery packs in this second subset 200b are sometimes referred to as 1P+ battery packs.

A third subset 200c of battery packs may include one or more battery packs having a plurality of battery cells wherein the plurality of battery cells is connected in one string of battery cells connected in series (1P) and the battery pack having this plurality of battery cells connected in this configuration is capable of being charged at a third maximum charging current that is greater than the second maximum charging current, for example 8 amperes (A), i.e., receiving a maximum charging current of 8 A. The battery packs in this third subset 200c are sometimes referred to as 1P++ battery packs.

A fourth subset 200d of battery packs may include one or more battery packs having a plurality of battery cells wherein the plurality of battery cells is connected in two strings of battery cells connected in parallel and wherein the battery cells in each string of battery cells are connected series (2P) and the battery pack having this plurality of battery cells connected in this configuration is capable of being charged at the third maximum charging current, for example 8 amperes (A), i.e., receiving a maximum charging current of 8 A. The battery packs in this fourth subset 200d are sometimes referred to as 2P battery packs.

A fifth subset 200e of battery packs may include one or more battery packs having a plurality of battery cells wherein the plurality of battery cells is connected in two strings of battery cells connected in parallel and wherein the battery cells in each string of battery cells are connected series (2P) and the battery pack having this plurality of battery cells connected in this configuration is capable of being charged at a fourth maximum charging current, for example 12 amperes (A), i.e., receiving a maximum charging current of 12 A. The battery packs in this fifth subset 200e are sometimes referred to as 2P+ battery packs.

A sixth subset 200f of battery packs may include one or more battery packs having a plurality of battery cells wherein the plurality of battery cells is connected in three strings of battery cells connected in parallel and wherein the battery cells in each string of battery cells are connected series (3P) and the battery pack having this plurality of battery cells connected in this configuration is capable of being charged at the fourth maximum charging current, for example 12 amperes (A), i.e., receiving a maximum charging current of 12 A. The battery packs in this sixth subset 200f are sometimes referred to as 3P battery packs.

A seventh subset 200g of battery packs may include one or more battery packs having a plurality of battery cells wherein the plurality of battery cells is connected in three strings of battery cells connected in parallel and wherein the battery cells in each string of battery cells are connected series (3P) and the battery pack having this plurality of battery cells connected in this configuration is capable of being charged at a fifth maximum charging current, for example 16 amperes (A), i.e., receiving a maximum charging current of 16 A. The battery packs in this seventh subset 200g are sometimes referred to as 3P+ battery packs.

The capacity of these packs 200 is dependent upon the capacity of the battery cells and the configuration or connection of the strings of battery cells. For example, a 1P pack having one string of 1.7 Ampere-hour (AHr) battery cells connected in series will have a capacity of 1.7 AHr while a 2P pack having two strings of battery cells connected in parallel wherein each string includes a plurality of 1.7 AHr battery cells connected in series will have a capacity of 3.4 AHr. In another example, a 2P pack having two strings of battery cells connected in parallel wherein each string includes a plurality of 5 AHr battery cells connected in series will have a capacity of 10 AHr while a 3P pack having three strings of battery cells connected in parallel wherein each string includes a plurality of 5 AHr battery cells connected in series will have a capacity of 15 AHr.

The example set of example battery packs may include additional or alternate types of battery packs having different configurations including being able to receive a higher maximum current or having a greater capacity.

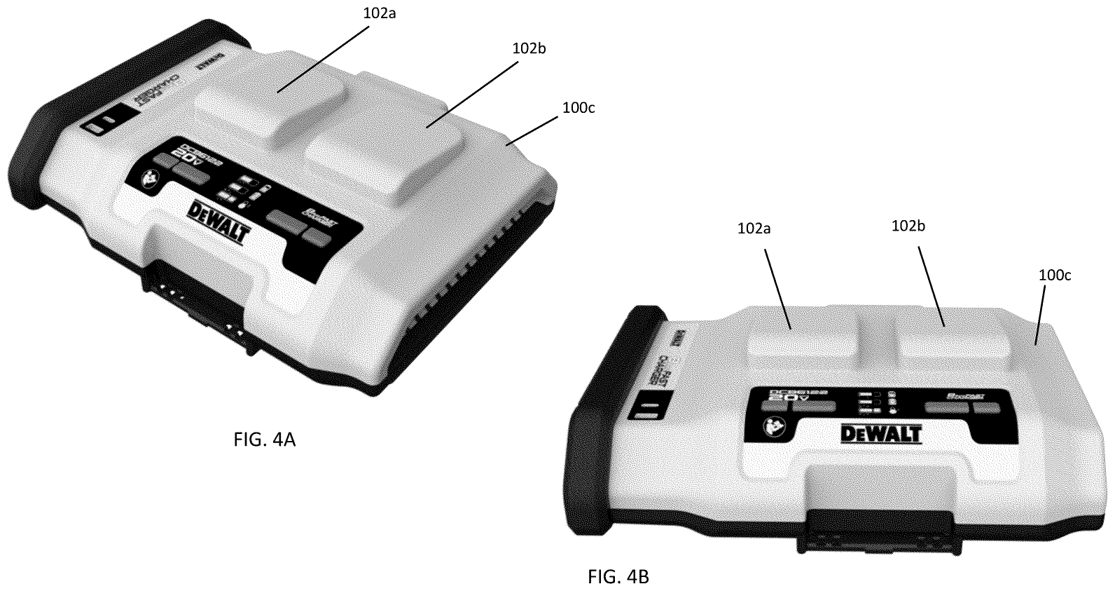

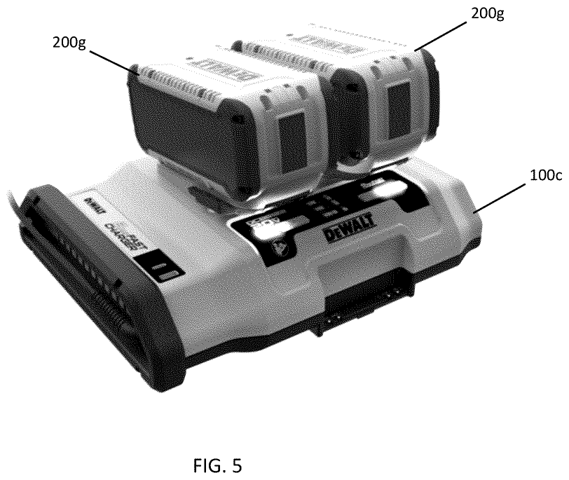

Referring to FIGS. 4A and 4B, there is illustrated an example embodiment of a multi-port battery pack charger 100c. This example battery pack charger 100c includes two ports (receptacles) 102a, 102b for receiving a maximum of two battery packs at one time. Alternate example embodiments may have more than two ports.

As illustrated in FIGS. 4A and 4B, the battery pack charger 100c includes a first port 102a for electrically and mechanically coupling with a removable, rechargeable battery pack and a second port 102b for electrically and mechanically coupling with a removable, rechargeable battery pack. FIG. 5 illustrates two example battery packs 200g coupled to the example battery pack charger 100c. As described in more detail below, the charger 100c may include independent AC-DC power supplies and a bridge assembly circuit and various control algorithms to direct available charging current from a single power supply to multiple charging ports. The charger 100c may identify various battery packs that are coupled to the charger 100c and determine the maximum charging current the battery pack is capable of accepting. The ability to share charging current amongst multiple charging ports enables the charger 100c to achieve reduced charge times as compared to a charger that is unable to share charging current.

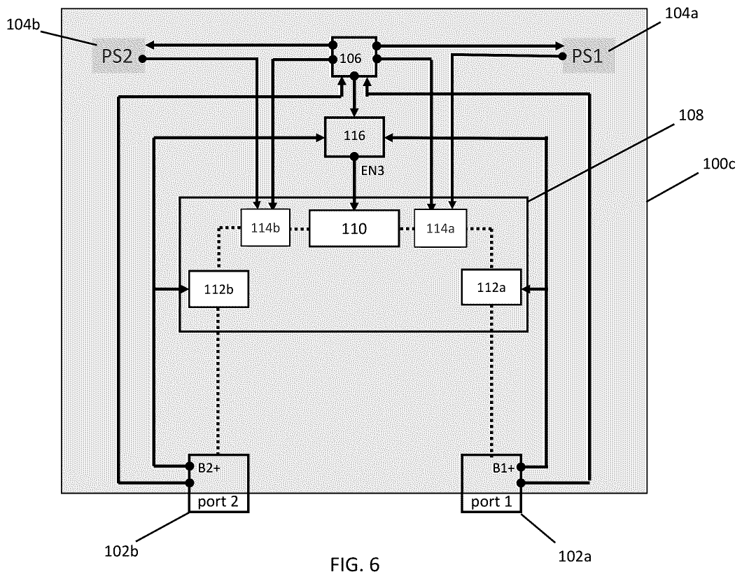

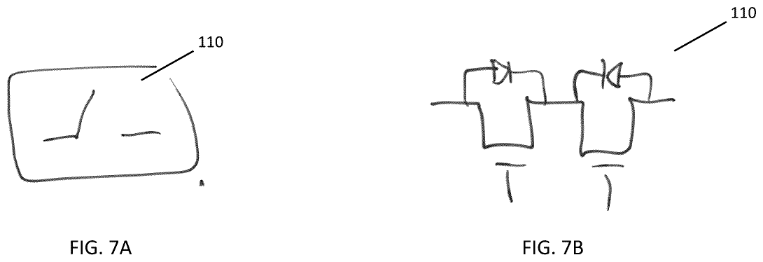

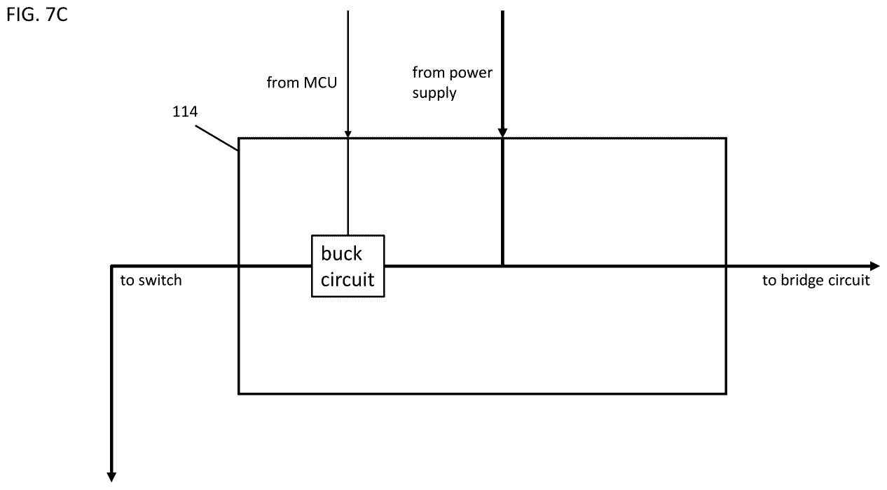

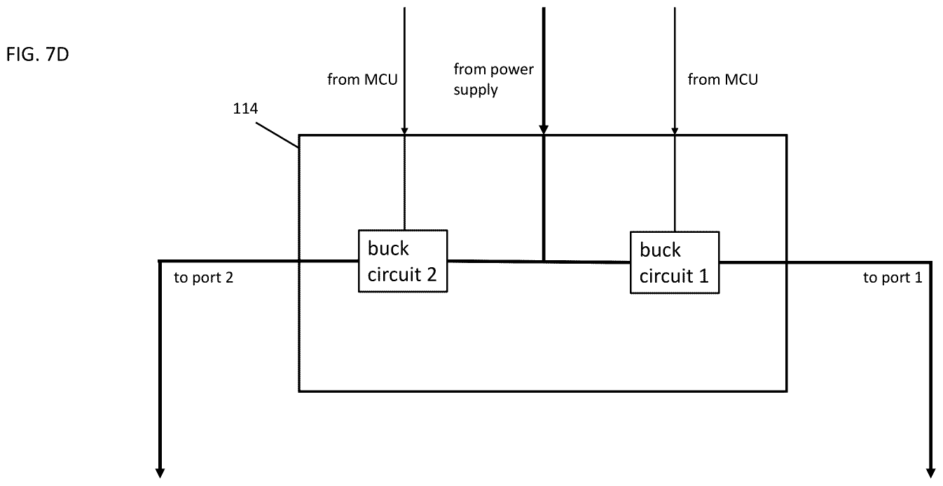

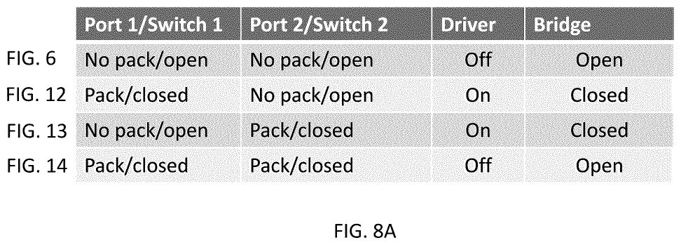

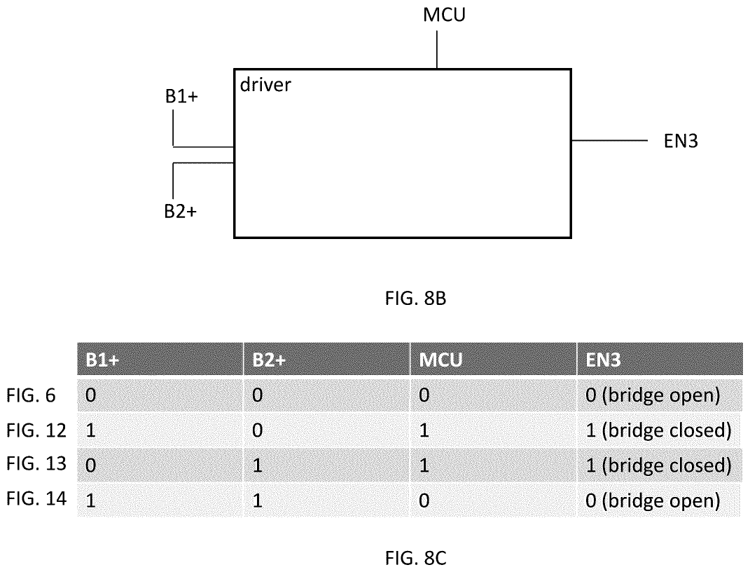

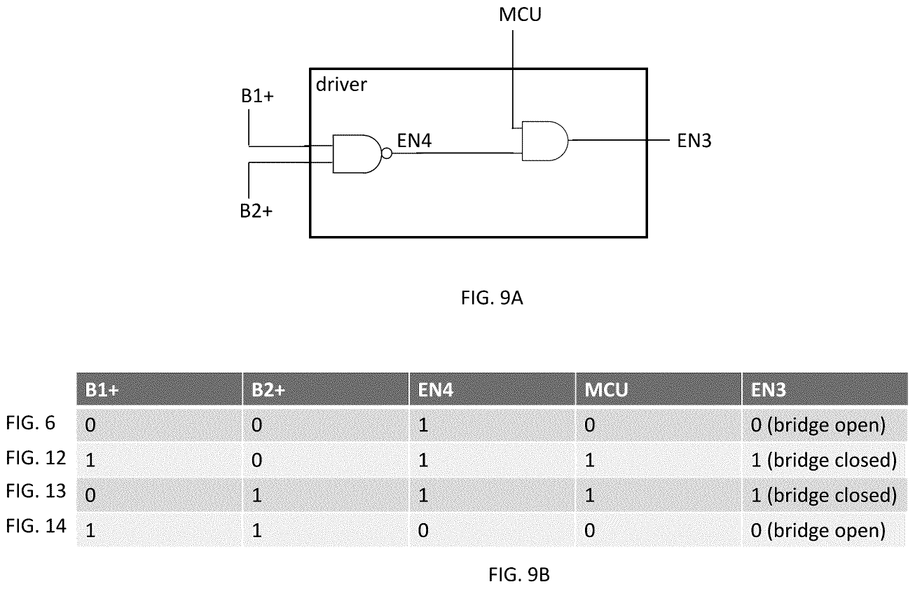

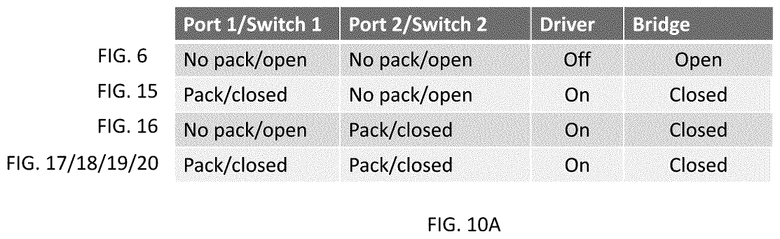

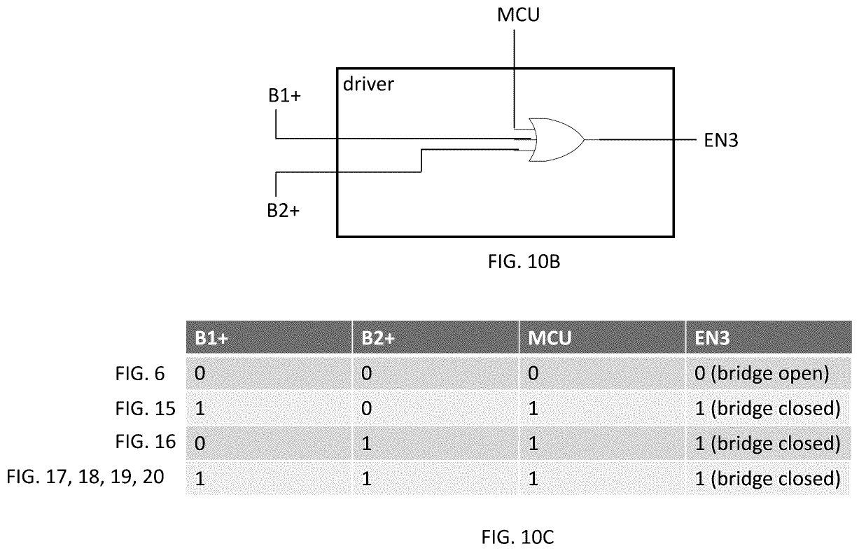

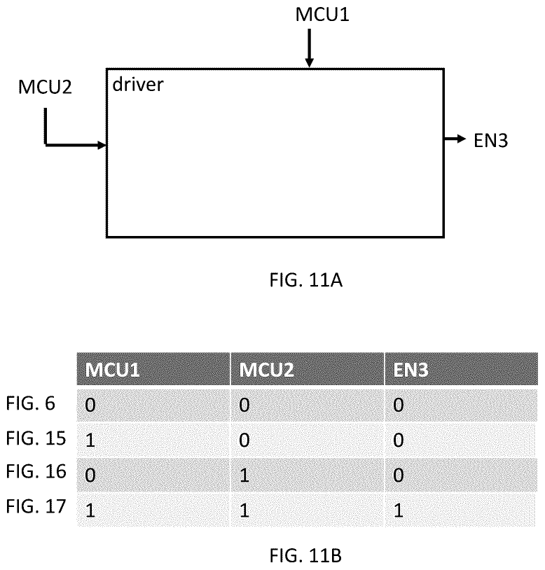

Referring to FIG. 6, there is illustrated a block diagram of the example battery pack charger 100c of FIGS. 4A, 4B and 5. The battery pack charger 100c may include additional components that are not shown for purposes of simplicity and clarity but which would be understood by one of ordinary skill in the art.

As illustrated in FIG. 6, the battery pack charger 100c (also referred to simply as a charger) includes a first port (port 1) or receptacle 102a for receiving and mating with a battery pack and a second port (port 2) or receptacle 102b for receiving and mating with a battery pack. The charger 100c may couple with a single battery pack in either port or may couple with two battery packs—one battery pack in each port.

The charger 100c may also include a first power supply (PS1) 104a and a second power supply (PS2) 104b for providing charging power to the first and second ports 102a, 102v, as described in detail below and in the figures. The charger 100c may also include a microprocessor 106—also sometimes referred to as a processor or master control unit (MCU)—to control various other components of the charger 100c.

The charger 100c may also include a bridge circuit assembly 108. The bridge circuit assembly 108 may include a bridge circuit 110, a first switch 112a, a second switch 112b, a first current limiting circuit 114a and a second current limiting circuit 114b. The first current limiting circuit 114a and the second current limiting circuit 114b limit the amount of charging current that flows to the first port 102a or to the second port 102b, respectively. In other words, the current limiting circuits 114a, 114b serve to pass or divert charging current. The charger 100c may also include a driver circuit 116.

The driver circuit 116, using input from the MCU 106 and the ports 102a, 102b, may control the bridge circuit 110. The MCU 106, using input from the ports 102a, 102b, may control the power supplies 104a, 104b, the driver circuit 116 and the current limiting circuits 114a, 114b.

The bridge circuit assembly 108, using input from the driver circuit 116, the MCU 106 and the ports 102a, 102b controls the sharing of the power from the power supplies 104a, 104b to the ports 102a, 102b.

The bridge circuit 110 may be any electronic or electromechanical component that allows current to flow in two opposite directions and that may be operated as an ON/OFF switch. In the example charger 100c illustrated in FIG. 6, the current could flow either from the first current limit circuit 1 (CL1) 114a to the second current limit circuit (CL2) 114b or from the second current limit circuit CL2 114b to the first current limit circuit CL1 114a.

In a first example embodiment, as illustrated in FIG. 7A, the bridge circuit 110 may be a mechanical DC relay switch that allows current to flow in two directions. Such a switch would be controlled to open or close by the output of the driver circuit 116. In a second example embodiment, as illustrated in FIG. 7B, the bridge circuit 110 may be a back-to-back MOSFET circuit to allow current to flow in two directions. Such a MOSFET circuit would be controlled to open or close in a particular direction by the output of the driver circuit 116.

As illustrated in FIG. 7C, the current limiting circuits 114 may include a buck converter circuit. The buck converter circuit receives control signals from the MCU 106. The buck converter circuit also receives charging current from the power supply 104. Based on the control signals from the MCU 106, the buck converter circuit is configured to allow a specified amount of charging current to pass from the current limiting circuit 114 to the switch 112. If more charging current is supplied to the buck converter circuit from the power supply than the buck converter circuit allows to pass, the remainder of the charging current may flow to the bridge circuit 110, the other current limiting circuit, the other switch and to the other battery port, depending upon the state of the bridge circuit 110, the other current limiting circuit 114 and the other switch 112.

In this example embodiment, the current limiting circuits 114 are configured to allow a maximum current equal to the sum of the maximum current that may be provided from the combined power supplies. For example, if each power supply is capable of providing 8 amperes of charging current than each current limiting circuit will be configured to allow 16 A of charging current to pass. The buck converter circuits may also be configured to not allow any charging current to pass. In a particular example, the power supply may be capable of providing 8 A of charging current and configured by the MCU (based on information from the ports) to provide 6 A of charging current and the current limiting circuit/buck converter circuit may be configured to allow 4 A of charging current to pass. If the bridge circuit 110 is closed, the remaining 2 A of charging current will be allowed to pass to the other current limiting circuit. And, if the other current limiting circuit is configured to allow current from the second power supply plus the current from the first power supply to pass than the 2 A of charging current from the first power supply that did not pass the first current limiting circuit will be directed to the second switch and potentially to the second port.

Referring to FIG. 8A, there is illustrated a truth table defining when the switches 112a, 112b will be open or closed, when the driver circuit 116 is set to on and when the bridge circuit 110 is closed for a charger that is configured to not share charging current from multiple power supplies amongst multiple charging ports. In this example embodiment, each port 102 is supplied charging current from only one of the power supplies 104. In other words, the first port 102a only receives charging current from the first power supply 104a and the second port 102b only receives charging current from the second power supply 104b.

In a first circumstance, with reference to FIG. 6, neither port 102 is coupled to a battery pack, both of the switches 112 are set to an open state, the driver circuit 116 is set to provide an off signal to the bridge circuit 110 and the bridge circuit 110 is set to an open state. Furthermore, the power supplies PS1, PS2 are set to provide OA. As such, no current will flow into or out of the bridge circuit assembly 108.

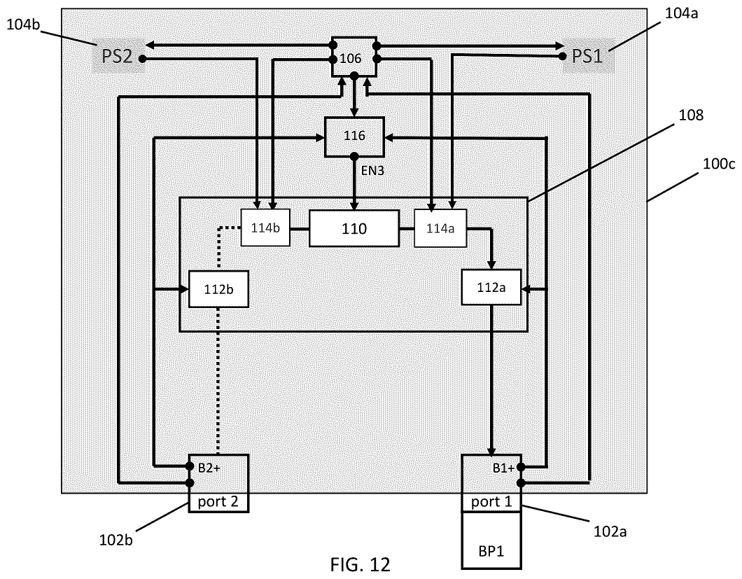

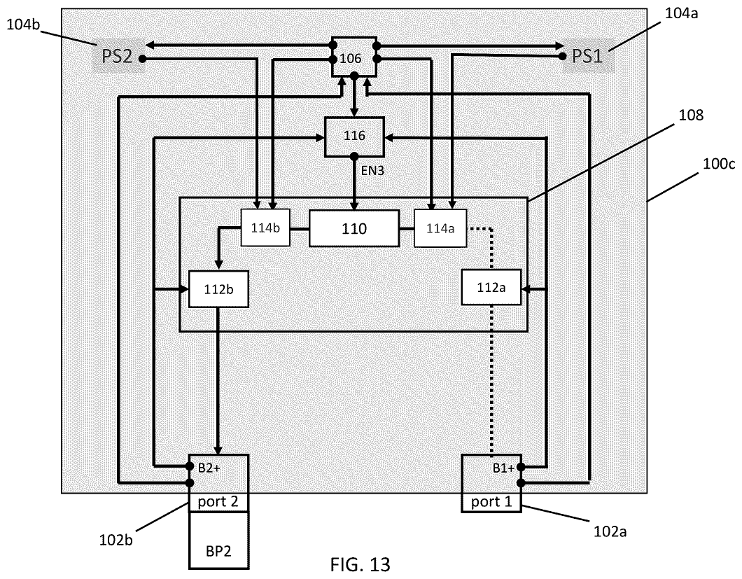

In a second circumstance, with reference to FIG. 12, the first port 102a is coupled to a battery pack BP1 and the second port 102b is not coupled to a battery pack, the first switch 112a is set to a closed state, the second switch 112b is set to an open state, the driver circuit 116 is set to provide an on signal to the bridge circuit 110 and the bridge circuit 110 is set to a closed state. Furthermore, the MCU 106 configures the first power supply PS1 104a to provide a charging current based on information received from the battery pack BP1 through the first port 102a and configures the second power supply PS2 104b to provide no charging current based on information (or a lack of information) received from the second port 102b. As such, while the bridge circuit 110 is able to pass current from the second current limiting circuit 114b to the first current limiting circuit 114a, there is no current from the second power supply PS2 104b to pass. Therefore, the battery pack BP1 only receives charging current from the first power supply 104a.

In a third circumstance, with reference to FIG. 13, the second port 102b is coupled to a battery pack BP2 and the first port 102a is not coupled to a battery pack, the second switch 112b is set to a closed state, the first switch 112a is set to an open state, the driver circuit 116 is set to provide an on signal to the bridge circuit 110 and the bridge circuit 110 is set to a closed state. Furthermore, the MCU 106 configures the second power supply PS2 104b to provide a charging current based on information received from the battery pack BP2 through the second port 102b and configures the first power supply PS1 104a to provide no charging current based on information (or a lack of information) received from the first port 102a. As such, while the bridge circuit 110 is able to pass current from the first current limiting circuit 114a to the second current limiting circuit 114b, there is no current from the first power supply PS1 104a to pass. Therefore, the battery pack BP2 only receives charging current from the second power supply 104b.

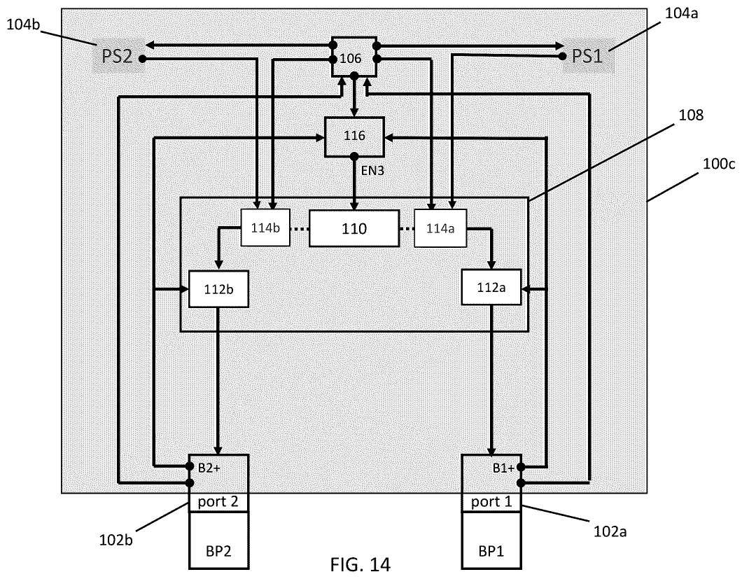

In a fourth circumstance, with reference to FIG. 14, the first port 102a is coupled to a battery pack BP1 and the second port 102b is coupled to a battery pack BP2, the first switch 112a is set to a closed state and the second switch 112b is set to a closed state, the driver circuit 116 is set to provide an off signal to the bridge circuit 110 and the bridge circuit 110 is set to an open state. Furthermore, the MCU 106 configures the first power supply 104a to provide a charging current based on information received from the battery pack BP1 through the first port 102a and configures the second power supply 104b to provide a charging current based on information received from the battery pack BP2 through the second port 102b. As such, as the bridge circuit 110 is open and not able to pass current from the first current limiting circuit 114a to the second current limiting circuit 114b or vice versa. Therefore, the battery pack BP1 only receives charging current from the first power supply 104a and the battery pack BP2 only receives charging current from the second power supply 104b.

Referring to FIG. 8B, there is illustrated a truth table defining when the switches 112a, 112b will be open or closed, when the driver circuit 116 is set to on and when the bridge circuit 110 is closed. In this example embodiment, each port 102 may be supplied charging current from one or both of the power supplies 104. In other words, the first port 102a may receive charging current from the first power supply 104a and/or the second power supply 104b and the second port 102b may also receive charging current from the first power supply 104a and/or the second power supply 104b.

In a first circumstance, with reference to FIG. 6, neither port 102 is coupled to a battery pack, both of the switches 112 are set to an open state, the driver circuit 116 is set to provide an off signal to the bridge circuit 110 and the bridge circuit 110 is set to an open state. Furthermore, the power supplies PS1, PS2 are set to provide OA. As such, no current will flow into or out of the bridge circuit assembly 108.

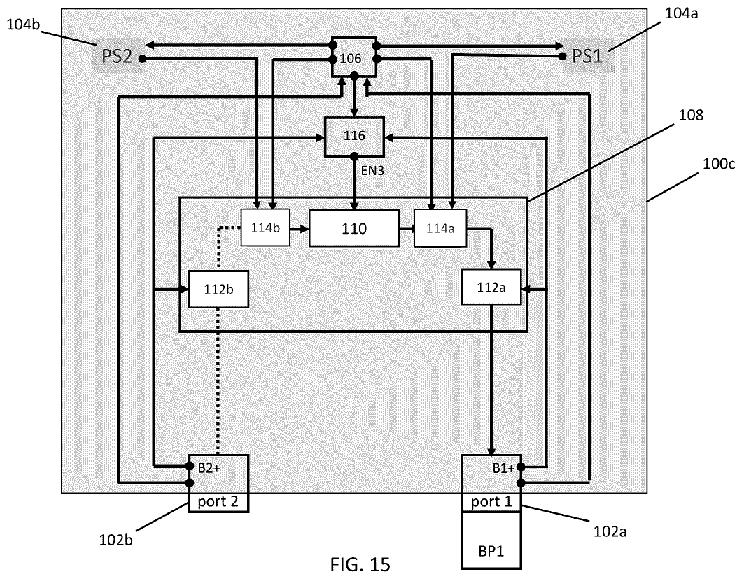

In a second circumstance, with reference to FIG. 15, the first port 102a is coupled to a battery pack BP1 and the second port 102b is not coupled to a battery pack, the first switch 112a is set to a closed state, the second switch 112b is set to an open state, the driver circuit 116 is set to provide an on signal to the bridge circuit 110 and the bridge circuit 110 is set to a closed state. Furthermore, the MCU 106 configures the first power supply 104a to provide a charging current based on information received from the battery pack BP1 through the first port 102a and configures the second power supply 104b to provide a charging current based on information (or a lack of information) received from the second port 102b and information received from the first port 102a in order to provide the maximum charge current that the battery pack BP1 is able to accept. Furthermore, the MCU 106 configures the second current limiting circuit 114b to pass 0 A to the second switch 112b. As such, since the bridge circuit 110 is closed and the second current limiting circuit 114b is set to pass 0 A, all of the charging current provided by the second power supply 104b passes current from the second current limiting circuit 114b through the bridge circuit 110 to the first current limiting circuit 114a. The MCU 106 configures the first current limiting circuit 114a to pass the current provided by the first power supply 104a and the power provided by the second power supply 104b to the first port 102a to charge the battery pack BP1.

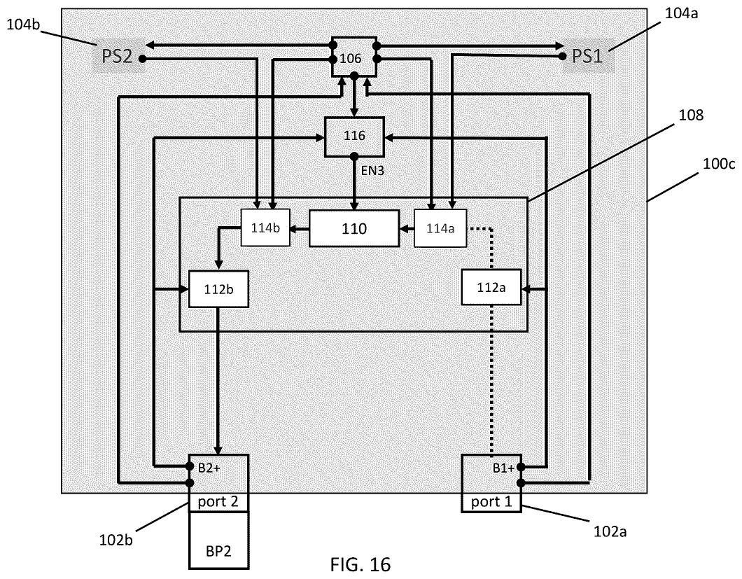

In a third circumstance, with reference to FIG. 16, the second port 102b is coupled to a battery pack BP2 and the first port 102a is not coupled to a battery pack, the second switch 112b is set to a closed state, the first switch 112a is set to an open state, the driver circuit 116 is set to provide an on signal to the bridge circuit 110 and the bridge circuit 110 is set to a closed state. Furthermore, the MCU 106 configures the second power supply 104b to provide a charging current based on information received from the battery pack BP2 through the second port 102b and configures the first power supply 104a to provide a charging current based on information (or a lack of information) received from the first port 102a and information received from the second port 102b in order to provide the maximum charge current that the battery pack BP2 is able to accept. Furthermore, the MCU 106 configures the first current limiting circuit 114a to pass 0 A to the first switch 112a. As such, since the bridge circuit 110 is closed and the first current limiting circuit 114a is set to pass 0 A, all the charging current provided by the first power supply 104a passes current from the first current limiting circuit 114a through the bridge circuit 110 to the second current limiting circuit 114b. The MCU 106 configures the second current limiting circuit 114b to pass the current provided by the first power supply 104a and the power provided by the second power supply 104b to the second port 102b to charge the battery pack BP2.

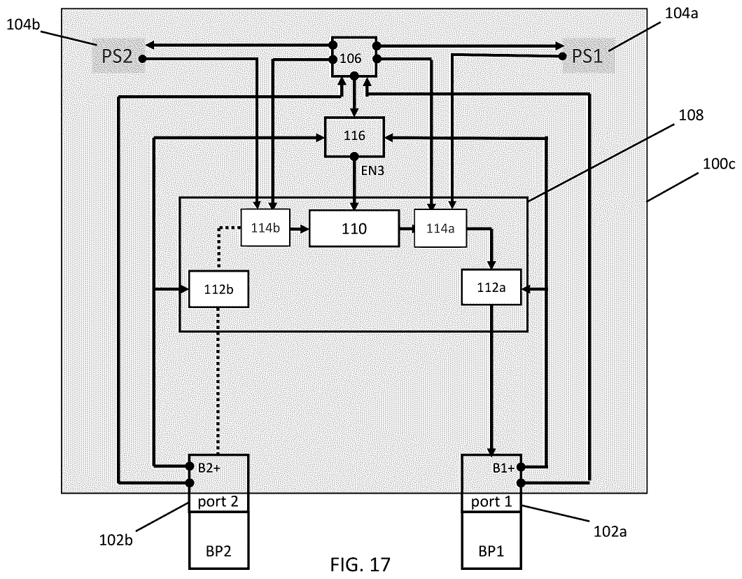

In a fourth circumstance, with reference to FIGS. 17-20, the first port 102a is coupled to a battery pack BP1 and the second port 102b is coupled to a battery pack BP2. In this circumstance, while the first switch 112a is set to a closed state and the second switch 112b is set to a closed state, the driver circuit 116 is set to provide an on signal to the bridge circuit 110 and the bridge circuit 110 is set to a closed state, charging current will not necessarily pass to both the first port 102a and the second port 102b. Furthermore, in this circumstance, the MCU 106 configures both the first power supply 104a and the second power supply 104b to provide a charging current based on information received from the battery pack BP1 through the first port 102a and from the battery pack BP2 through the second port 102b. Each of the power supplies 104 may be configured to provide a charging current amount from a minimum, e.g., 1 A to a maximum amount the power supply is capable of supplying, e.g., 8 A. In this circumstance, depending upon the state or condition or parameters of the battery pack BP1 and the battery BP2, the MCU 106 will configure the first current limiting circuit 114a and the second current limiting circuit 114b to direct the charging current from both of the power supplies 104a, 104b to a first of the battery packs BP1, BP2 or to a second of the battery packs BP1, BP2 or to both of the battery packs BP1, BP2 simultaneously.

Referring to FIG. 17, in this instance, the first power supply 104a and the second power supply 104b have each been configured to provide a charging current in a range of a minimum amount to a maximum capable amount and the second current limiting circuit 114b has been configured to pass no charging current to the second switch 112b. As such, all of the charging current produced by the second power supply 104b is directed to the bridge circuit 110 and passed through the bridge circuit 110 to the first current limiting circuit 114a. Furthermore, the first current limiting circuit 114a is configured to pass all of the charging current produced by and received from the first power supply 104a and all of the charging current received from the second current limiting circuit 114b through the bridge circuit 110 to the first port 102a to charge the battery pack BP1.

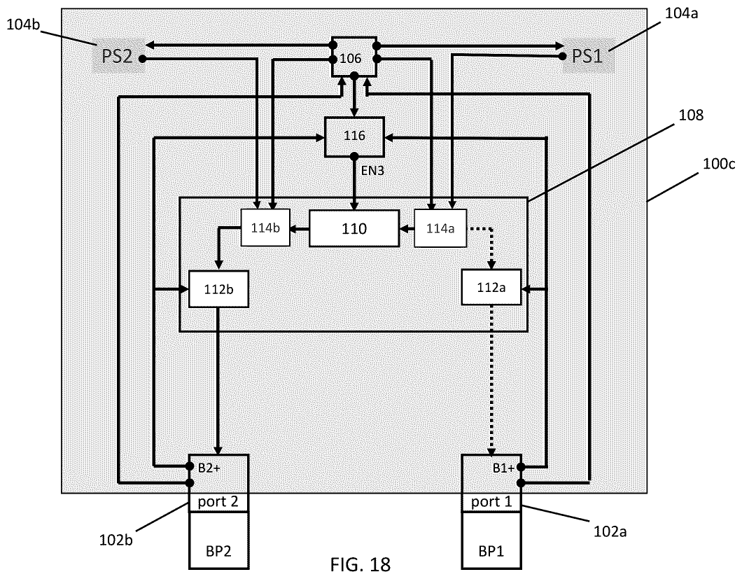

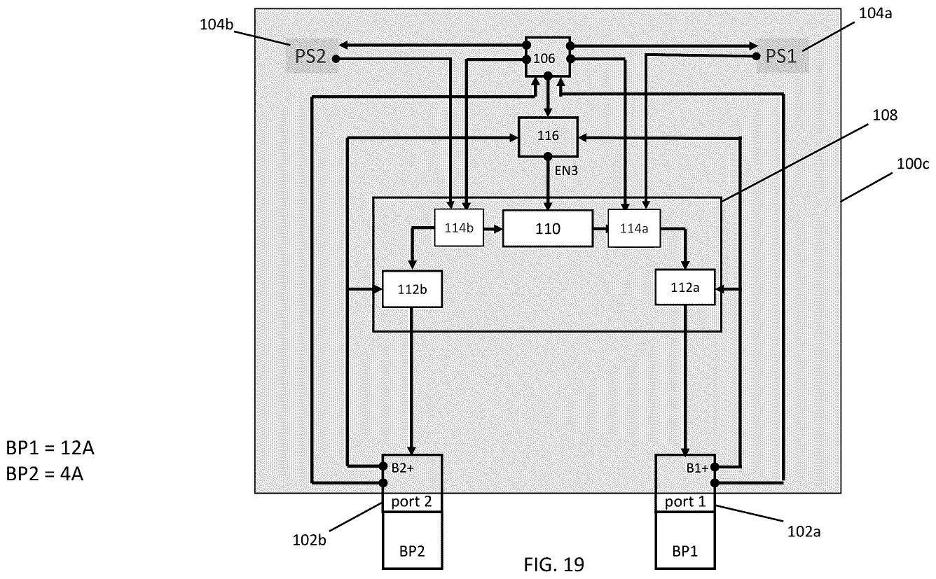

Referring to FIG. 18, in this instance, the first power supply 104a and the second power supply have each been configured to provide a charging current in a range of a minimum amount to a maximum capable amount and the first current limiting circuit 114a has been configured to pass no charging current to the first switch 112a. As such, all of the charging current produced by the first power supply 104a is directed to the bridge circuit 110 and passed through the bridge circuit 110 to the second current limiting circuit 114b. Furthermore, the second current limiting circuit 114b is configured to pass all of the charging current produced by and received from the second power supply 104b and all of the charging current received from the first current limiting circuit 114a through the bridge circuit 110 to the second port 102b to charge the battery pack BP2.

Referring to FIG. 19, in this instance, the first power supply 104a and the second power supply 104b have each been configured to provide a charging current in a range of a minimum amount to a maximum capable amount. Furthermore, the second current limiting circuit 114b has been configured to pass less charging current to the second switch 112b than it receives from the second power supply 104b. As such, some of the charging current produced by the second power supply 104b is passed to the second port 102b to charge the second battery pack BP2 and the remainder of the charging current produced by the second power supply 104b and received by the second current limiting circuit 114b is directed to the bridge circuit 110 and passed through the bridge circuit 110 to the first current limiting circuit 114a. Furthermore, the first current limiting circuit 114a is configured to pass all of the charging current produced by and received from the first power supply 104a and all of the charging current received from the second current limiting circuit 114b through the bridge circuit 110 to the first port 102a to charge the first battery pack BP1.

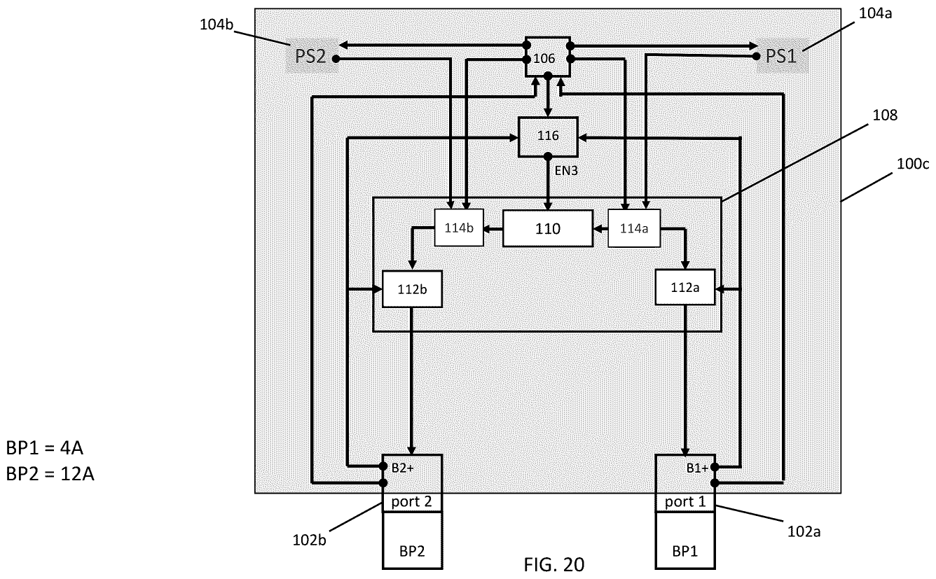

Referring to FIG. 20, instance, the first power supply 104a and the second power supply 104b have each been configured to provide a charging current in a range of a minimum amount to a maximum capable amount. Furthermore, the first current limiting circuit 114a has been configured to pass less charging current to the first switch 112a than it receives from the first power supply 104a. As such, some of the charging current produced by the first power supply 104a is passed to the first port 102a to charge the first battery pack BP1 and the remainder of the charging current produced by the first power supply 104a and received by the first current limiting circuit 114a is directed to the bridge circuit 110 and passed through the bridge circuit 110 to the second current limiting circuit 114b. Furthermore, the second current limiting circuit 114b is configured to pass all of the charging current produced by and received from the second power supply 104b and all of the charging current received from the first current limiting circuit 114a through the bridge circuit 110 to the second port 102b to charge the second battery pack BP2.

Referring to FIG. 15, in this example charging scheme, a battery pack (BP1) is coupled to a first port (port 1) 102a. Based on signals/information from the first port 102a/first battery pack BP1 and the MCU 106, the driver circuit 116 closes the bridge circuit 110 to allow current to flow in both directions between the first current limiting circuit 114a and the second current limiting circuit 114b. Based on signals/information from the first port 102a regarding parameters of the battery pack BP1, the MCU 106 may provide the maximum charge current, that the power supplies may provide, to the first port 102a and the battery pack BP1 that the battery pack BP1 may accept. For example, if each of the power supplies 104a, 104b is capable of providing/outputting a maximum of 8 amperes of charging current and the battery pack BP1 is capable of receiving a maximum charging current of 10 A, the MCU 106 may control the first power supply 104a to output 8 A of charging current and the second power supply 104b to output 2 A of charging current while also controlling the second current limiting circuit 114b to divert the 2 A of current from the second power supply 104b to the bridge circuit 110 (in other words, controlling the second current limiting circuit 114b to not allow any charging current to pass to the second charging port 102b) while also controlling the bridge circuit 110 to be closed to allow current to pass from the second current limiting circuit 114b to the first current limiting circuit 114a while also controlling the first current limiting circuit 114a to pass 10 A of charging current to the first port 102a to charge the first battery pack BP1. Simultaneously, the first switch 112a will close to allow the 10 A of charging current to flow from the first current limiting circuit 114a to the first port 102a to charge the first battery pack BP1.

In another example embodiment, the MCU 106 may control the first power supply 104a to output 5 A of charging current and the second power supply 104b to output 5 A of charging current while also controlling the second current limiting circuit 114b to divert the 5 A of charging current to the bridge circuit 110 (in other words, controlling the second current limiting circuit 114b to not allow any charging current to pass to the second charging port 102b) while also controlling the bridge circuit 110 to be closed to allow the charging current to pass from the second current limiting circuit 114b to the first current limiting circuit 114a while also controlling the first current limiting circuit 114a to pass 10 A of charging current to the first port 102a to charge the first battery pack BP1. Simultaneously, the first switch 112a will close to allow the 10 A of charging current to flow from the first current limiting circuit 114a to the first port 102a to charge the first battery pack BP1.

In another example embodiment, the first battery pack BP1 is capable of receiving a maximum charging current of 16 A. As such, the MCU 106 may control the first power supply 104a to output 8 A of charging current and the second power supply 104b to output 8 A of charging current while also controlling the second current limiting circuit 114b to divert the 8 A of charging current to the bridge circuit 110 (in other words, controlling the second current limiting circuit 114b to not allow any charging current to pass to the second charging port 102b) while also controlling the bridge circuit 110 to be closed to allow the charging current to pass from the second current limiting circuit 114b to the first current limiting circuit 114a while also controlling the first current limiting circuit 114a to pass 16 A of charging current to the first port 102a to charge the first battery pack BP1. Simultaneously, the first switch 112a will close to allow the 16 A of charging current to flow from the first current limiting circuit 114a to the first port 102a to charge the first battery pack BP1.

Referring to FIG. 16, in this example charging scheme, a second battery pack (BP2) is coupled to a second port (port 2) 102b. Based on signals/information from the second port 102b/second battery pack BP2 and the MCU 106, the driver circuit 116 closes the bridge circuit 110 to allow current to flow in both directions between the first current limiting circuit 114a and the second current limiting circuit 114b. Based on signals/information from the second port 102b regarding parameters of the battery pack BP2, the MCU 106 may provide the maximum charge current to the second port 102b and the battery pack BP2. For example, if each of the power supplies 104a, 104b is capable of providing/outputting a maximum of 8 amperes of charging current and the battery pack BP2 is capable of receiving a maximum charging current of 10 A, the MCU 106 may control the second power supply 104b to output 8 A of charging current and the first power supply 104a to output 2 A of charging current while also controlling the first current limiting circuit 114a to divert the 2 A of charging current to the bridge circuit 110 (in other words, controlling the first current limiting circuit 114a to not allow any charging current to pass to the first charging port 102a) while also controlling the bridge circuit 110 to be closed to allow the charging current to pass from the first current limiting circuit 114a to the second current limiting circuit 114b while also controlling the second current limiting circuit 114b to pass 10 A of charging current to the second port 102b to charge the second battery pack BP2. Simultaneously, the second switch 112b will close to allow the 10 A of charging current to flow from the second current limiting circuit 114b to the second port 102b to charge the second battery pack BP2.

In another example embodiment, the MCU 106 may control the first power supply 104a to output 5 A of charging current and the second power supply 104b to output 5 A of charging current while also controlling the first current limiting circuit 114a to divert the 5 A of charging current to the bridge circuit 110 (in other words, controlling the first current limiting circuit 114a to not allow any charging current to pass to the first charging port 102a) while also controlling the bridge circuit 110 to be closed to allow the charging current to pass from the first current limiting circuit 114a to the second current limiting circuit 114b while also controlling the second current limiting circuit 114b to pass 10 A of the charging current to the second port 102b to charge the second battery pack BP2. Simultaneously, the second switch 112b will close to allow the 10 A of charging current to flow from the second current limiting circuit 114b to the second port 102b to charge the second battery pack BP2.

In another example embodiment, the second battery pack BP2 is capable of receiving a maximum charging current of 16 A. As such, the MCU 106 may control the first power supply 104a to output 8 A of charging current and the second power supply 104b to output 8 A of charging current while also controlling the first current limiting circuit 114a to divert the 8 A of charging current to the bridge circuit 110 (in other words, controlling the first current limiting circuit 114a to not allow any charging current to pass to the first charging port 102a) while also controlling the bridge circuit 110 to be closed to allow the charging current to pass from the first current limiting circuit 114a to the second current limiting circuit 114b while also controlling the second current limiting circuit 114b to pass 16 A of charging current to the second port 102b to charge the second battery pack BP2. Simultaneously, the second switch 112b will close to allow the 16 A of charging current to flow from the second current limiting circuit 114b to the second port 102b to charge the second battery pack BP2.

Referring to FIG. 17, this charging scheme is similar to the charging scheme illustrated and described with respect to FIG. 15 except that another battery pack BP2 is coupled to the second port 102b of the charger 100c. Regardless of the battery pack BP2 being coupled to the second port 102b, the power supplies 104 may provide power to the first battery pack BP1 in the same manner as described above with respect to FIG. 15. However, as noted in FIG. 8B, the second switch 112b is closed as it has received a signal from the second port 102b that a battery pack BP2 is present. In this example charging scheme, a first battery pack BP1 is coupled to the first port 102a. Based on signals/information from the first port 102a/first battery pack BP1 and from the second port 102b/second battery pack BP2 and the MCU 106, the driver circuit 116 closes the bridge circuit 110 to allow charging current to flow in both directions between the first current limiting circuit 114a and the second current limiting circuit 114b. Based on signals/information from the first port 102a regarding parameters of the first battery pack BP1 and from the second port 102b regarding parameters of the second battery pack BP2, the MCU 106 may configure the power supplies 104 to provide up to the maximum charge current that the power supplies 104 may provide, to the first port 102a and the battery pack BP1 based on information defining the maximum charge current that the battery pack BP1 may accept. For example, if each of the power supplies 104a, 104b is capable of providing/outputting a maximum of 8 amperes of charging current and the battery pack BP1 is capable of receiving a maximum charging current of 10 A, the MCU 106 may control the first power supply 104a to output 8 A of charging current and the second power supply 104b to output 2 A of charging current while also controlling the second current limiting circuit 114b to divert the 2 A of charging current from the second power supply 104b to the bridge circuit 110 (in other words, controlling the second current limiting circuit 114b to not allow any charging current to pass to the second port 102b) while also controlling the bridge circuit 110 to be closed to allow current to pass from the second current limiting circuit 114b to the first current limiting circuit 114a while also controlling the first current limiting circuit 114a to pass 10 A of charging current to the first port 102a to charge the first battery pack BP1. Simultaneously, the first switch 112a will close to allow the 10 A of charging current to flow from the first current limiting circuit 114a to the first port 102a to charge the first battery pack BP1.

Referring to FIG. 18, this charging scheme is similar to the charging scheme illustrated and described with respect to FIG. 16 except that another battery pack BP1 is coupled to the first port 102a of the charger 100c. Regardless of the battery pack BP1 being coupled to the first port 102a, the power supplies 104 may provide power to the second battery pack BP2 in the same manner as described above with respect to FIG. 16. However, as noted in FIG. 8B, the first switch 112a is closed as it has received a signal from the first port 102a that a battery pack BP1 is present. In this example charging scheme, a first battery pack BP1 is coupled to the first port 102a and a second battery pack BP2 is coupled to the second port 102b. Based on signals/information from the first port 102a/first battery pack BP1 and from the second port 102b/second battery pack BP2 and the MCU 106, the driver circuit 116 closes the bridge circuit 110 allow current to flow in both directions between the first current limiting circuit 114a and the second current limiting circuit 114b. Based on signals/information from the first port 102a regarding parameters of the battery pack BP1 and from the second port 102b regarding parameters of the battery pack BP2, the MCU 106 may provide the maximum charge current, that the power supplies 104 may provide, to the second port 102b and the battery pack BP2 that the battery pack BP2 may accept. For example, if each of the power supplies 104a, 104b is capable of providing/outputting a maximum of 8 amperes of charging current and the battery pack BP2 is capable of receiving a maximum charging current of 10 A, the MCU 106 may control the second power supply 104b to output 8 A of charging current and the first power supply 104a to output 2 A of charging current while also controlling the first current limiting circuit 114a to divert the 2 A of charging current from the first power supply 104a to the bridge circuit 110 (in other words, controlling the first current limiting circuit 114a to not allow any charging current to pass to the first charging port 102a) while also controlling the bridge circuit 110 to be closed to direct current to pass from the first current limiting circuit 114a to the second current limiting circuit 114b while also controlling the second current limiting circuit 114b to pass 10 A of charging current to the second port 102b to charge the second battery pack BP2. Simultaneously, the second switch 112b will close to allow the 10 A of charging current to flow from the second current limiting circuit 114b to the second port 102b to charge the second battery pack BP2.

Referring to FIG. 19, this charging scheme is similar to the charging scheme illustrated and described with respect to FIG. 14. In this example embodiment, a first battery pack BP1 is coupled to the first port 102a and a second battery pack BP2 is coupled to the second port 102b. In this example embodiment both battery packs are charged simultaneously with charging current from one of the power supplies 104b being directed to both of the battery packs BP1, BP2. As noted in FIG. 8B, the first switch 112a is closed as it has received a signal from the first port 102a that a battery pack BP1 is present and the second switch 112b is closed as it has received a signal from the second port 102b that a battery pack BP2 is present.

Based on signals/information from the first port 102a/first battery pack BP1 and from the second port 102b/second battery pack BP2 and the MCU 106, the driver circuit 116 closes the bridge circuit 110 to allow current to flow in both directions between the first current limiting circuit 114a and the second current limiting circuit 114b. Based on signals/information from the first port 102a/first battery pack BP1 and the second port 102b/second battery pack BP2 regarding parameters of the first battery pack BP1 and the second battery pack BP2, the MCU 106 may configure the power supplies 104 to provide up to the maximum charge current that the power supplies 104 may provide, to the first port 102a and the first battery pack BP1, based on information defining a maximum charging current that the first battery pack BP1 may accept and/or to the second port 102b and the battery pack BP2, based on information defining a maximum charging current that the second battery pack BP2 may accept. For example, if each of the power supplies 104a, 104b is capable of providing/outputting a maximum of 8 amperes of charging current and the first battery BP1 is capable of receiving a maximum charging current of 12 A and the second battery pack BP2 is capable of receiving a maximum charging current of 4 A, the MCU 106 may configure the first power supply 104a to output 8 A of charging current and the second power supply 104b to output 8 A of charging current while also configuring the second current limiting circuit 114b to divert the 4 A of charging current from the second power supply 104b to the bridge circuit 110 (in other words, controlling the second current limiting circuit 114b to allow 4 A of charging current to pass to the second charging port 102b) while also controlling the bridge circuit 110 to be closed to allow charging current to pass from the second current limiting circuit 114b to the first current limiting circuit 114a. Specifically, the second current limiting circuit 114b passes 4 A of charging current to the second port 102b to charge the second battery pack BP2. Simultaneously, the second switch 112b will close to allow the 4 A of charging current to flow from the second current limiting circuit 114b to the second port 102b to charge the second battery pack BP2. Furthermore, the 4 A of charging current diverted by the second current limiting circuit 114b passes through the bridge circuit 110 to the first current limiting circuit 114a. The first current limiting circuit 114a is configured to receive the 4 A of charging current received from the second current limiting circuit 114b and the 8 A of charging current from the first power supply 104a, for a total of 12 A of charging current, to pass to the first port 102a to charge the first battery pack BP1.

Referring to FIG. 20, this charging scheme is similar to the charging scheme illustrated and described with respect to FIG. 19. In this example embodiment, a first battery pack BP1 is coupled to the first port 102a and a second battery pack BP2 is coupled to the second port 102b. In this example embodiment both battery packs are charged simultaneously with charging current from one of the power supplies 104a being directed to both of the battery packs BP1, BP2. As noted in FIG. 8B, the first switch 112a is closed as it has received a signal from the first port 102a that a battery pack BP1 is present and the second switch 112b is closed as it has received a signal from the second port 102b that a battery pack BP2 is present. Based on signals/information from the first port 102a/first battery pack BP1 and from the second port 102b/second battery pack BP2 and the MCU 106, the driver circuit 116 closes the bridge circuit 110 to allow current to flow in both directions between the first current limiting circuit 114a and the second current limiting circuit 114b. Based on signals/information from the first port 102a/first battery pack BP1 and the second port 102b/second battery pack BP2 regarding parameters of the first battery pack BP1 and the second battery pack BP2, the MCU 106 may configure the power supplies 104 to provide up to the maximum charge current that the power supplies 104 may provide, to the first port 102a and the first battery pack BP1, based on information defining a maximum charging current that the first battery pack BP1 may accept and/or to the second port 102b and the battery pack BP2, based on information defining a maximum charging current that the second battery pack BP2 may accept. For example, if each of the power supplies 104a, 104b is capable of providing/outputting a maximum of 8 amperes of charging current and the second battery BP2 is capable of receiving a maximum charging current of 12 A and the first battery pack BP1 is capable of receiving a maximum charging current of 4 A, the MCU 106 may configure the first power supply 104a to output 8 A of charging current and the second power supply 104b to output 8 A of charging current while also configuring the first current limiting circuit 114a to divert the 4 A of charging current from the first power supply 104a to the bridge circuit 110 (in other words, controlling the first current limiting circuit 114a to allow 4 A of charging current to pass to the first charging port 102a) while also controlling the bridge circuit 110 to be closed to allow charging current to pass from the first current limiting circuit 114a to the second current limiting circuit 114b. Specifically, the first current limiting circuit 114a passes 4 A of charging current to the first port 102a to charge the first battery pack BP1. Simultaneously, the first switch 112a will close to allow the 4 A of charging current to flow from the first current limiting circuit 114a to the first port 102a to charge the first battery pack BP1. Furthermore, the 4 A of charging current diverted by the first current limiting circuit 114a passes through the bridge circuit 110 to the second current limiting circuit 114b. The second current limiting circuit 114b is configured to receive the 4 A of charging current received from the first current limiting circuit 114a and the 8 A of charging current from the second power supply 104b, for a total of 12 A of charging current, to pass to the second port 102b to charge the second battery pack BP2.

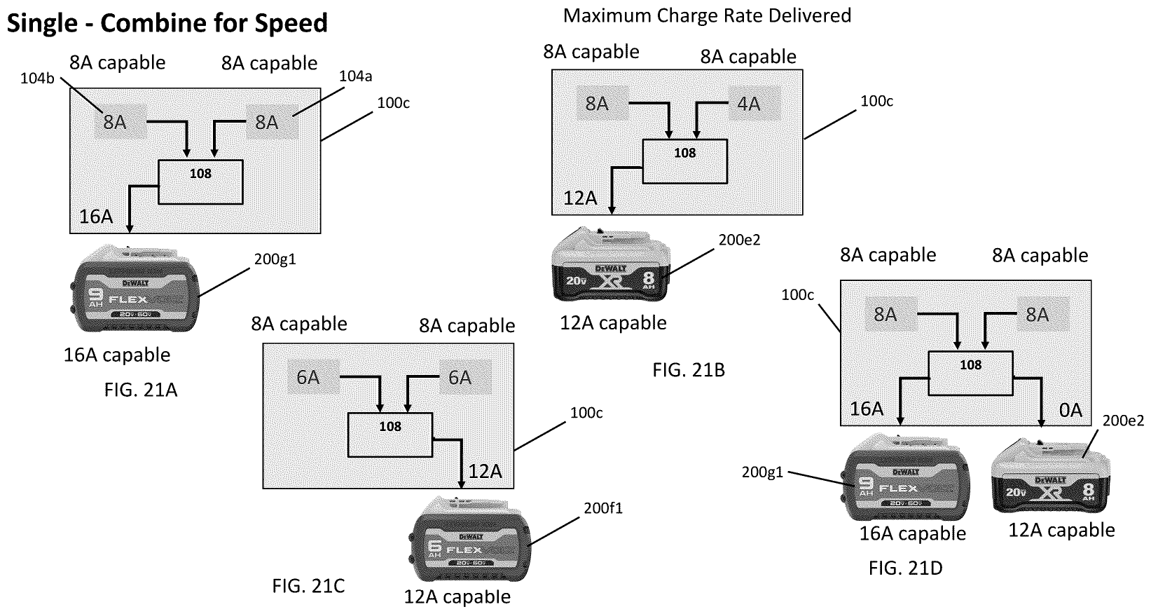

With reference to FIG. 21A, there is illustrated an example charger 100c and battery pack charging scheme. As illustrated, the charger 100c includes a first AC-DC power supply 104a and a second AC-DC power supply 104b. In this example, the power supplies 104 are each capable of providing a maximum of 8 A of charging current. In this example, the battery pack 200g1 is coupled to a port 102b of the charger 100c and is capable of receiving a maximum of 16 A of charging current. In this example, the first power supply 104a is configured to provide 8 A of charging current and the second power supply is configured to provide 8 A of charging current to the bridge assembly circuit 108. The bridge assembly circuit 108 directs 16 A of charging current from both of the power supplies 104 (8 A of charging current from the first power supply 104a and 8 A of charging current from the second power supply 104b) to the port 102b, as described above, to charge the battery pack 200g1 at its maximum charging rate.

With reference to FIG. 21B, there is illustrated an example charger 100c and battery pack charging scheme. As illustrated, the charger 100c includes a first AC-DC power supply 104a and a second AC-DC power supply 104b. In this example, the power supplies 104 are each capable of providing a maximum of 8 A of charging current. In this example, the battery pack 200e2 is coupled to a port 102b of the charger 100c and is capable of receiving a maximum of 12 A of charging current. In this example, the first power supply 104a is configured to provide 4 A of charging current and the second power supply is configured to provide 8 A of charging current to the bridge assembly circuit 108. The bridge assembly circuit 108 directs 12 A of charging current from both of the power supplies 104 (4 A of charging current from the first power supply 104a and 8 A of charging current from the second power supply 104b) to the port 102b, as described above, to charge the battery pack 200g1 at its maximum charging rate.

With reference to FIG. 21C, there is illustrated an example charger 100c and battery pack charging scheme. As illustrated, the charger 100c includes a first AC-DC power supply 104a and a second AC-DC power supply 104b. In this example, the power supplies 104 are each capable of providing a maximum of 8 A of charging current. In this example, the battery pack 200f1 is coupled to a port 102a of the charger 100c and is capable of receiving a maximum of 12 A of charging current. In this example, the first power supply 104a is configured to provide 6 A of charging current and the second power supply is configured to provide 6 A of charging current to the bridge assembly circuit 108. The bridge assembly circuit 108 directs 12 A of charging current from both of the power supplies 104 (6 A of charging current from the first power supply 104a and 6 A of charging current from the second power supply 104b) to the port 102a, as described above, to charge the battery pack 200f1 at its maximum charging rate.

With reference to FIG. 21D, there is illustrated an example charger 100c and battery pack charging scheme. As illustrated, the charger 100c includes a first AC-DC power supply 104a and a second AC-DC power supply 104b. In this example, the power supplies 104 are each capable of providing a maximum of 8 A of charging current. In this example, the battery pack 200e2 is coupled to a port 102a of the charger 100c and is capable of receiving a maximum of 12 A of charging current and the battery pack 200g1 is coupled to a port 102b of the charger 100c and is capable of receiving a maximum of 16 A of charging current. In this example, the first power supply 104a is configured to provide 8 A of charging current and the second power supply is configured to provide 8 A of charging current to the bridge assembly circuit 108. The bridge assembly circuit 108 directs 16 A of charging current from both of the power supplies 104 (8 A of charging current from the first power supply 104a and 8 A of charging current from the second power supply 104b) to the port 102b and no charging current to the port 102a, as described above, to charge the battery pack 200g1 at its maximum charging rate.

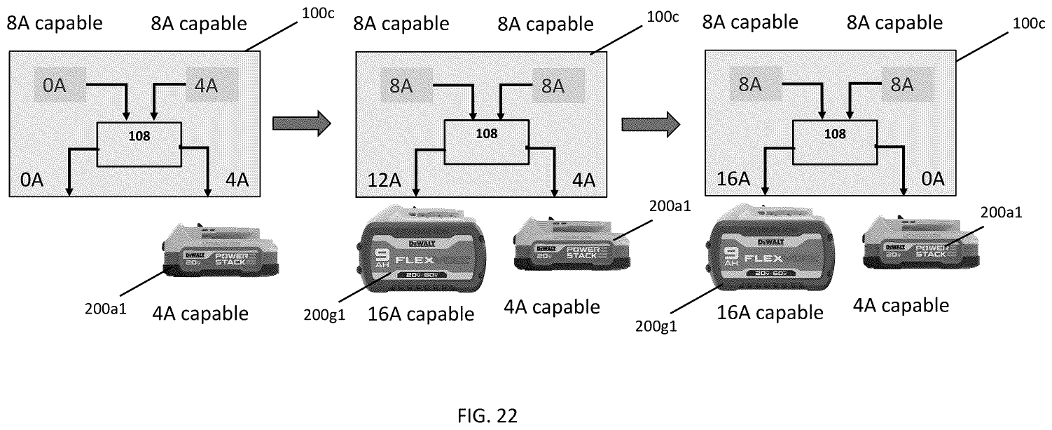

With reference to FIG. 22, there is illustrated an example charger 100c and a single pack to multi-pack shared charging battery pack charging scheme. In this charging scheme, if a higher capacity battery pack is received by the charger after a lower capacity battery pack then the battery packs share the total charging current from the power supplies providing the lower capacity pack with a charging current that matches its maximum charging rate until it is fully charged and thereafter provides the higher capacity pack with a charging current that matches its maximum charging rate. As illustrated, the charger 100c includes a first AC-DC power supply 104a and a second AC-DC power supply 104b. In this example, the power supplies 104 are each capable of providing a maximum of 8 A of charging current. In this example, the battery pack 200a1 is coupled to a port 102a of the charger 100c and is capable of receiving a maximum of 4 A of charging current. In this example, when the first battery pack 200a1 is coupled to the first port 102a the first power supply 104a is configured to provide 4 A of charging current to match the maximum charging rate of the first battery pack 200a1. When the second battery pack 200g1 is coupled to the charger 100c the first power supply 104a is configured to provide 8 A of charging current and the second power supply is configured to provide 8 A of charging current. The bridge assembly circuit 108 is configured to provide 4 A of charging current to the first battery pack 200a1 and 12 A of charging current to the second battery pack 200g1. When the first battery pack 200a1 is fully charged, the bridge assembly circuit is reconfigured to direct 16 A of charging current from both of the power supplies 104 (8 A of charging current from the first power supply 104a and 8 A of charging current from the second power supply 104b) to the port 102b and to the second battery pack 200g1, as described above, to charge the battery pack 200g1 at its maximum charging rate.

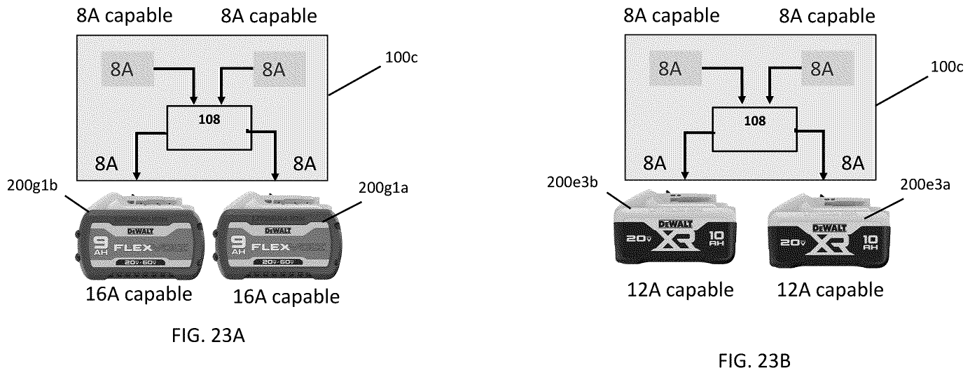

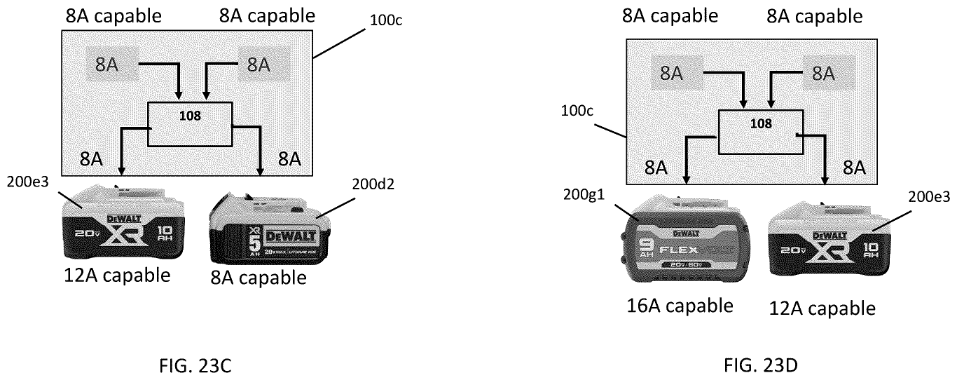

With reference to FIGS. 23A-23D, there is illustrated an example charger 100c and a two pack, simultaneous charging scheme. In this charging scheme, if two battery packs are coupled to the charger and each has a maximum charging rate that is equal to or greater than the maximum charge current that the power supplies can supply, each battery pack is charged at the highest rate capable from the charger. As illustrated, the charger 100c includes a first AC-DC power supply 104a and a second AC-DC power supply 104b. In this example, the power supplies 104 are each capable of providing a maximum of 8 A of charging current. In this example, with reference to FIG. 23A, the first battery pack 200g1a is coupled to a first port 102a of the charger 100c and is capable of receiving a maximum charging current of 16 A and the second battery pack 200g1b is coupled to a second port 102b of the charger 100c and is capable of receiving a maximum charging current of 16 A. In this example, each power supply 104 is configured to provide an 8 A charging current to the bridge assembly circuit 108 and the bridge assembly circuit 108 is configured to direct the 8 A charging current from the first power supply 104a to the first port 102a/first battery pack 200g1a and to direct the 8 A charging current from the second power supply 104b to the second port 102b/second battery pack 200g1b, as described above.

In this example, with reference to FIG. 23B, the first battery pack 200e3a is coupled to a first port 102a of the charger 100c and is capable of receiving a maximum charging current of 12 A and the second battery pack 200e3b is coupled to a second port 102b of the charger 100c and is capable of receiving a maximum charging current of 12 A. In this example, each power supply 104 is configured to provide an 8 A charging current to the bridge assembly circuit 108 and the bridge assembly circuit 108 is configured to direct the 8 A charging current from the first power supply 104a to the first port 102a/first battery pack 200e3a and to direct the 8 A charging current from the second power supply 104b to the second port 102b/second battery pack 200e3b, as described above.

In this example, with reference to FIG. 23C, the first battery pack 200d2 is coupled to a first port 102a of the charger 100c and is capable of receiving a maximum charging current of 8 A and the second battery pack 200e3 is coupled to a second port 102b of the charger 100c and is capable of receiving a maximum charging current of 12 A. In this example, each power supply 104 is configured to provide an 8 A charging current to the bridge assembly circuit 108 and the bridge assembly circuit 108 is configured to direct the 8 A charging current from the first power supply 104a to the first port 102a/first battery pack 200d2 and to direct the 8 A charging current from the second power supply 104b to the second port 102b/second battery pack 200e3, as described above.

In this example, with reference to FIG. 23D, the first battery pack 200e3 is coupled to a first port 102a of the charger 100c and is capable of receiving a maximum charging current of 12 A and the second battery pack 200g1 is coupled to a second port 102b of the charger 100c and is capable of receiving a maximum charging current of 16 A. In this example, each power supply 104 is configured to provide an 8 A charging current to the bridge assembly circuit 108 and the bridge assembly circuit 108 is configured to direct the 8 A charging current from the first power supply 104a to the first port 102a/first battery pack 200e3 and to direct the 8 A charging current from the second power supply 104b to the second port 102b/second battery pack 200g1, as described above.

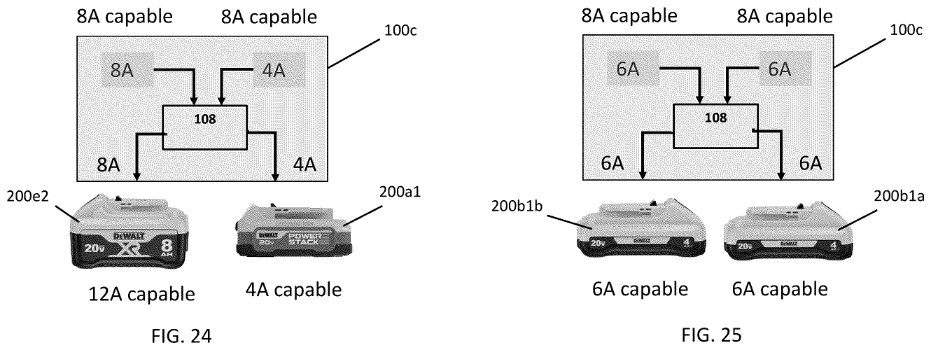

With reference to FIG. 24, there is illustrated an example charger 100c and a two pack, simultaneous charging scheme. In this charging scheme, a first battery pack 200a1 having a maximum capable charge rate of 4 A is coupled to the first port 102a and a second battery pack 200e2 having a maximum capable charge rate of 12 A is coupled to the second port 102b. In this example, the first power supply is configured to provide a charging current of 4 A and the second power supply is configured to provide a charging current of 8 A. Furthermore, the bridge assembly circuit 108 is configured to direct the 4 A of charging current from the first power supply 104a to the first port 102a to charge the first battery pack 200a1 and to direct the 8 A of charging current from the second power supply 104b to the second port 102b to charge the second battery pack 200e2. In this example, even though the second battery pack 200e2 is capable of receiving a charging current greater than the 8 A provided from the second power supply 104b, the charger is not configured to provide (share) the available additional charging current from the first power supply 104a.

With reference to FIG. 25, there is illustrated an example charger 100c and a two pack, simultaneous charging scheme. In this charging scheme, a first battery pack 200b1a having a maximum capable charge rate of 6 A is coupled to the first port 102a and a second battery pack 200b1b having a maximum capable charge rate of 6 A is coupled to the second port 102b. In this example, the first power supply is configured to provide a charging current of 6 A and the second power supply is configured to provide a charging current of 6 A. Furthermore, the bridge assembly circuit 108 is configured to direct the 6 A of charging current from the first power supply 104a to the first port 102a to charge the first battery pack 200b1a and to direct the 6 A of charging current from the second power supply 104b to the second port 102b to charge the second battery pack 200b1b.

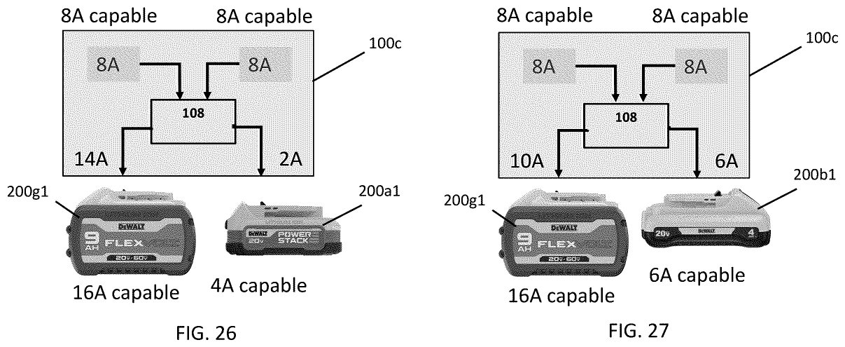

With reference to FIG. 26, there is illustrated an example charger 100c and a two pack, simultaneous sharing charging scheme. The charger 100c includes a first power supply 104a capable of providing a maximum charging current of 8 A and a second power supply 104b capable of providing a maximum charging current 8 A. In alternate embodiments, the charger 100c may include power supplies that are capable of providing a maximum charging current greater than 8 A or less than 8 A. In this charging scheme, a first battery pack 200a1 having a maximum capable charge rate of 4 A is coupled to the first port 102a and a second battery pack 200g1 having a maximum capable charge rate of 16 A is coupled to the second port 102b. In this example, the first power supply is configured to provide a charging current of 8 A and the second power supply is configured to provide a charging current of 8 A. Furthermore, the bridge assembly circuit 108 is configured to direct 2 A of the charging current from the first power supply 104a to the first port 102a to charge the first battery pack 200a1 at a 2 A charge rate and direct 6 A of charging current from the first power supply 104a and 8 A of charging current from the second power supply 104b to the second port 102b to charge the second battery pack 200g1 at a 14 A charge rate. In this instance, the charger 100c is configured to charge the higher capacity battery pack 200g1 at a rate as close to its maximum capable charge rate while still providing the lower capacity battery pack 200a1 with a minimum charge current.

With reference to FIG. 27, there is illustrated an example charger 100c and a two pack, simultaneous sharing charging scheme. The charger 100c includes a first power supply 104a capable of providing a maximum charging current of 8 A and a second power supply 104b capable of providing a maximum charging current 8 A. In alternate embodiments, the charger 100c may include power supplies that are capable of providing a maximum charging current greater than 8 A or less than 8 A. In this charging scheme, a first battery pack 200b1 having a maximum capable charge rate of 6 A is coupled to the first port 102a and a second battery pack 200g1 having a maximum capable charge rate of 16 A is coupled to the second port 102b. In this example, the first power supply is configured to provide a charging current of 8 A and the second power supply is configured to provide a charging current of 8 A. Furthermore, the bridge assembly circuit 108 is configured to direct 6 A of the charging current from the first power supply 104a to the first port 102a to charge the first battery pack 200b1 at a 6 A charge rate and direct 2 A of charging current from the first power supply 104a and 8 A of charging current from the second power supply 104b to the second port 102b to charge the second battery pack 200g1 at a 10 A charge rate. In this instance, the charger 100c is configured to charge the lower capacity battery pack 200b1 at its maximum capable charge rate while providing the higher capacity battery pack 200g1 with the remainder of the available charging current from the first power supply 104a.

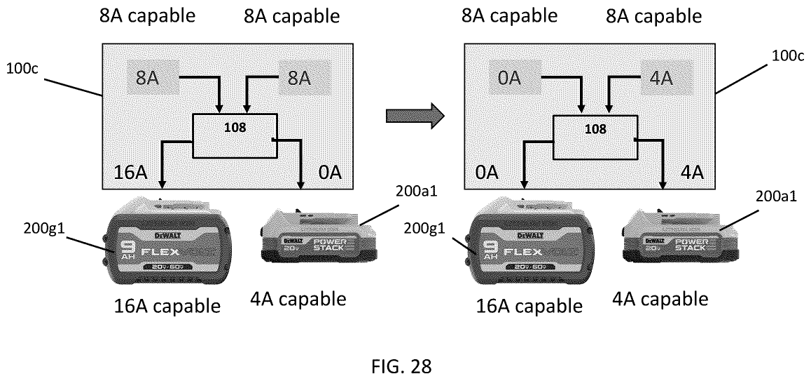

With reference to FIG. 28, there is illustrated an example charger 100c and a two pack, power sharing charging scheme. The charger 100c includes a first power supply 104a capable of providing a maximum charging current of 8 A and a second power supply 104b capable of providing a maximum charging current 8 A. In alternate embodiments, the charger 100c may include power supplies that are capable of providing a maximum charging current greater than 8 A or less than 8 A. In this charging scheme, a first battery pack 200a1 having a maximum capable charge rate of 4 A is coupled to the first port 102a and a second battery pack 200g1 having a maximum capable charge rate of 16 A is coupled to the second port 102b. In this example, both battery packs are coupled to the charger 100c, for all intents and purposes, at the same time. In this example, the first power supply 104a is configured to provide a charging current of 8 A and the second power supply 104b is configured to provide a charging current of 8 A. Furthermore, the bridge assembly circuit 108 is configured to direct OA of the charging current from the first power supply 104a to the first port 102a such that the first battery pack 200b1 is not being charged and direct 8 A of charging current from the first power supply 104a and 8 A of charging current from the second power supply 104b to the second port 102b to charge the second battery pack 200g1 at a 16 A charge rate. Once the first battery pack 200g1 is fully charged the first power supply 104a is reconfigured to provide a charging current of 4 A and the second power supply is reconfigured to provide a charging current of 0 A. Furthermore, the bridge assembly circuit 108 is reconfigured to direct 4 A of the charging current from the first power supply 104a to the first port 102a to charge the first battery pack 200a1 at a 4 A charge rate and direct OA of the charging current to the second port 102b such that the second battery pack 200g1 is not being charged. In this instance, the charger 100c is configured to first charge the higher capacity battery pack 200g1 at its maximum capable charge rate while not charging the lower capacity battery pack 200a1 and once the higher capacity battery pack 200g1 has been fully charged (100% state of charge (SOC)) then charge the lower capacity batter pack 200a1 at its maximum charge rate until it has been fully charged.

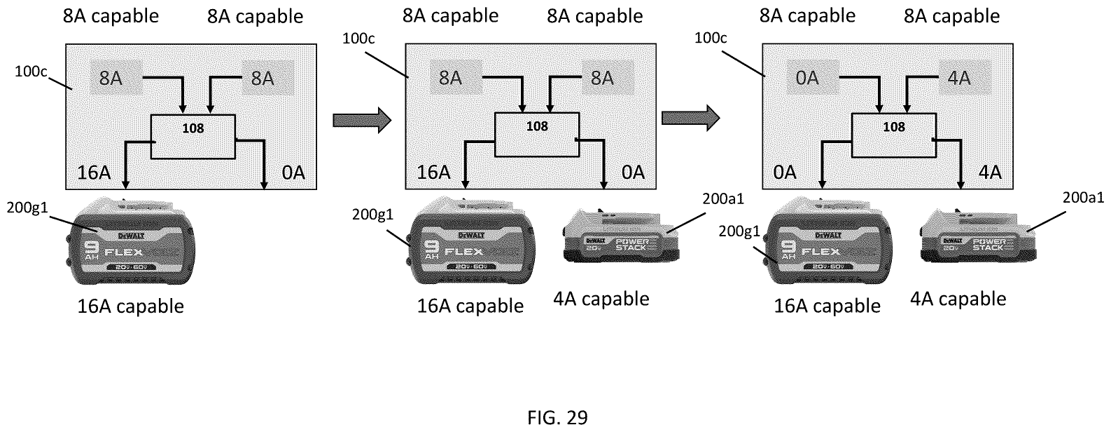

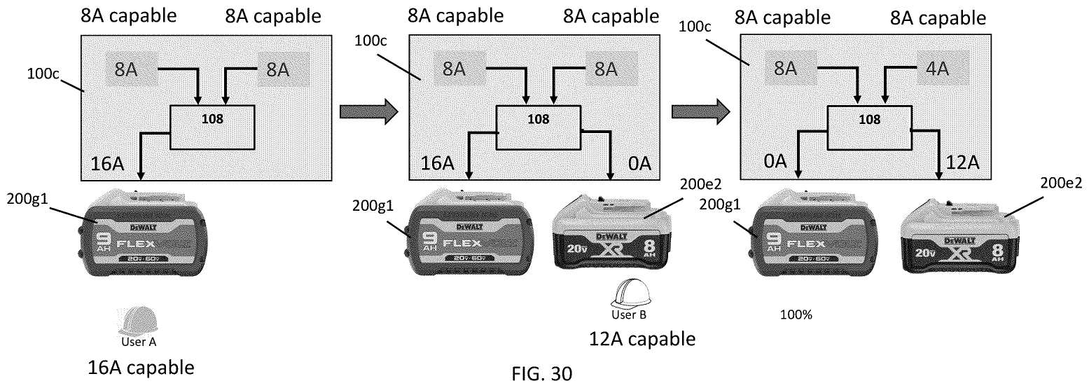

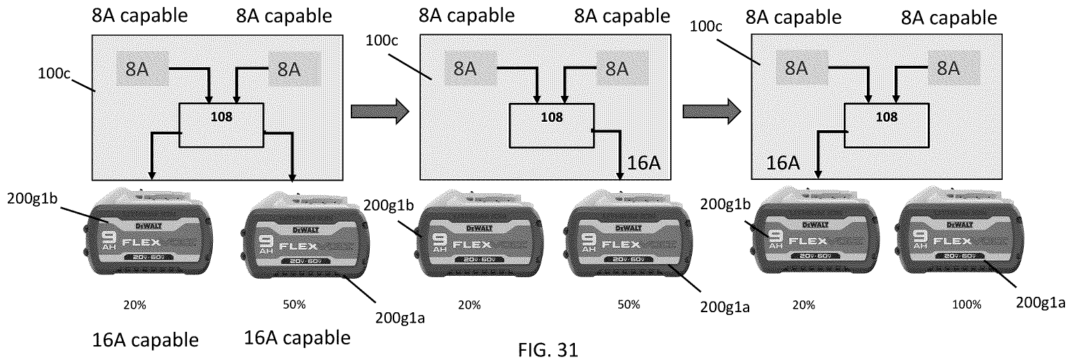

With reference to FIG. 29, there is illustrated an example charger 100c and a two pack, sequential power sharing charging scheme. The charger 100c includes a first power supply 104a capable of providing a maximum charging current of 8 A and a second power supply 104b capable of providing a maximum charging current 8 A. In alternate embodiments, the charger 100c may include power supplies that are capable of providing a maximum charging current greater than 8 A or less than 8 A. In this charging scheme, a first battery pack 200g1 having a maximum capable charge rate of 16 A is initially coupled to the second port 102b. In this example, once the first battery pack 200g1 is coupled to the charger 100c the first power supply 104a is configured to provide a charging current of 8 A and the second power supply 104b is configured to provide a charging current of 8 A. Furthermore, the bridge assembly circuit 108 is configured to direct OA of charging current to the first port 102a and direct 8 A of charging current from the first power supply 104a and 8 A of charging current from the second power supply 104b to the second port 102b to charge the first battery pack 200g1 at a 16 A charge rate. As illustrated, at some point after charging of the first battery pack 200g1 has begun a second battery pack 200a1 having a maximum capable charge rate of 4 A is coupled to the first port 102a of the charger 100c. Even though the charger recognizes that a battery pack has been coupled to the first port 102a—and the first switch 112a is closed, as described above—the bridge assembly circuit 108 will not otherwise be reconfigured. In other words, the bridge assembly circuit 108 will still direct 16 A of charging current to the second port 102b to charge the first battery pack 200g1 at a 16 A charge rate. Once the first battery pack 200g1 has been fully charged the first power supply 104a is reconfigured to provide a charging current of 4 A and the second power supply 104b is reconfigured to provide a charging current of 0 A. Furthermore, the bridge assembly circuit 108 is reconfigured to direct the 4 A charging current from the first power supply 104a to the first port 102a to charge the second battery pack 200a1 at a 4 A charge rate and direct OA of the charging current to the second port 102b such that the second battery pack 200g1 is not being charged. In this instance, the charger 100c is configured to maintain the maximum charge rate on the higher capacity until it is fully charged and thereafter provide the maximum charge rate to the lower capacity battery pack-that was coupled to the charger second.

With reference to FIG. 30, there is illustrated an example charger 100c and a two pack, sequential power sharing charging scheme. The charger 100c includes a first power supply 104a capable of providing a maximum charging current of 8 A and a second power supply 104b capable of providing a maximum charging current 8 A. In alternate embodiments, the charger 100c may include power supplies that are capable of providing a maximum charging current greater than 8 A or less than 8 A. In this charging scheme, a first battery pack 200g1 having a maximum capable charge rate of 16 A is initially coupled to the second port 102b. In this example, once the first battery pack 200g1 is coupled to the charger 100c the first power supply 104a is configured to provide a charging current of 8 A and the second power supply 104b is configured to provide a charging current of 8 A. Furthermore, the bridge assembly circuit 108 is configured to direct OA of charging current to the first port 102a and direct 8 A of charging current from the first power supply 104a and 8 A of charging current from the second power supply 104b to the second port 102b to charge the first battery pack 200g1 at a 16 A charge rate. As illustrated, at some point after charging of the first battery pack 200g1 has begun a second battery pack 200e2 having a maximum capable charge rate of 12 A is coupled to the first port 102a of the charger 100c. Even though the charger recognizes that a battery pack has been coupled to the first port 102a—and the first switch 112a is closed, as described above—the bridge assembly circuit 108 will not otherwise be reconfigured. In other words, the bridge assembly circuit 108 will still direct 16 A of charging current to the second port 102b to charge the first battery pack 200g1 at a 16 A charge rate. Once the first battery pack 200g1 has been fully charged the first power supply 104a is reconfigured to provide a charging current of 4 A and the second power supply 104b is reconfigured to provide a charging current of 8 A. Furthermore, the bridge assembly circuit 108 is reconfigured to direct the 4 A charging current from the first power supply 104a and direct the 8 A charging current from the second power supply 104b to the first port 102a to charge the second battery pack 200e2 at a 12 A charge rate and direct OA of the charging current to the second port 102b such that the second battery pack 200g1 is not being charged. In this instance, the charger 100c is configured charge the first pack received at a maximum charge rate until it is fully charged, even if another battery pack is coupled to the charger, regardless of the SOC or capacity or maximum charge current capability of the two battery packs and thereafter provide the maximum charge rate to the second battery pack coupled to the charger.

With reference to FIG. 31, there is illustrated an example charger 100c and a two pack, sequential power sharing charging scheme. The charger 100c includes a first power supply 104a capable of providing a maximum charging current of 8 A and a second power supply 104b capable of providing a maximum charging current 8 A. In alternate embodiments, the charger 100c may include power supplies that are capable of providing a maximum charging current greater than 8 A or less than 8 A. In this charging scheme, a first battery pack 200g1a having a maximum capable charge rate of 16 A and a SOC of 50% is coupled to the first port 102a and a second battery pack 200g1b having a maximum capable charge rate of 16 A and an SOC of 20% is coupled to the second port 102b. In this example, both battery packs may be coupled to the charger 100c, for all intents and purposes, at the same time or the second battery pack may be coupled to the charger after charging has already begun on the first battery pack of the first battery pack may be coupled to the charger after charging has already begun on the second battery pack. In this example, the first power supply 104a is configured to provide a charging current of 8 A and the second power supply 104b is configured to provide a charging current of 8 A. Furthermore, the bridge assembly circuit 108 is configured to direct 0 A of the charging current from the first power supply 104a to the second port 102b such that the second battery pack 200g1b is not being charged and direct 8 A of charging current from the first power supply 104a and 8 A of charging current from the second power supply 104b to the first port 102a to charge the first battery pack 200g1b at a 16 A charge rate. Once the first battery pack 200g1a is fully charged the bridge assembly circuit 108 is reconfigured to direct 8 A of the charging current from the first power supply 104a and 8 A of the charging current from the second power supply 104b to the second port 102b to charge the second battery pack 200g1b at a 16 A charge rate and direct OA of the charging current to the first port 102a such that the first battery pack 200g1a is not being charged. In this instance, any time there are two battery packs coupled to the charger, the charger 100c is configured to first charge the battery pack having the higher SOC at its maximum capable charge rate while not charging the battery pack having the lower SOC and once the battery pack having the higher SOC has been fully charged then charge the battery pack having the lower SOC at its maximum charge rate until it has been fully charged.

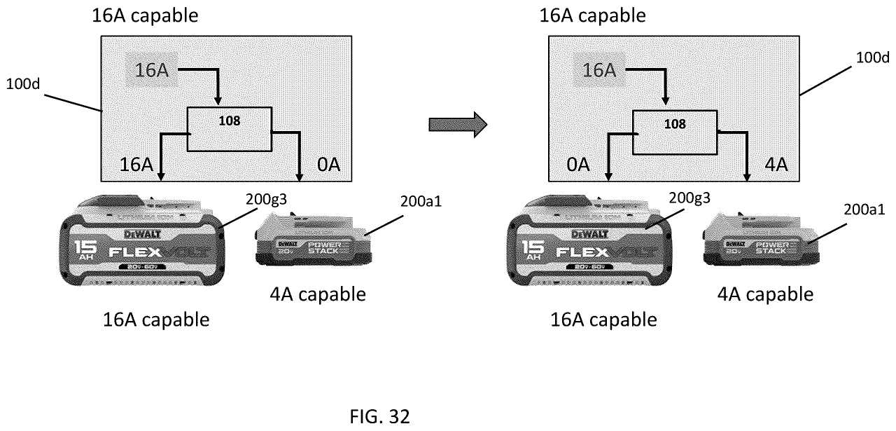

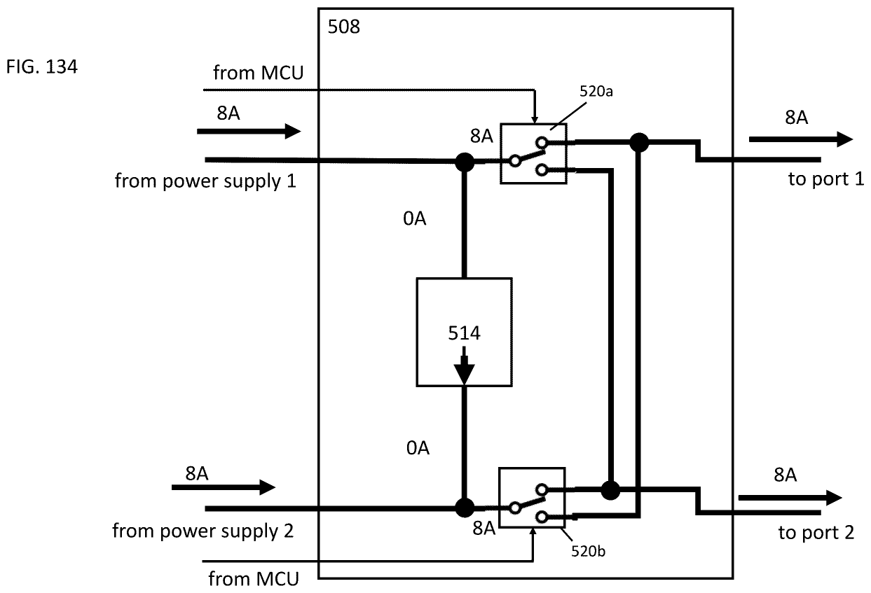

With reference to FIG. 32, there is illustrated an example charger 100d and a two pack, sequential power sharing charging scheme. The charger 100d includes a single power supply 104 capable of providing a maximum charging current of 16 A. In alternate embodiments, the charger 100d may include a power supply that is capable of providing a maximum charging current greater than 16 A or less than 16 A. In this example embodiment, with reference to FIG. 134B, the bridge assembly circuit 108 may include a pair of buck converter circuits electrically connected to the power supply 104. Furthermore, each of the buck converter circuits is electrically coupled to the MCU 106 in order to enable the MCU 106 to configure the buck converter circuit to adjust the amount of charging current the buck converter circuit allows to pass to a respective port 102a, 102b. In this charging scheme, a first battery pack 200a1 having a maximum capable charge rate of 4 A is coupled to the first port 102a and a second battery pack 200g3 having a maximum capable charge rate of 16 A is coupled to the second port 102b. In this example, both battery packs may be coupled to the charger 100d, for all intents and purposes, at the same time or the second battery pack may be coupled to the charger after charging has already begun on the first battery pack or the first battery pack may be coupled to the charger after charging has already begun on the second battery pack. In this example, the power supply 104 is configured to provide a charging current of 16 A. Furthermore, the bridge assembly circuit 108 is configured to direct OA of the charging current from the power supply 104 to the first port 102a such that the first battery pack 200a1 is not being charged and direct 16 A of charging current from the power supply 104 to the second port 102b to charge the second battery pack 200g3 at a 16 A charge rate. Once the second battery pack 200g3 is fully charged the bridge assembly circuit 108 is reconfigured to direct 4 A of the charging current from the power supply 104 to the first port 102a to charge the first battery pack 200a1 at a 4 A charge rate and direct OA of the charging current to the second port 102b such that the second battery pack 200g3 is not being charged. In this instance, any time there are two battery packs coupled to the charger, the charger 100c is configured to first charge the battery pack having the greater capacity at its maximum capable charge rate while not charging the battery pack having the lower capacity and once the battery pack having the higher capacity has been fully charged then charge the battery pack having the lower capacity at its maximum charge rate until it has been fully charged. In this embodiment, the MCU 106 initially configures the first buck converter circuit to pass OA of charging current to the first port 102a and configures the second buck converter circuit to pass 16 A of charging current to the second port 102b. Once the second battery pack 200g3 has been fully charged, the MCU 106 reconfigures the first buck converter circuit to pass 4 A of charging current to the first port 102a and reconfigures the second buck converter circuit to pass OA to the second port 102b.

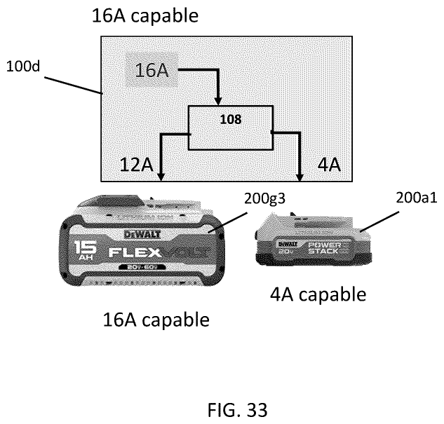

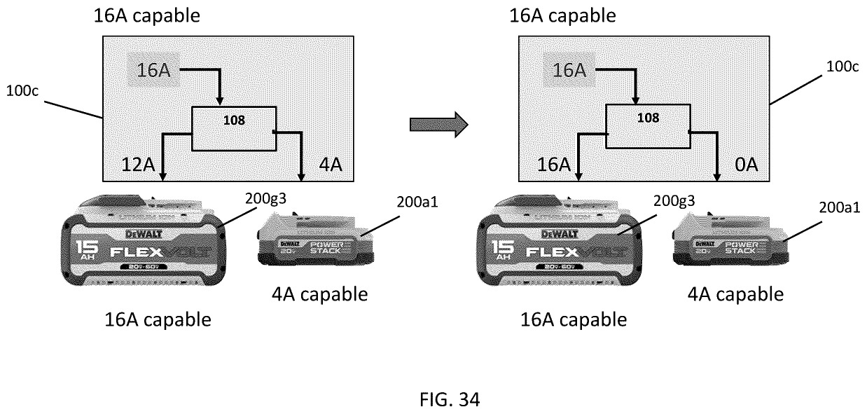

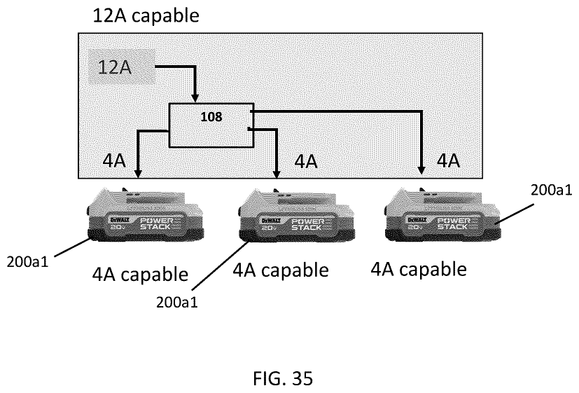

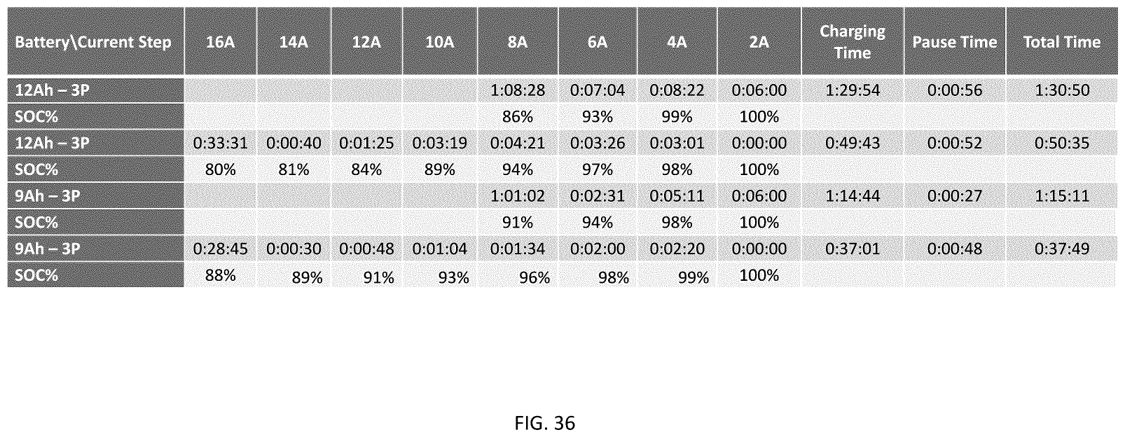

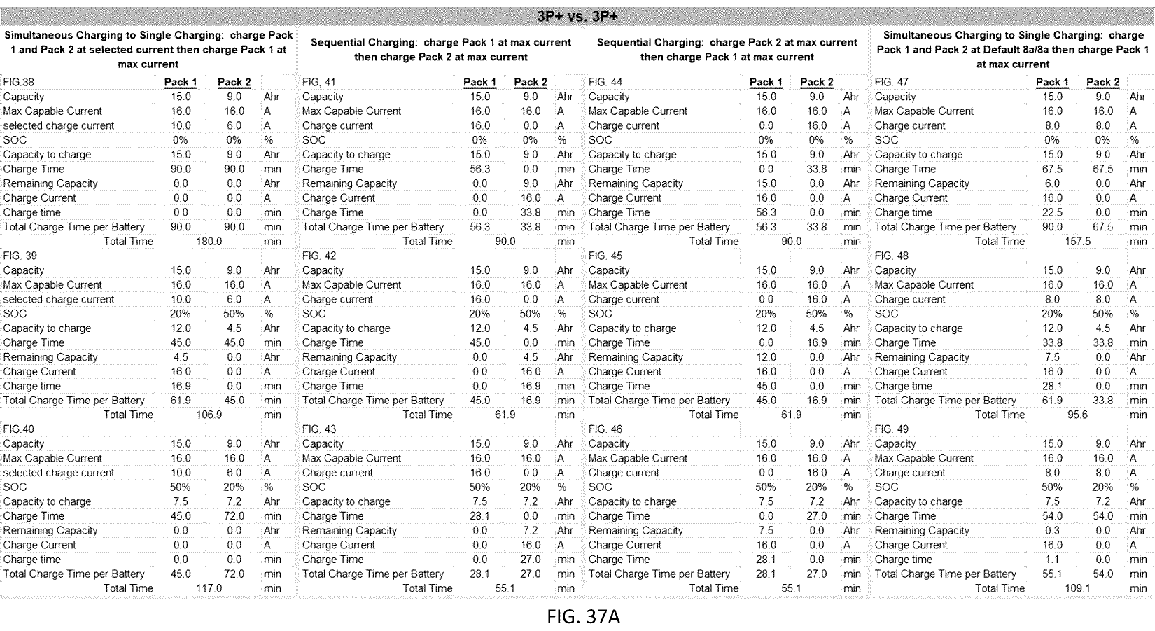

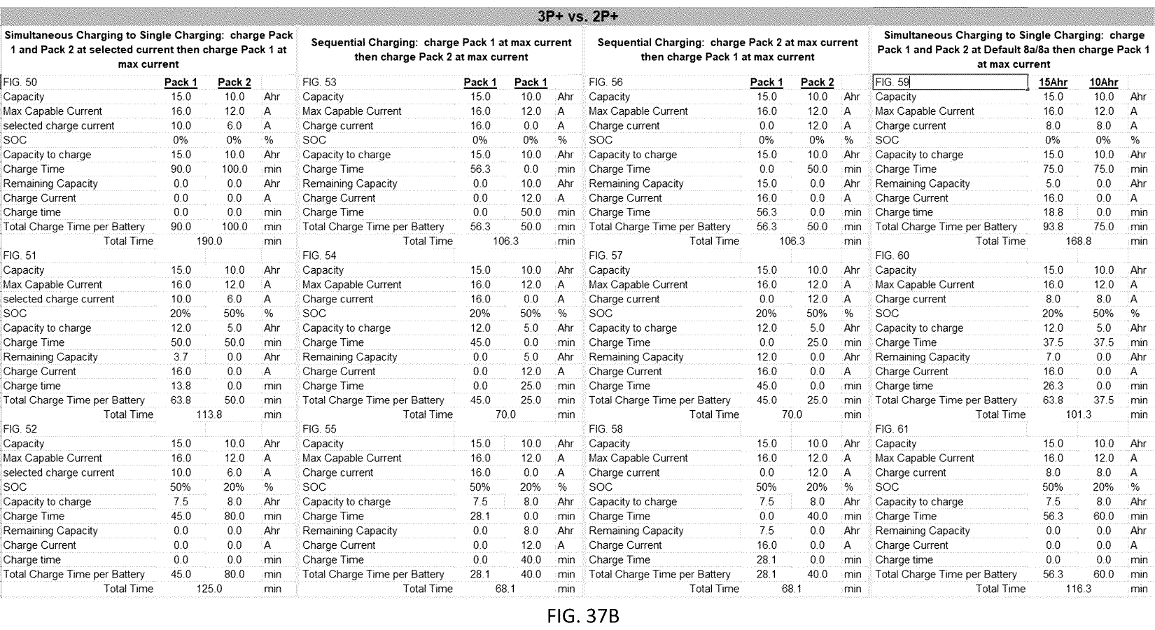

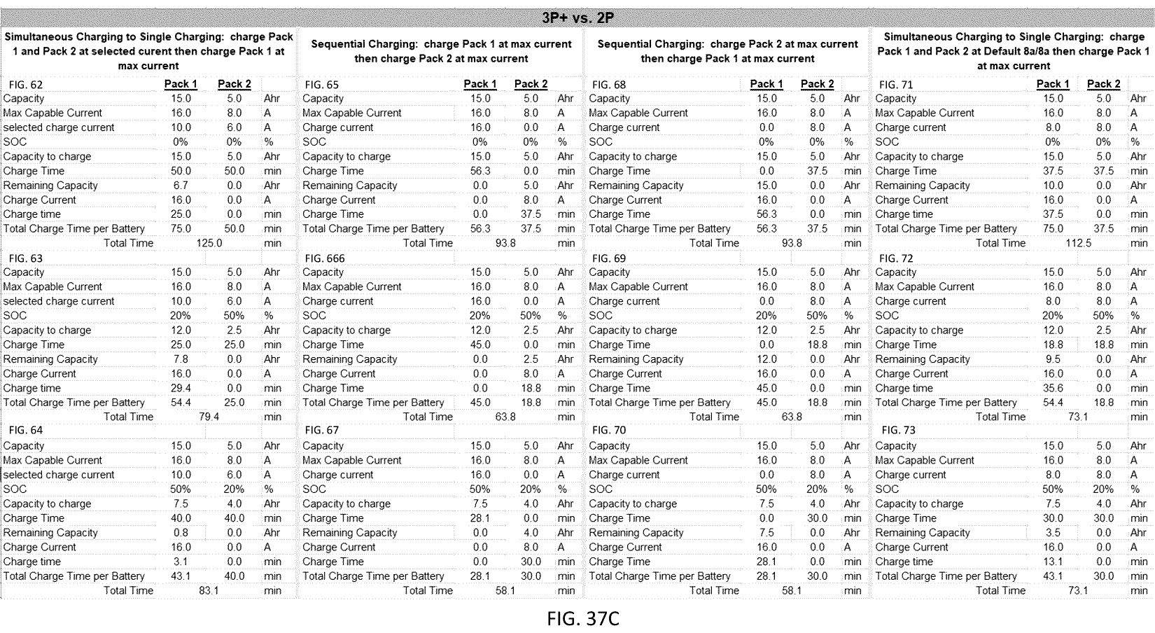

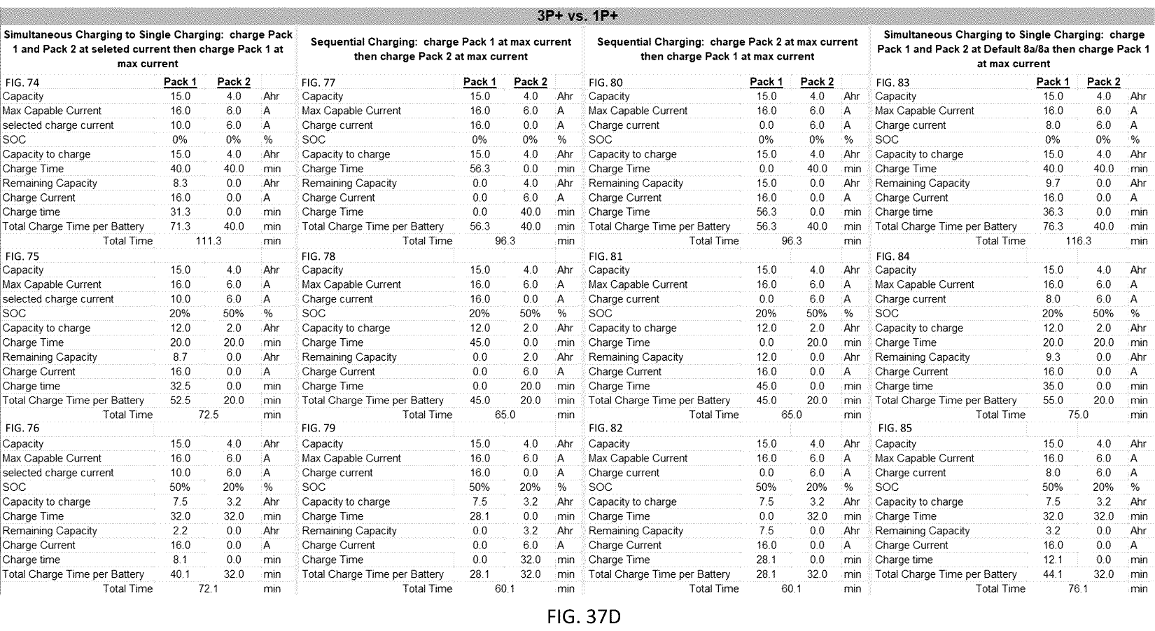

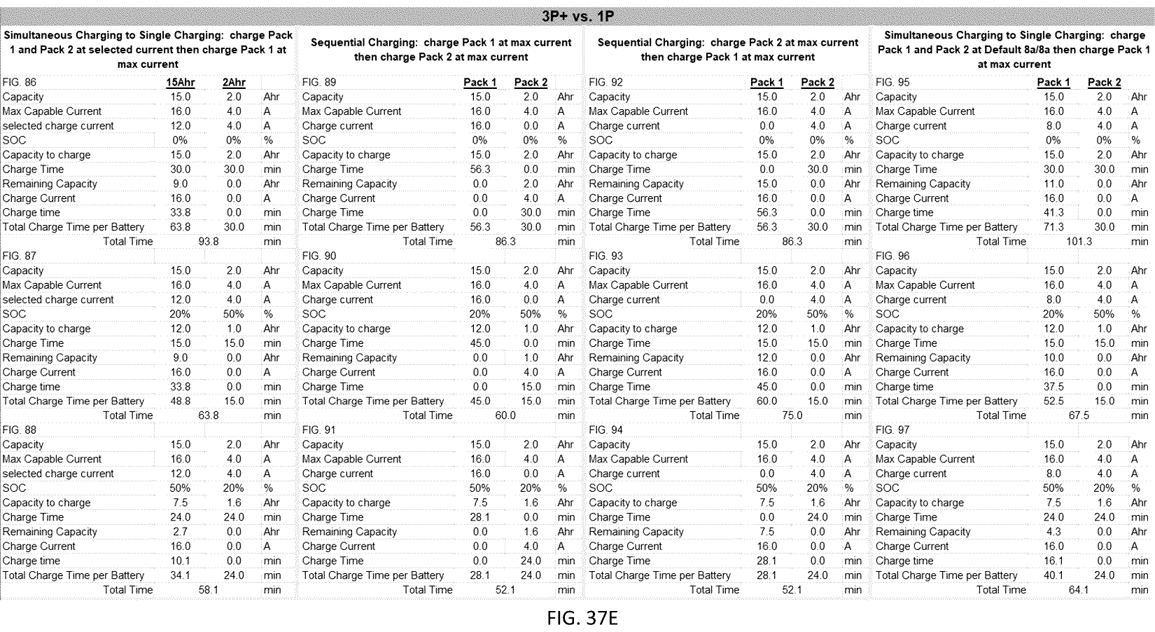

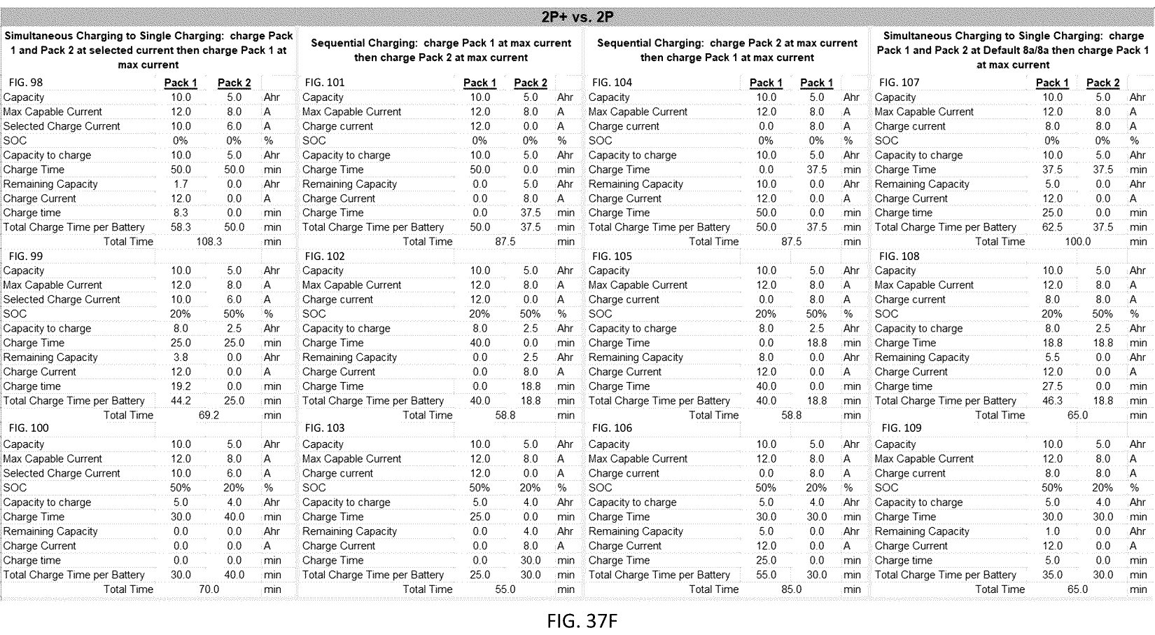

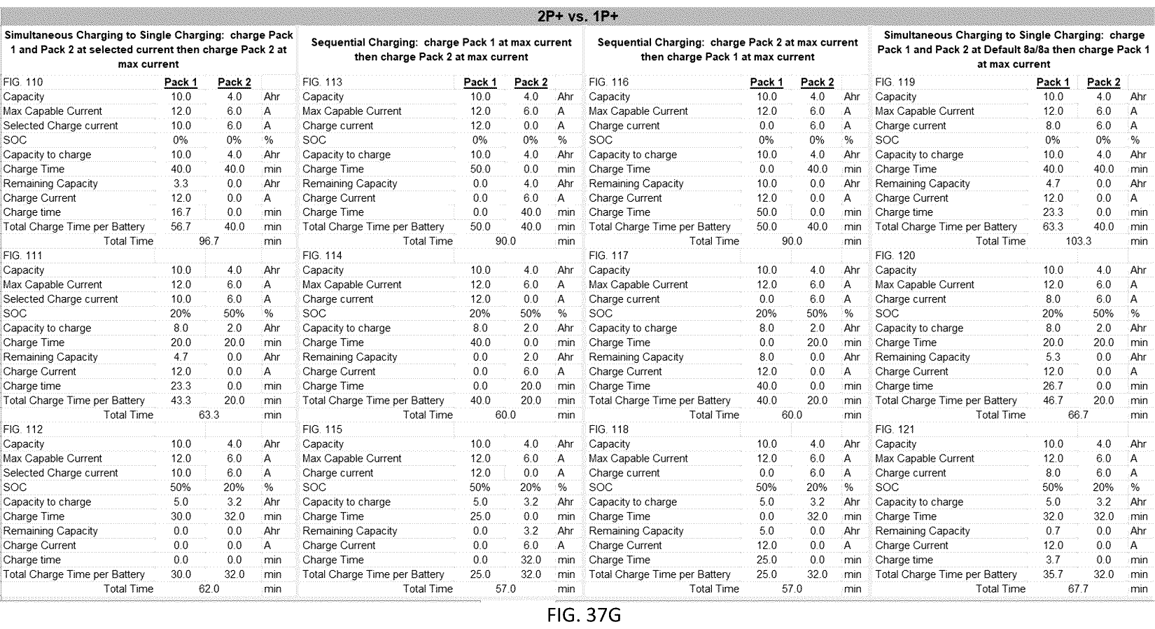

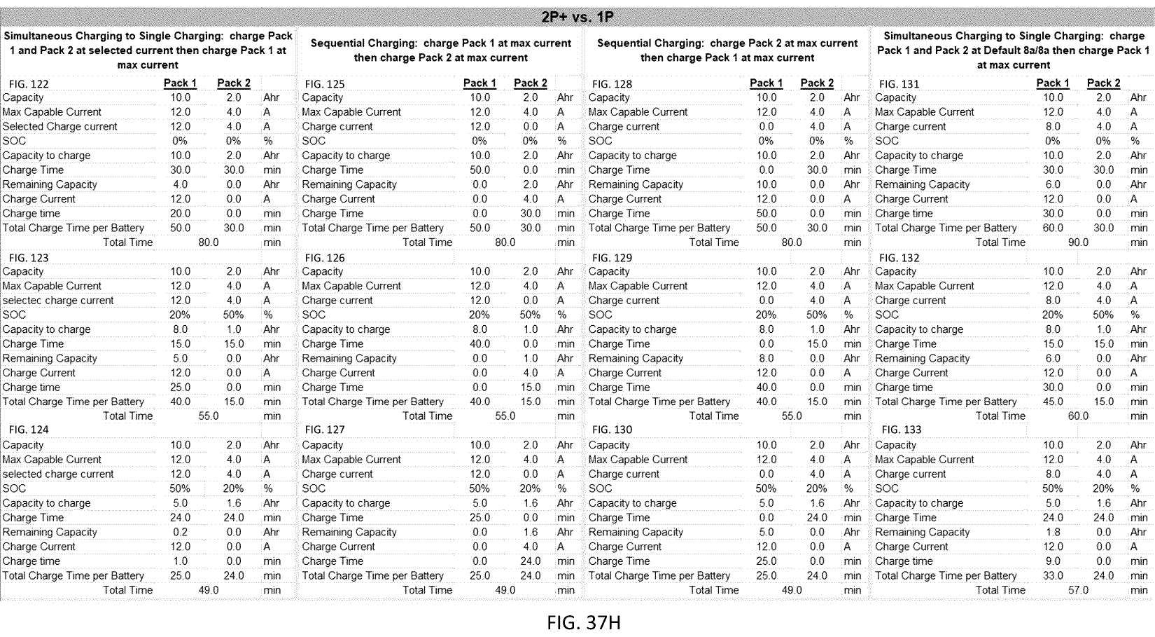

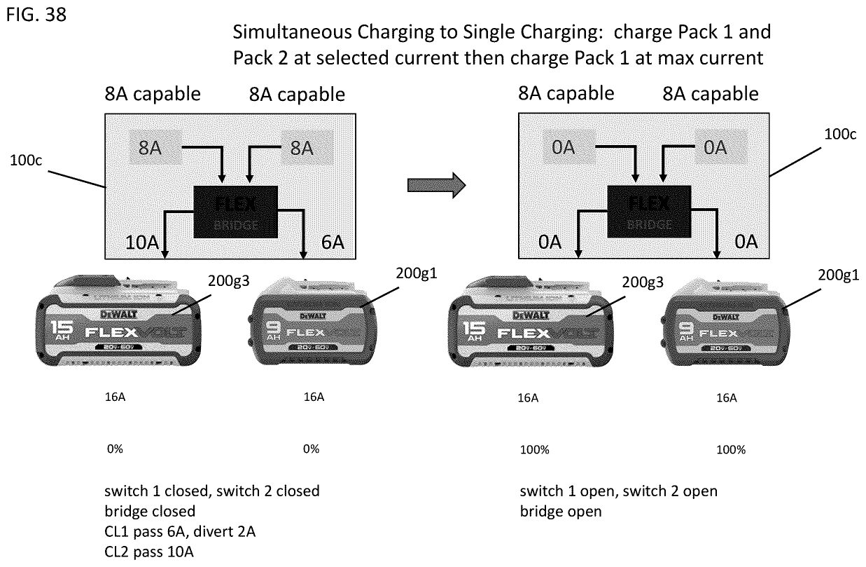

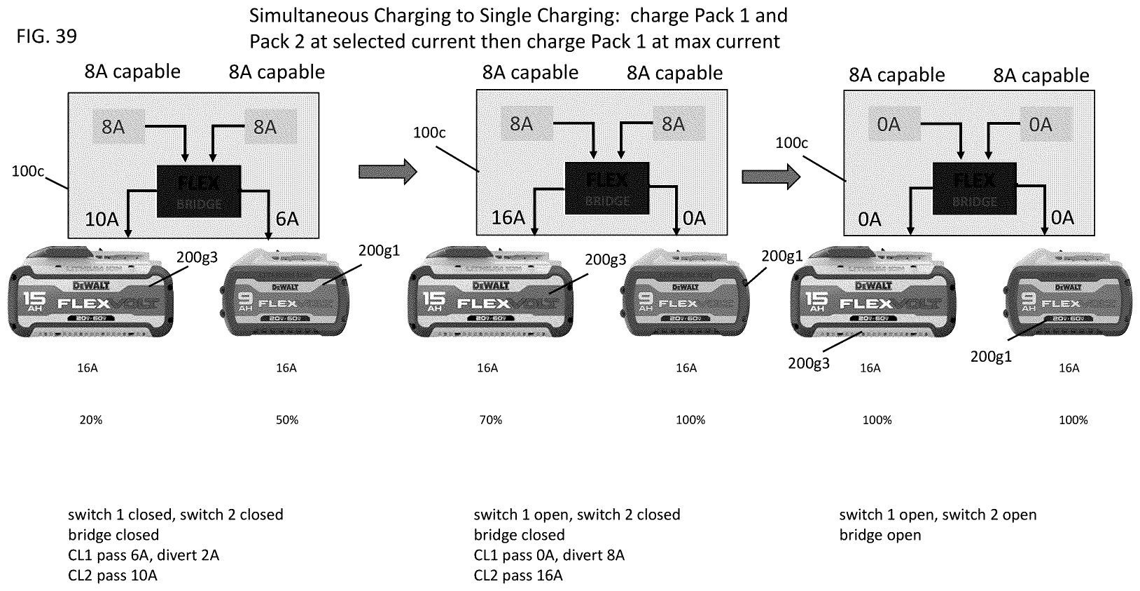

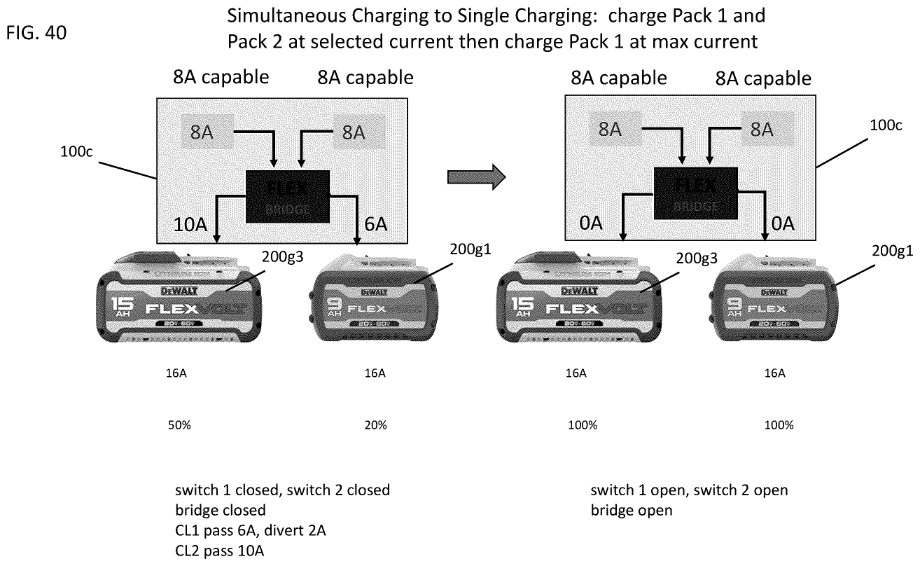

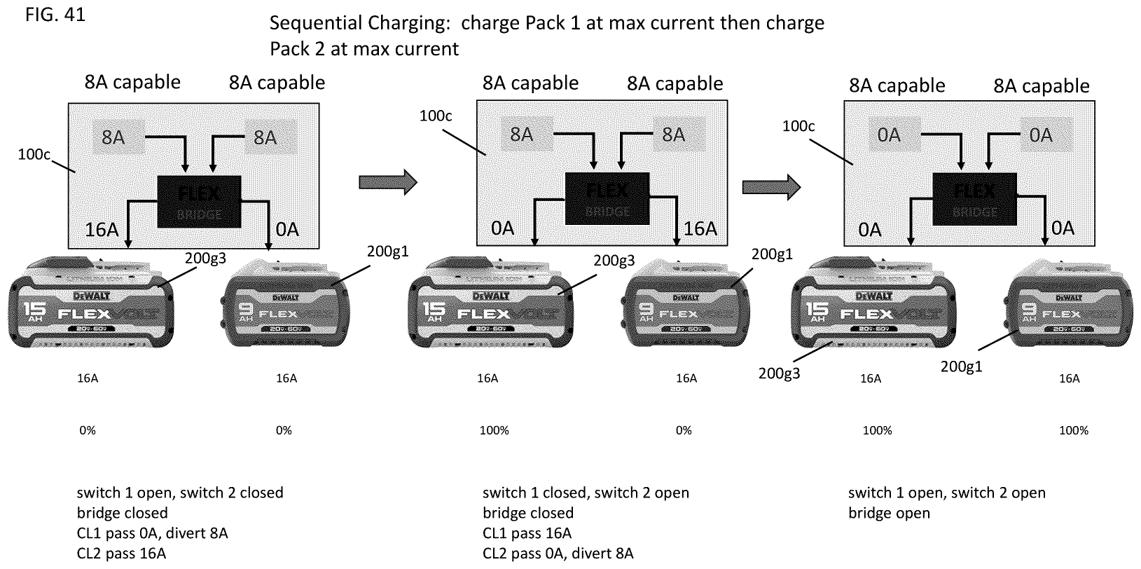

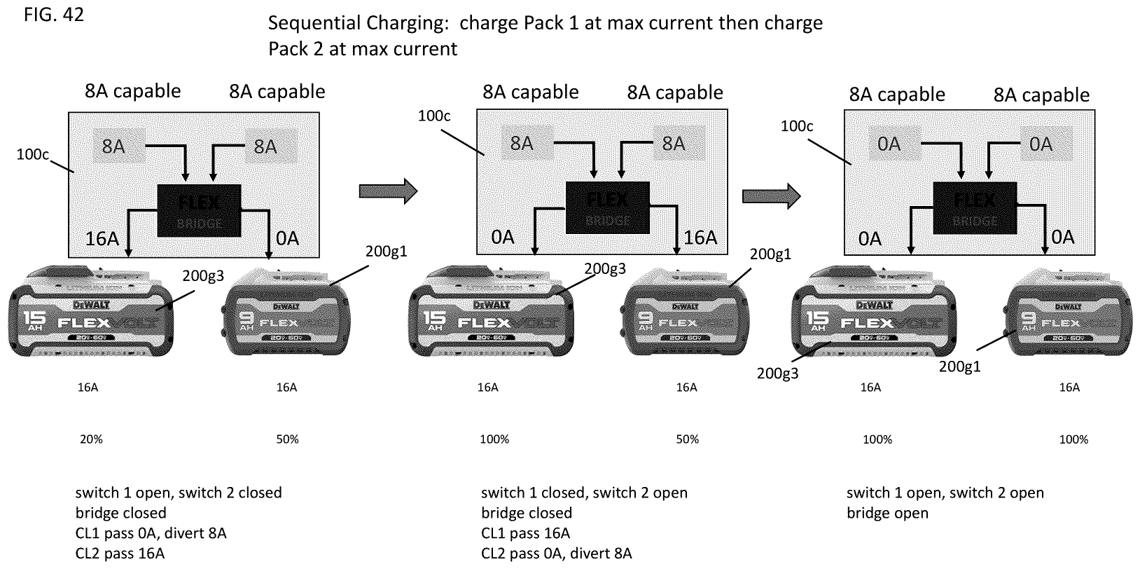

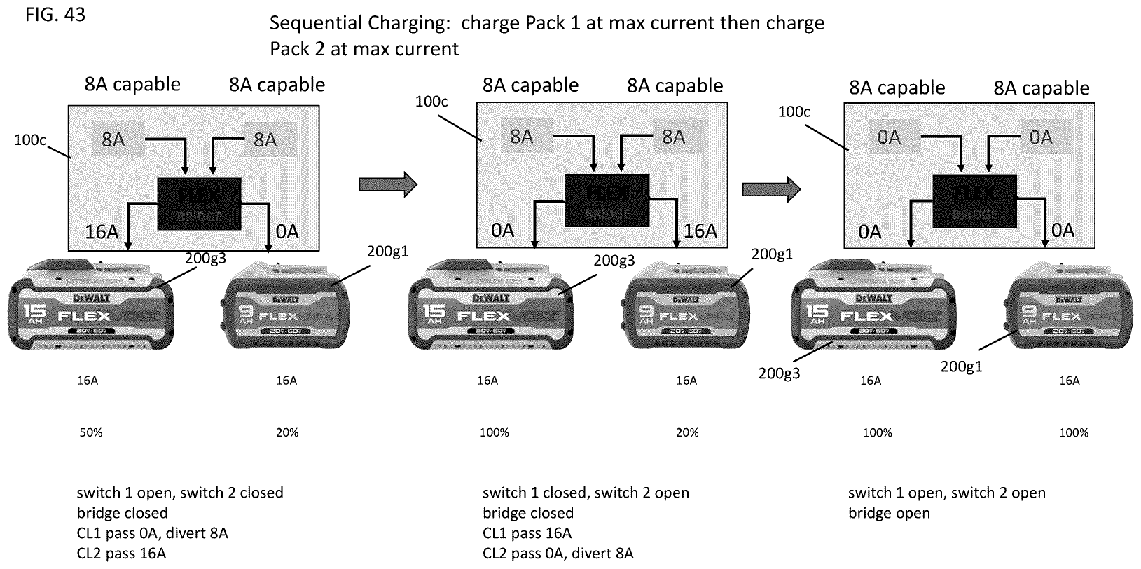

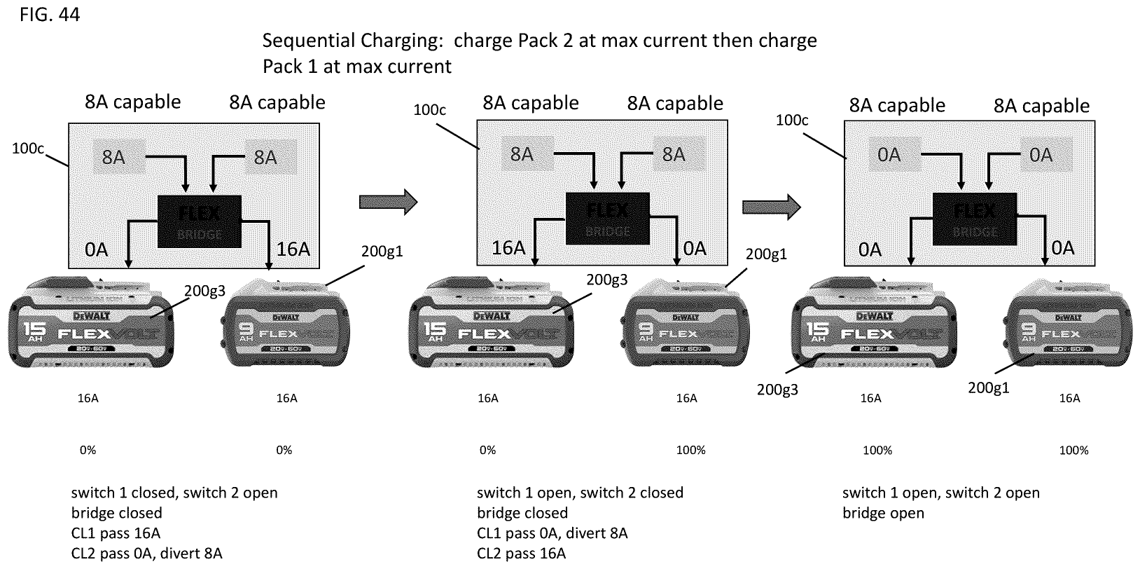

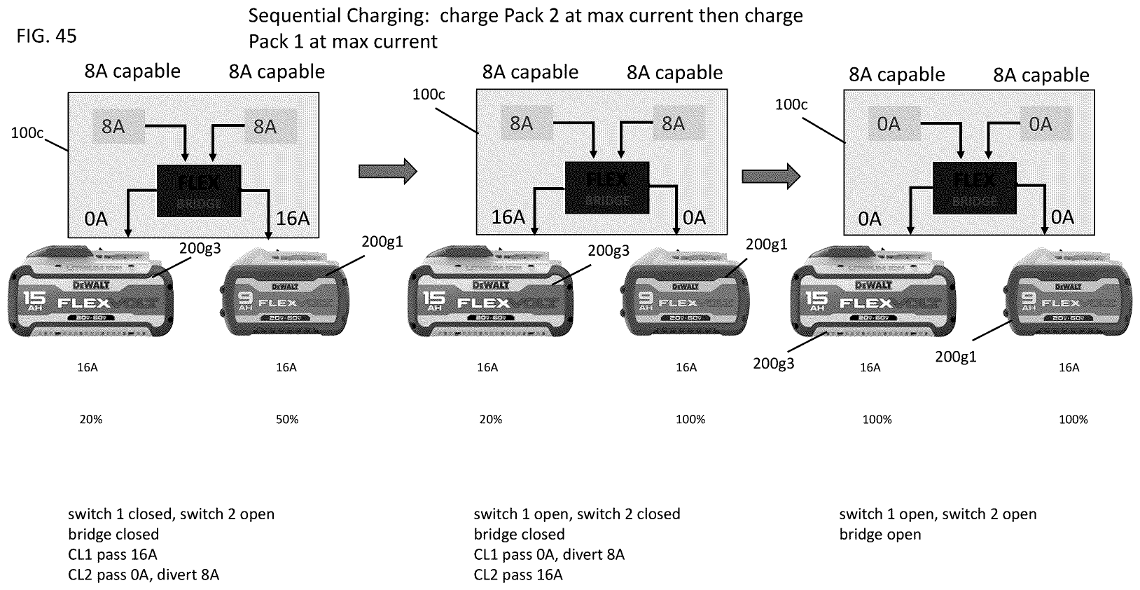

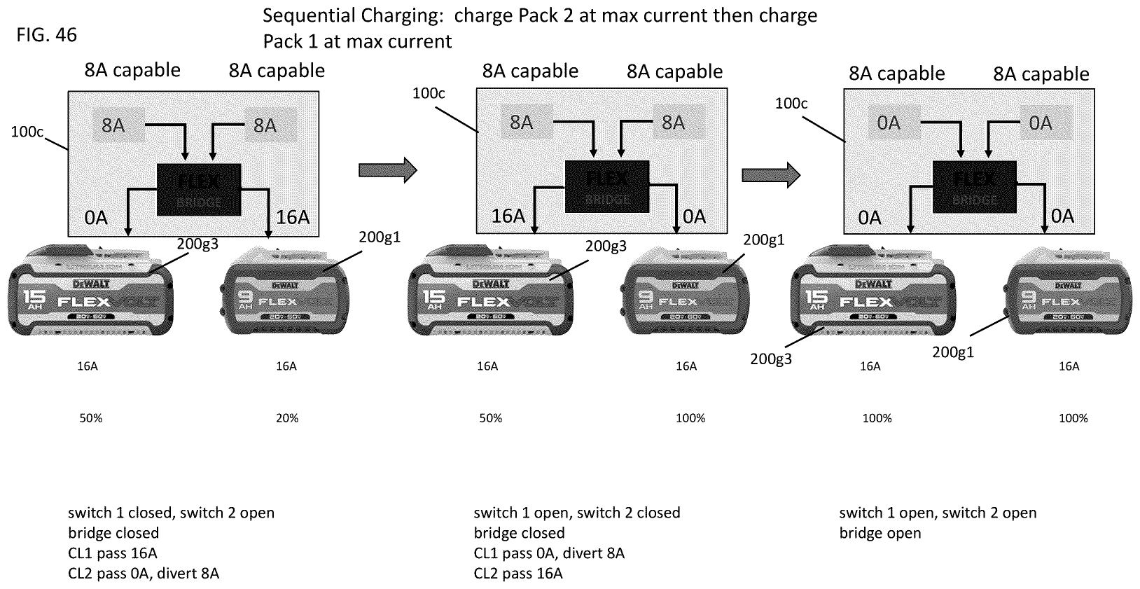

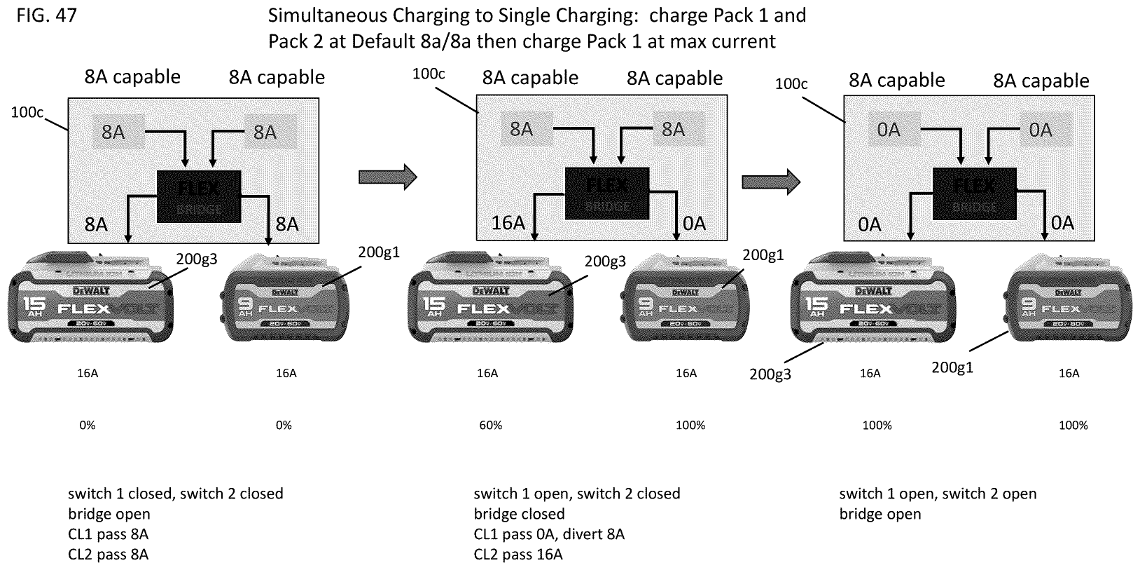

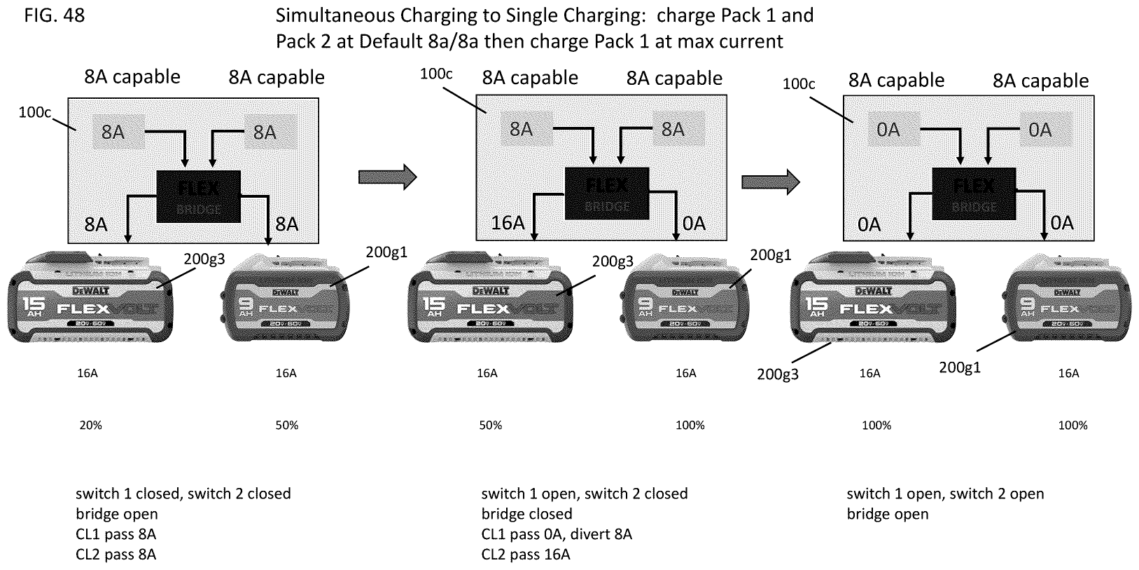

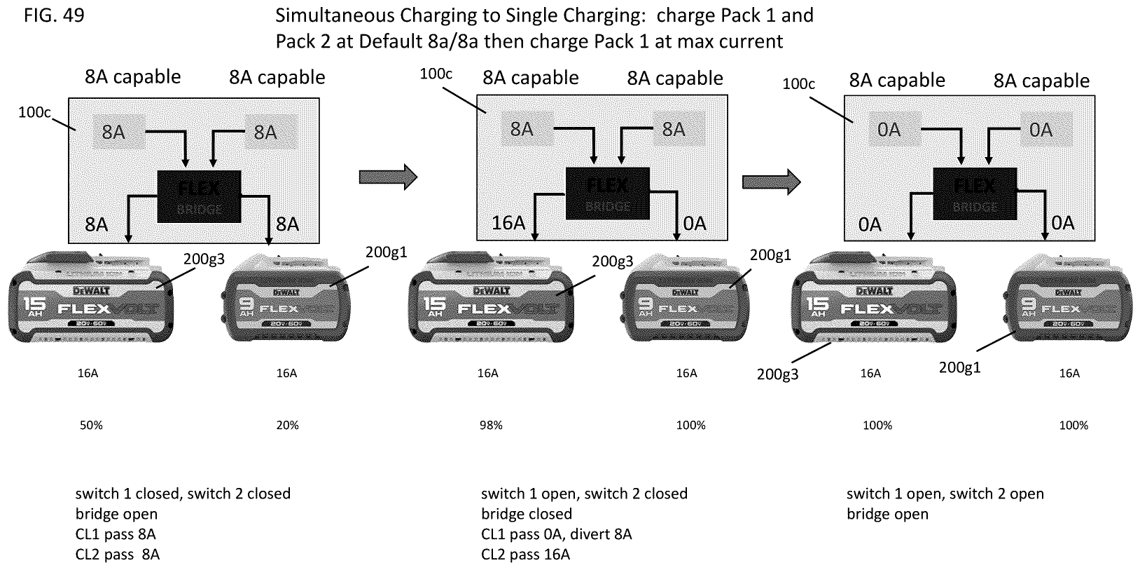

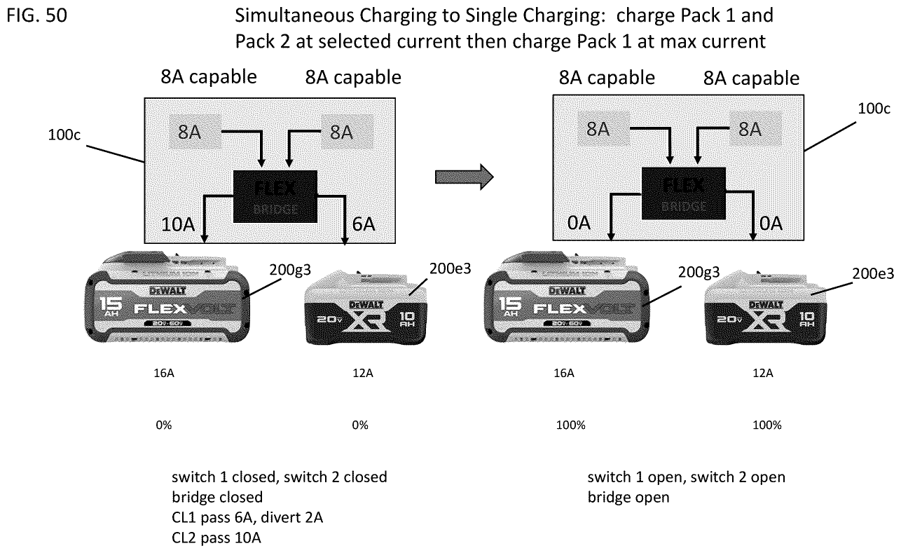

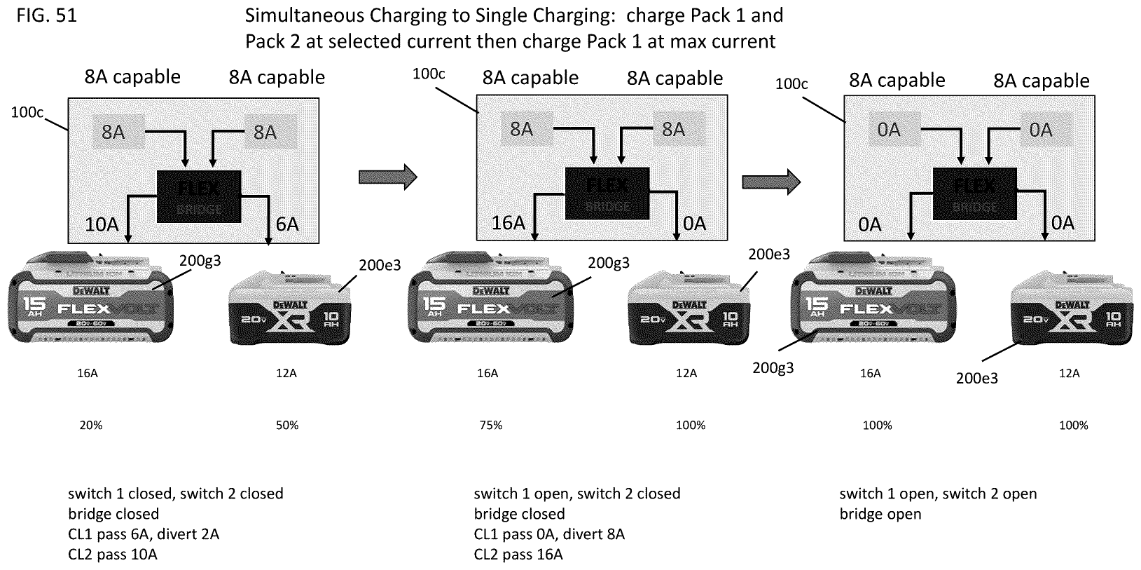

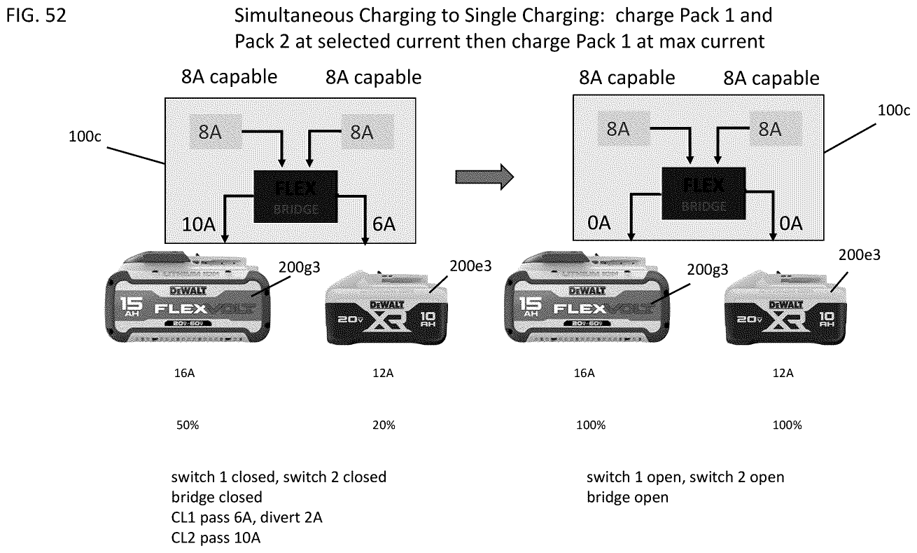

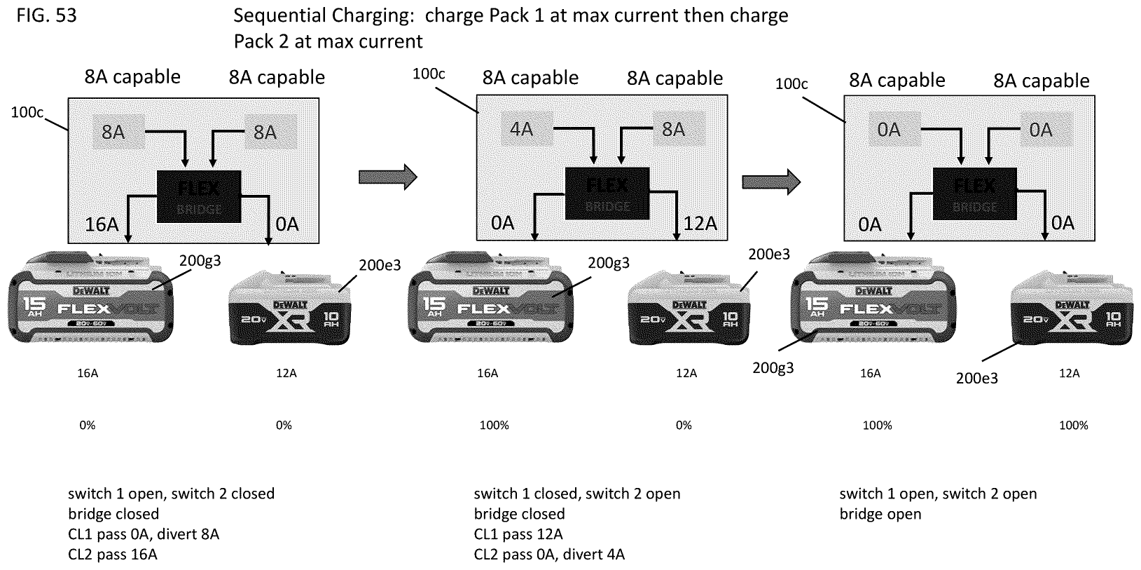

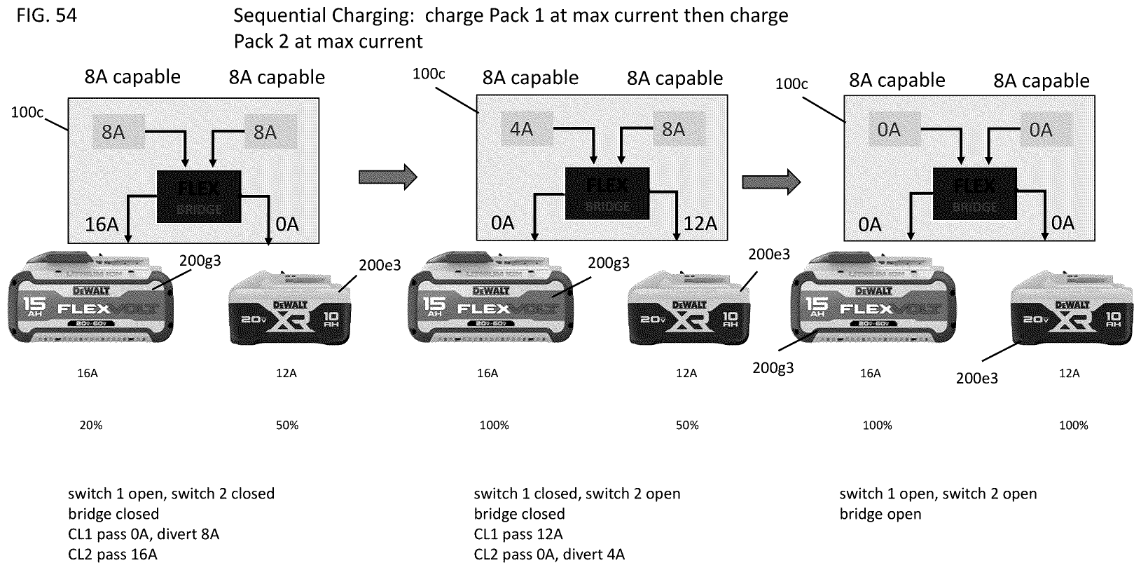

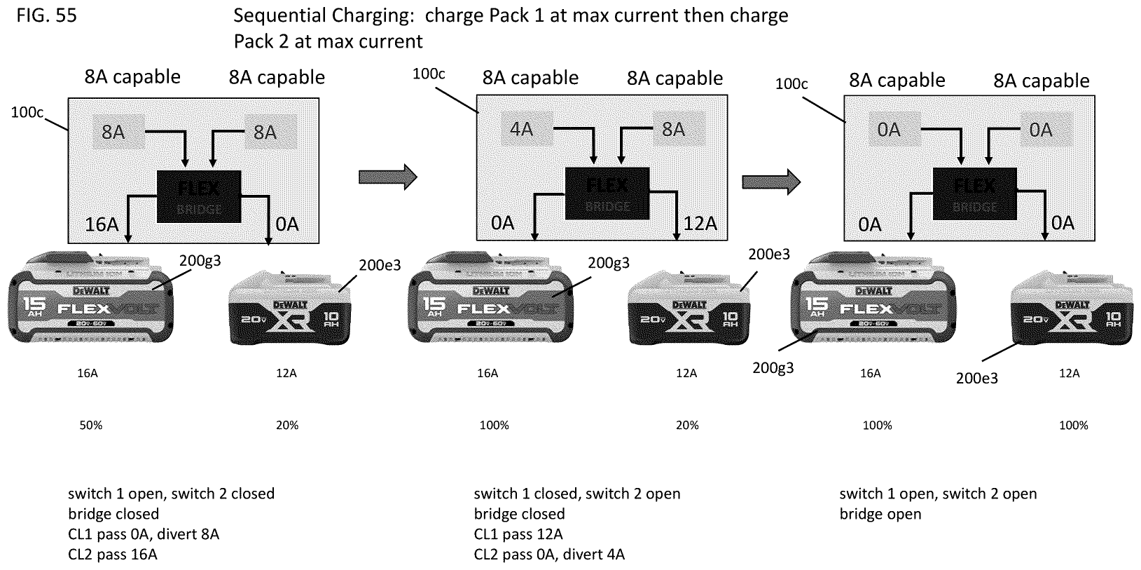

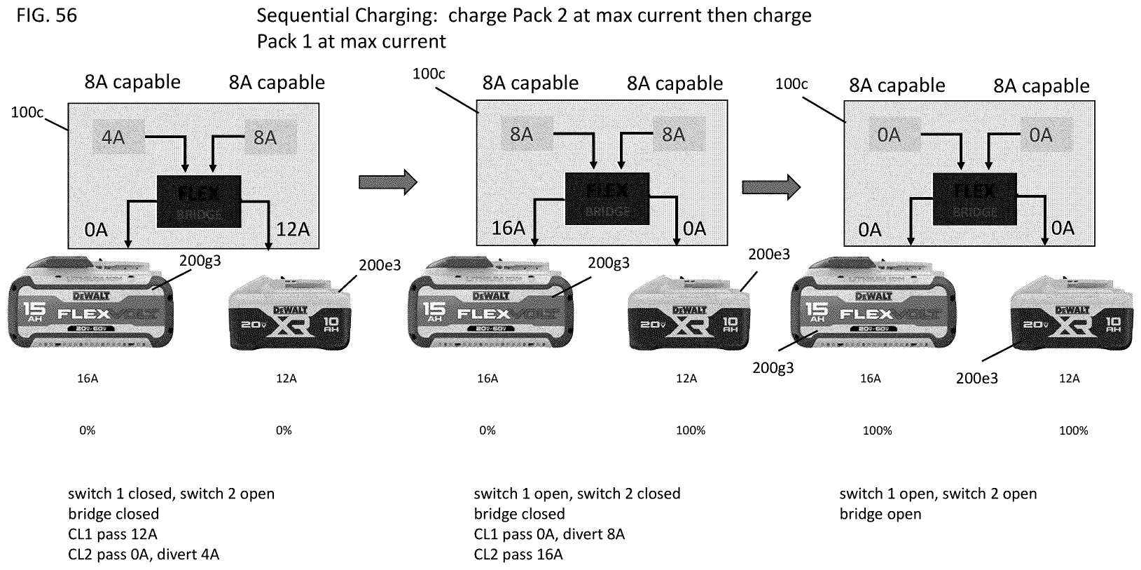

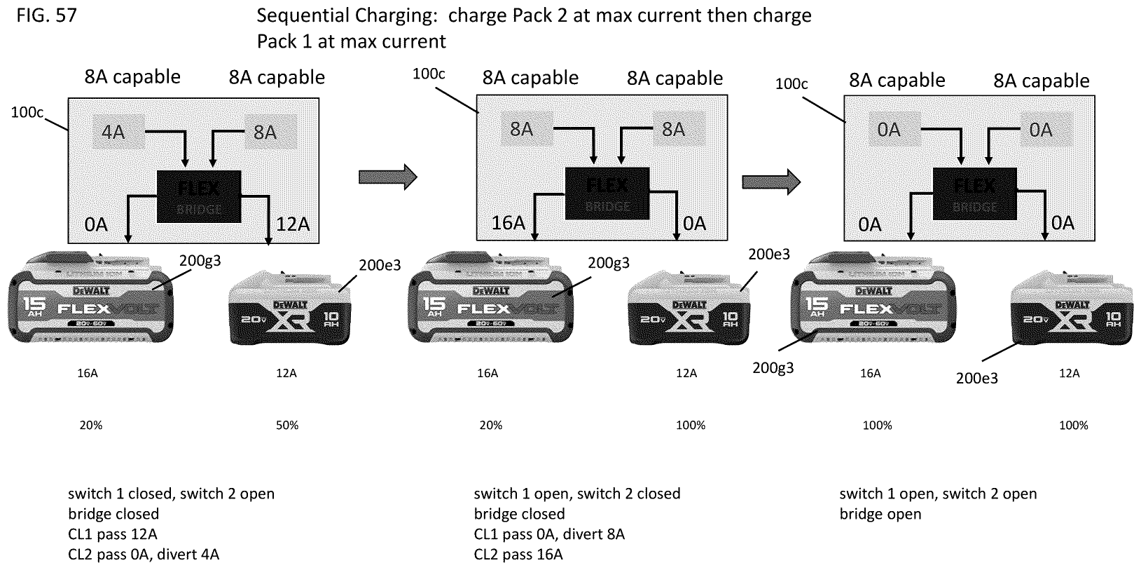

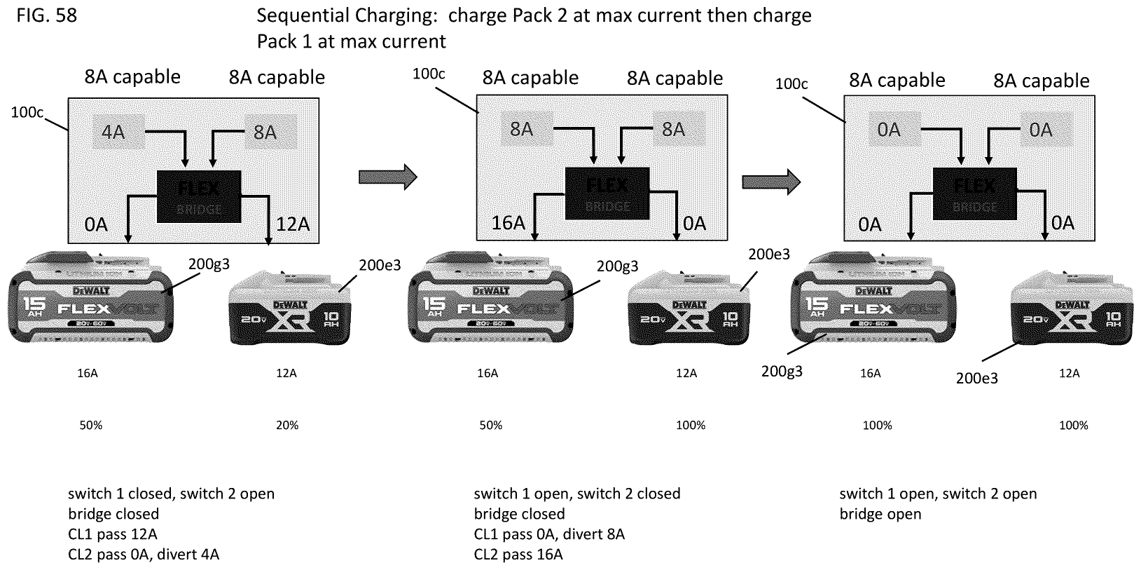

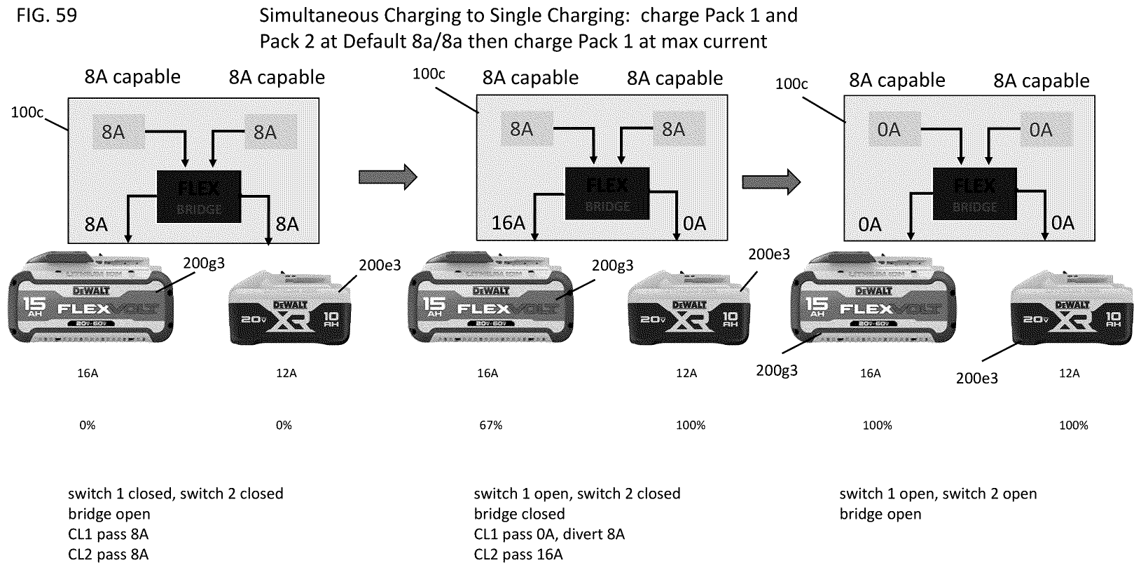

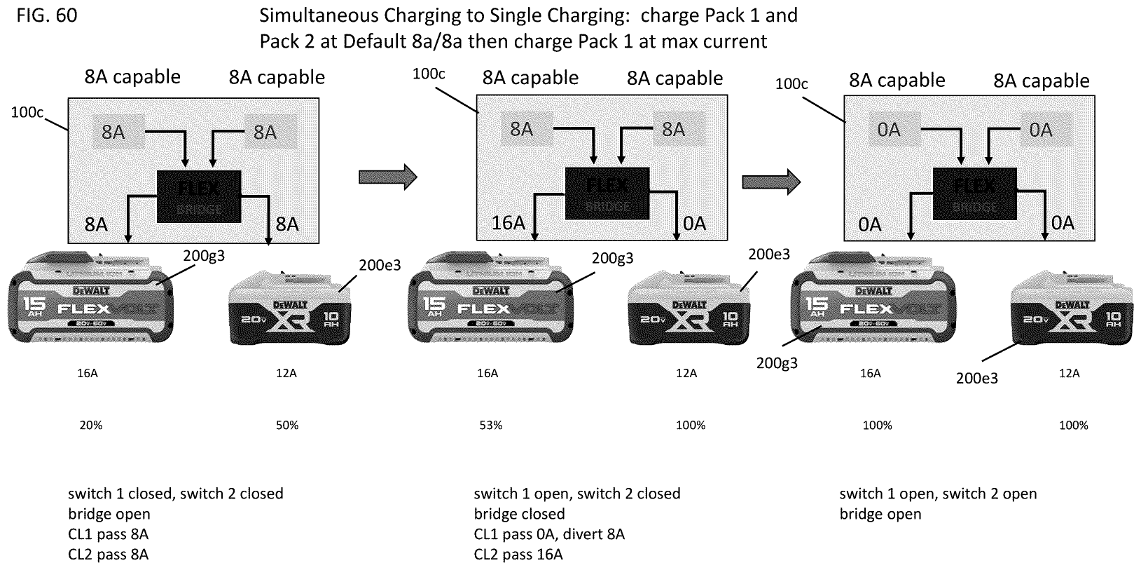

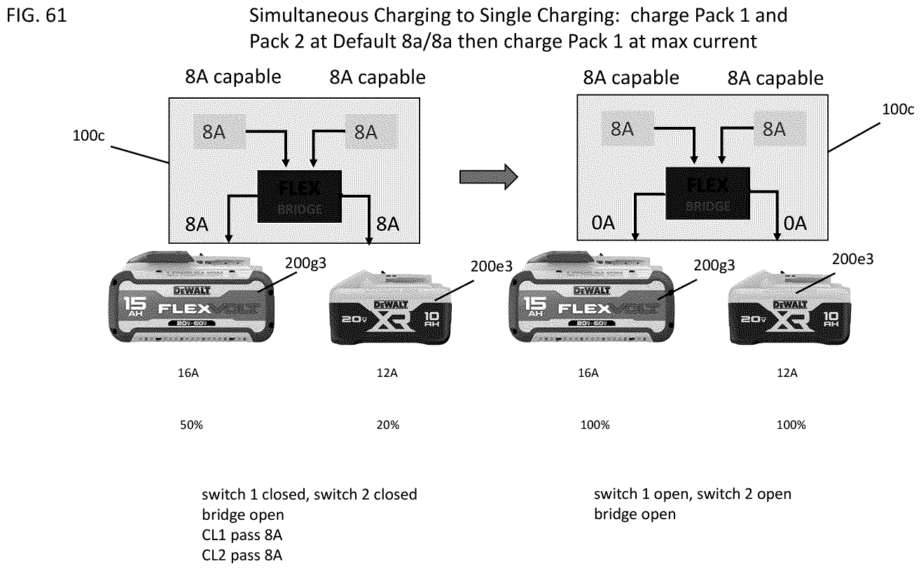

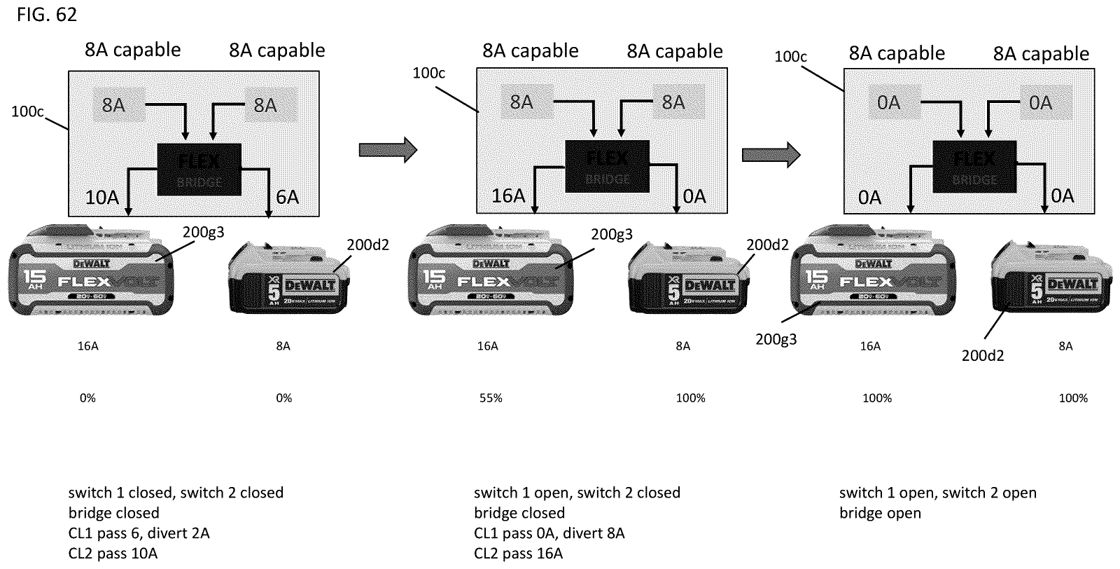

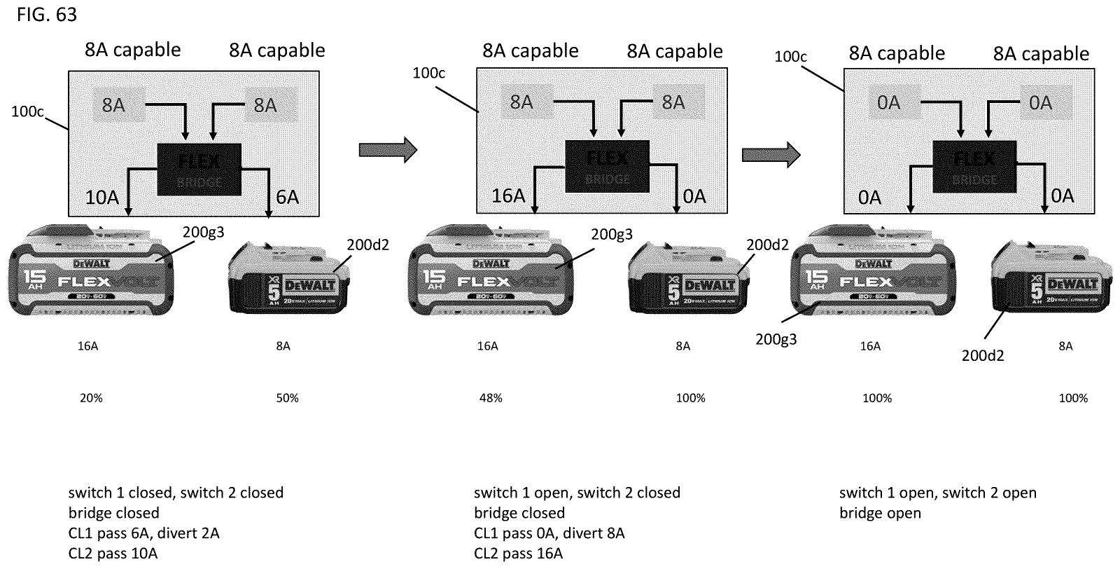

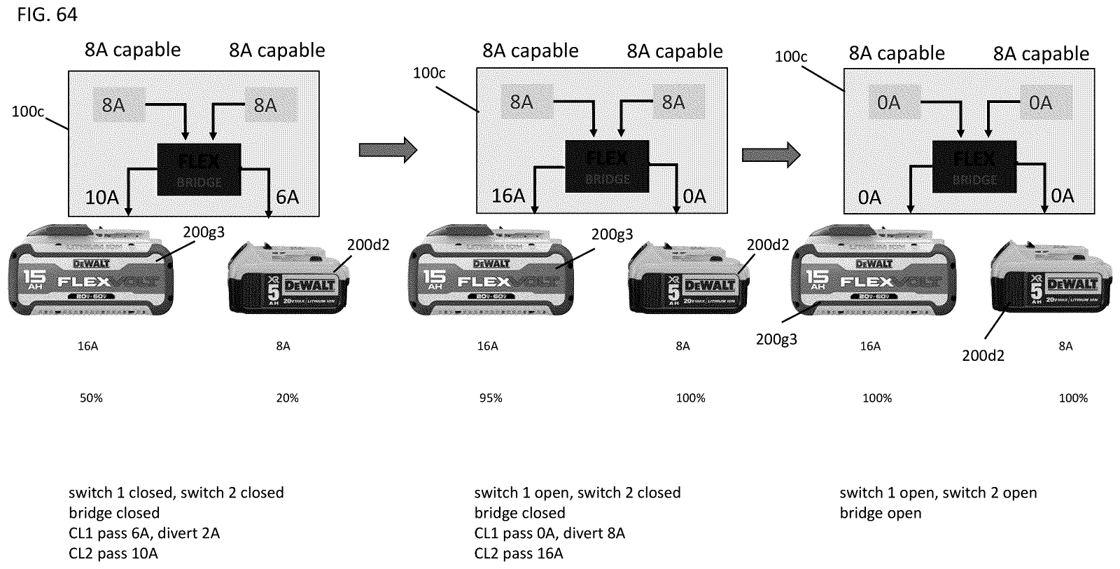

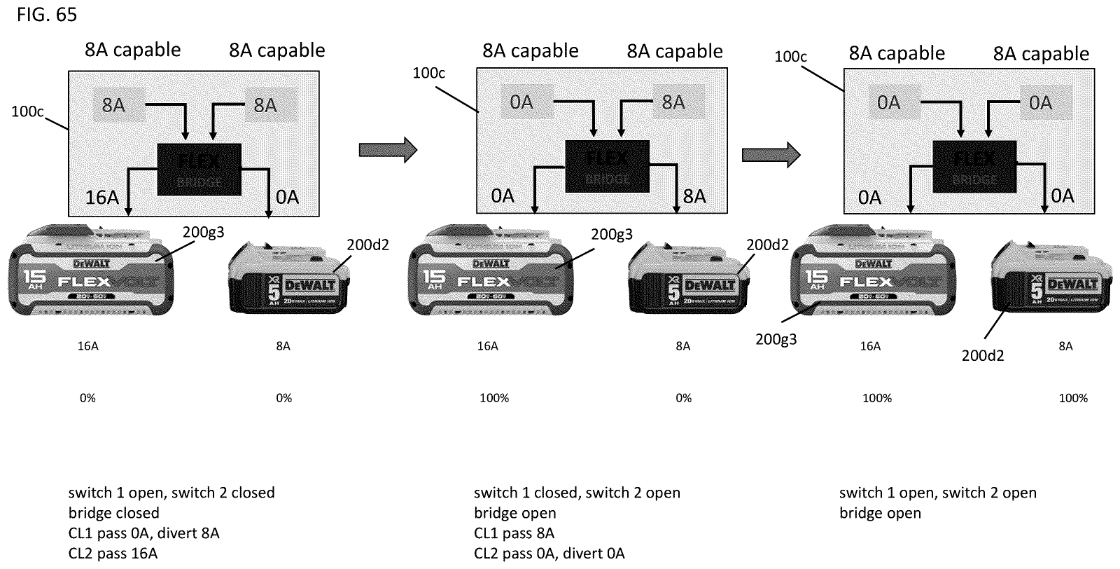

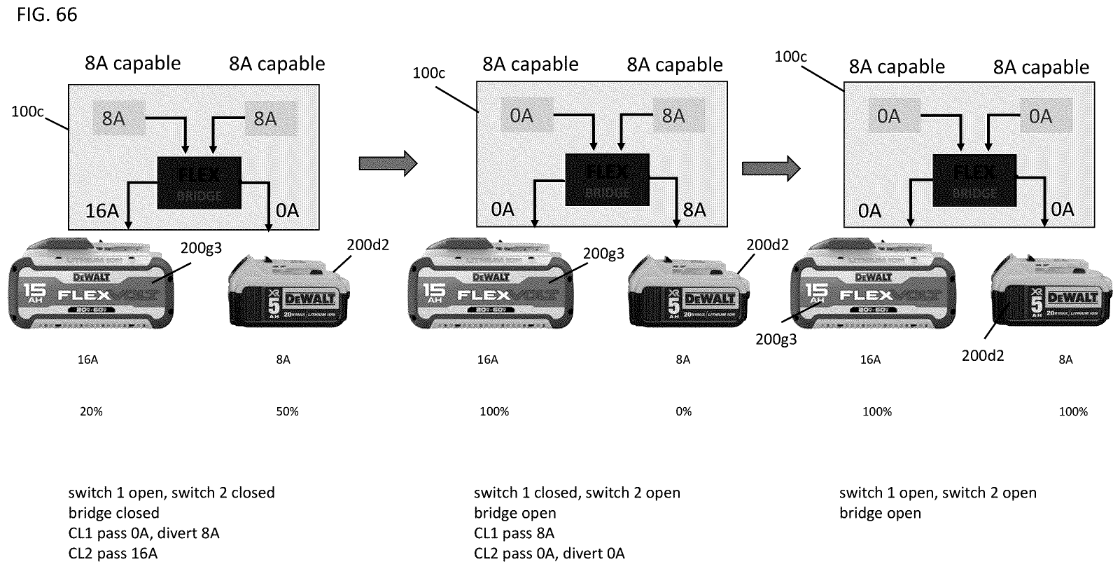

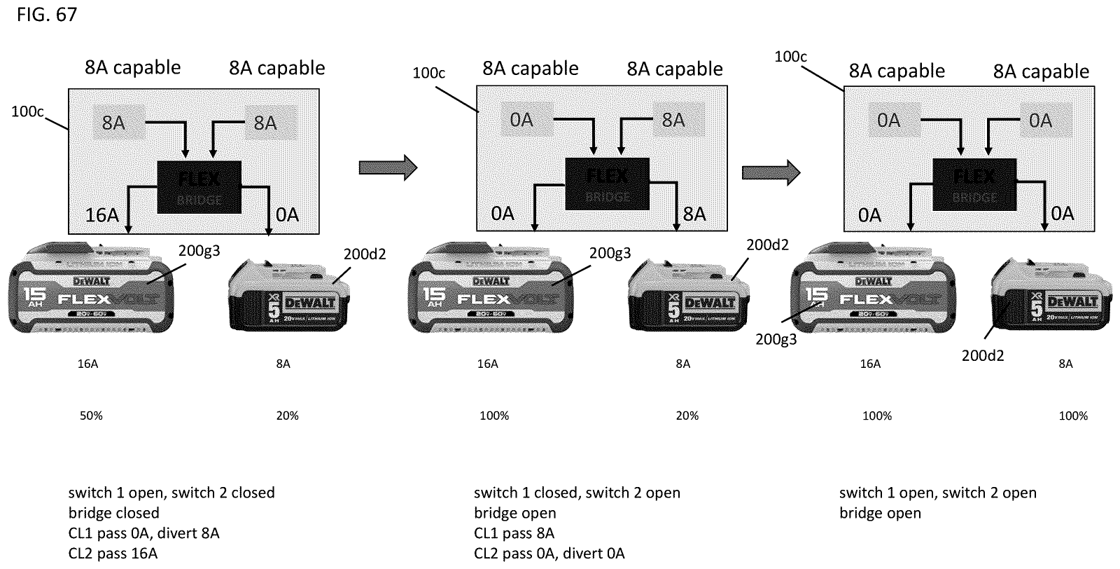

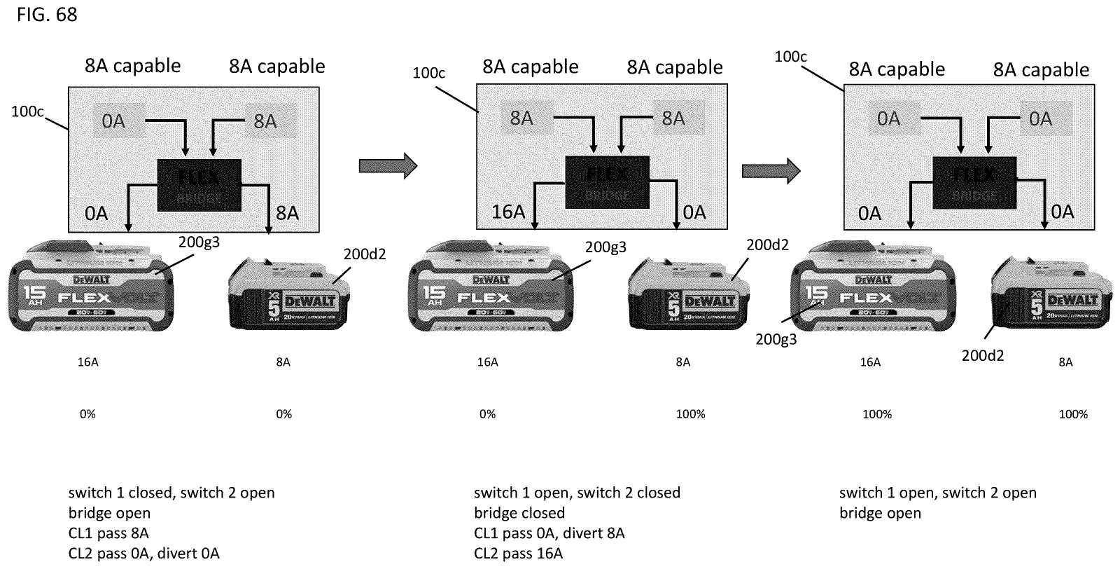

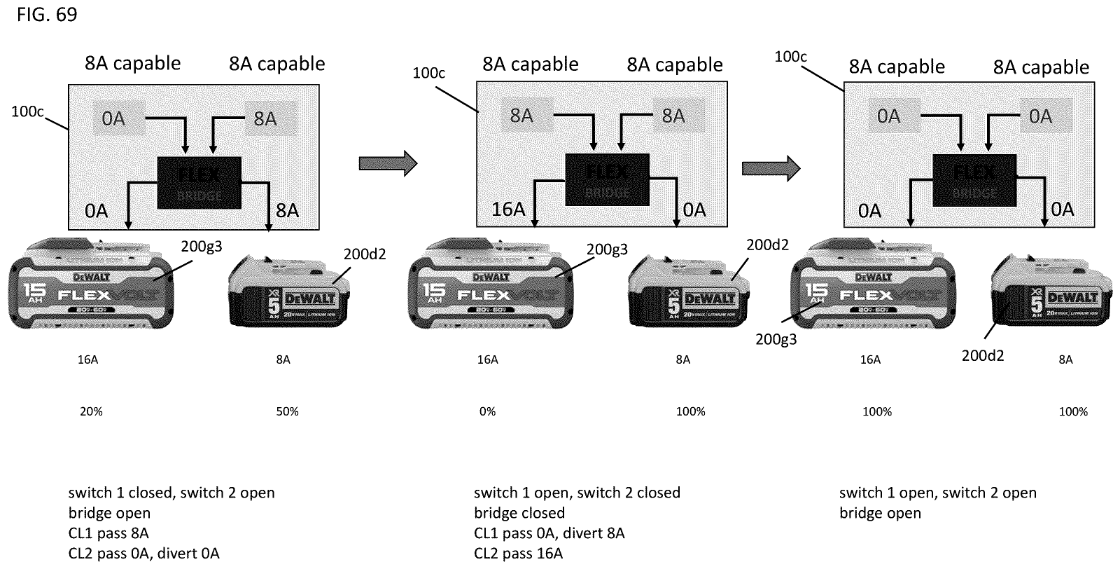

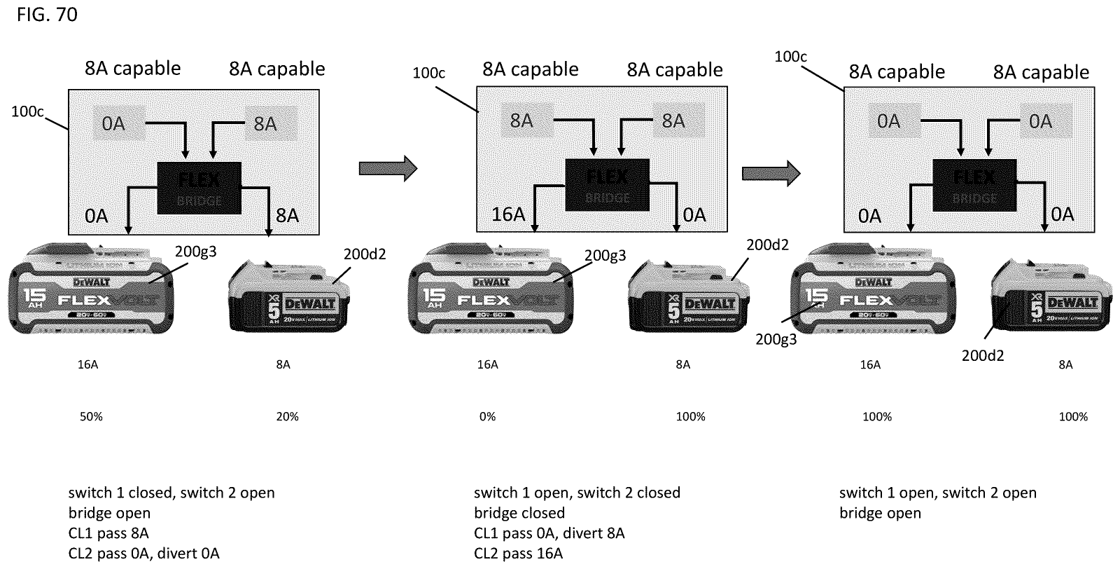

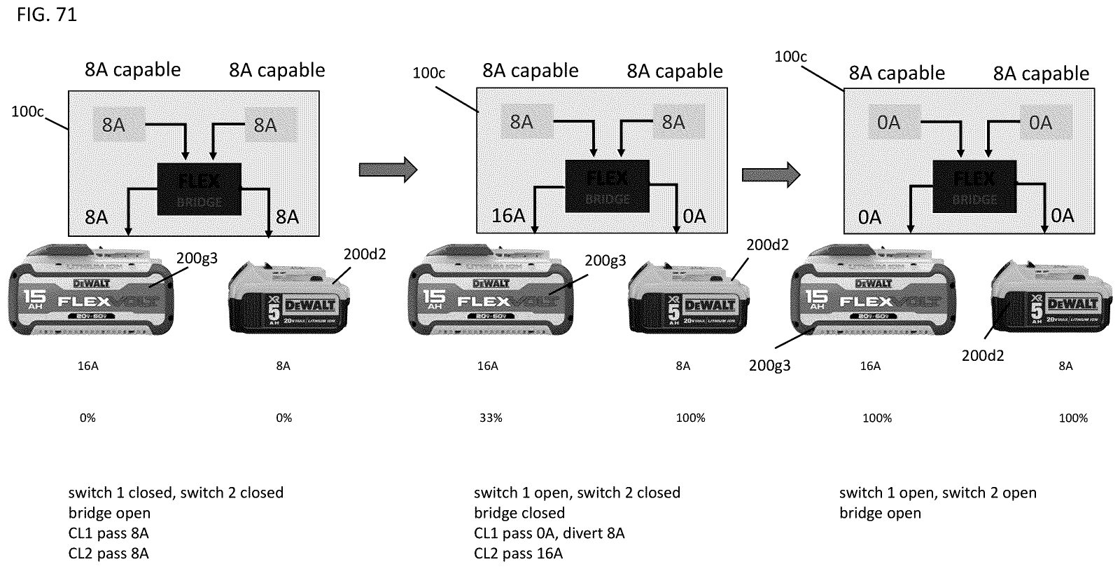

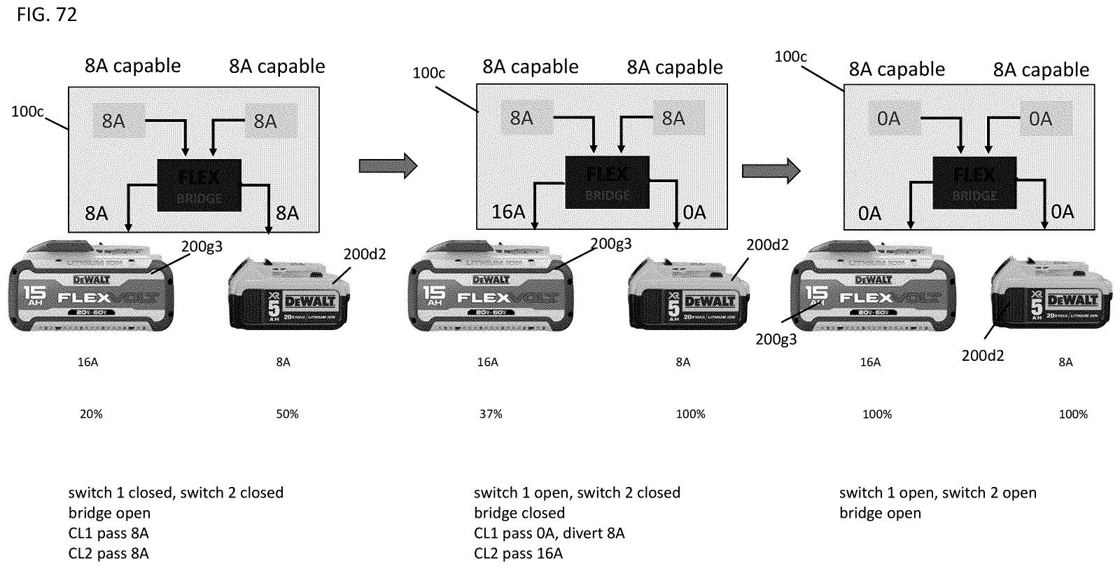

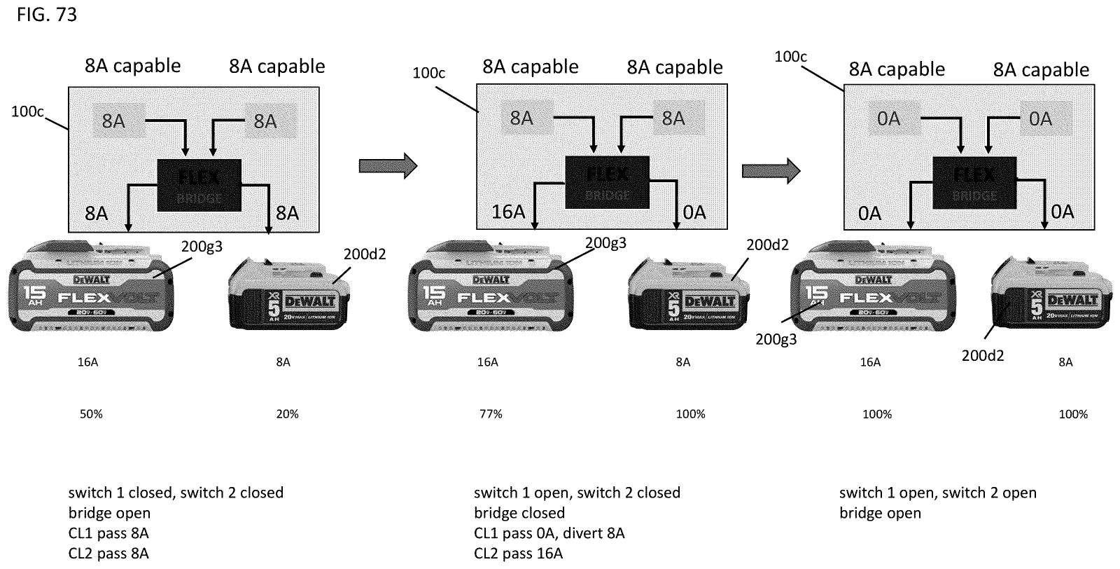

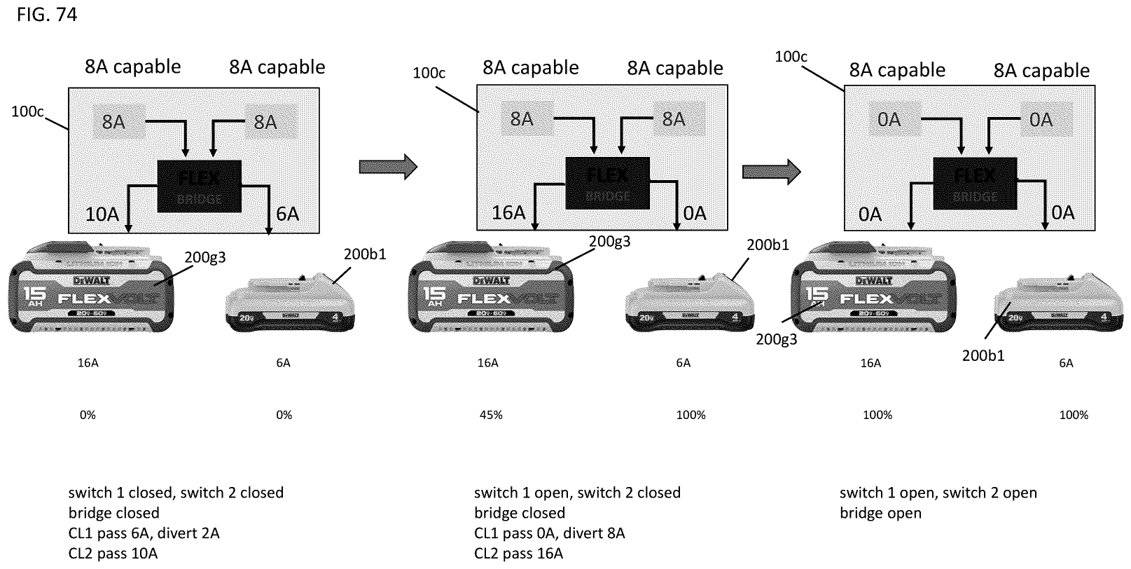

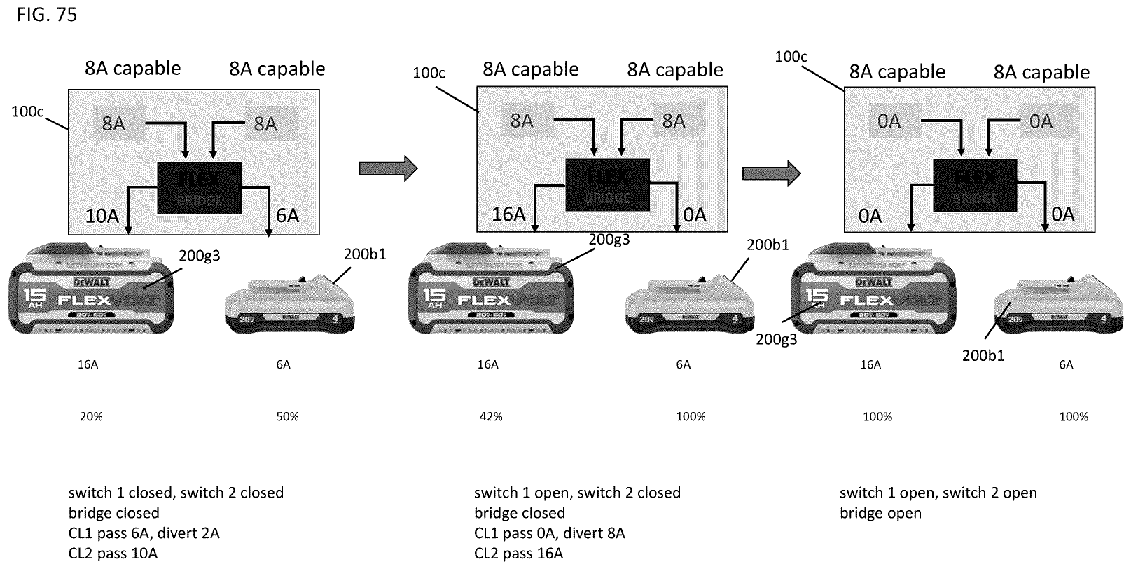

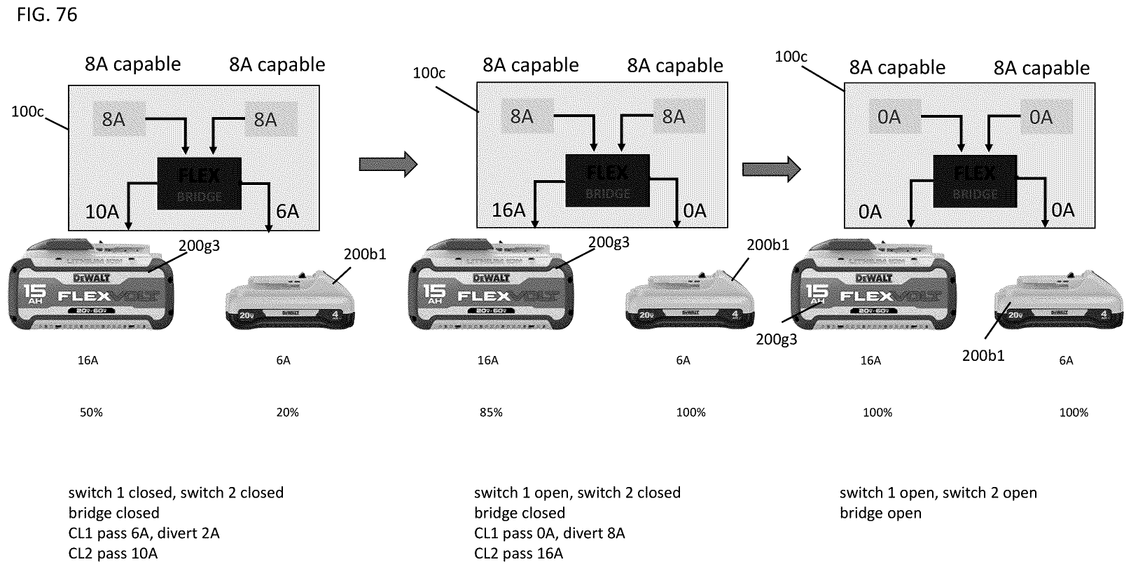

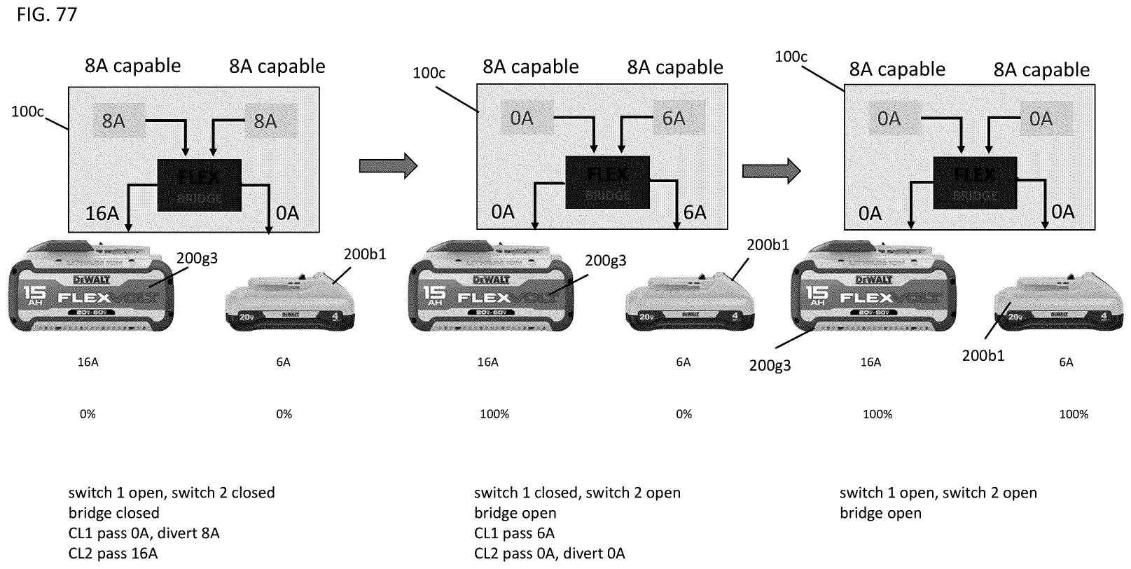

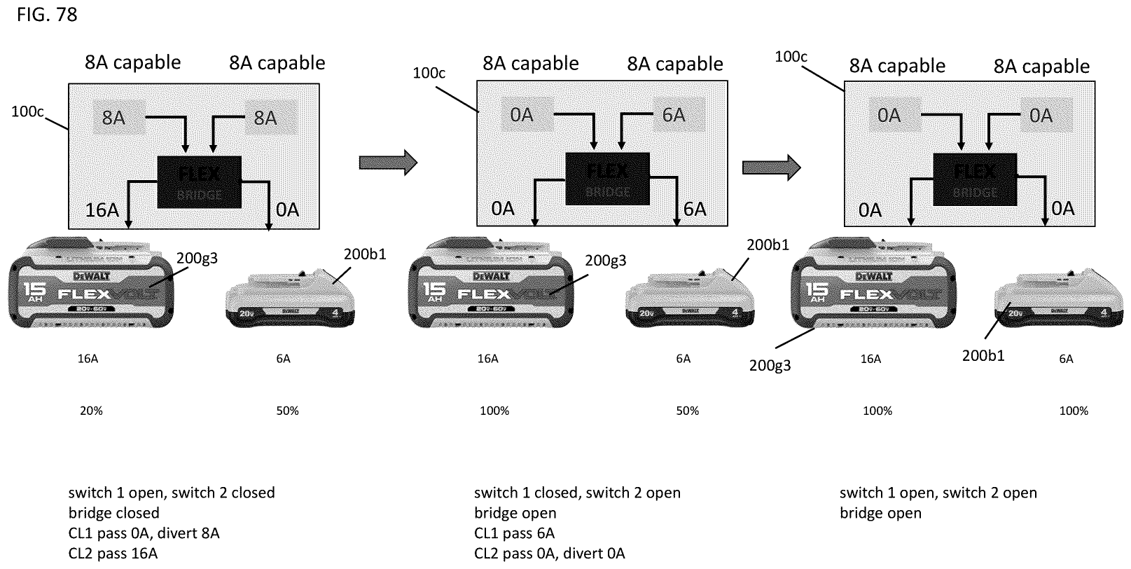

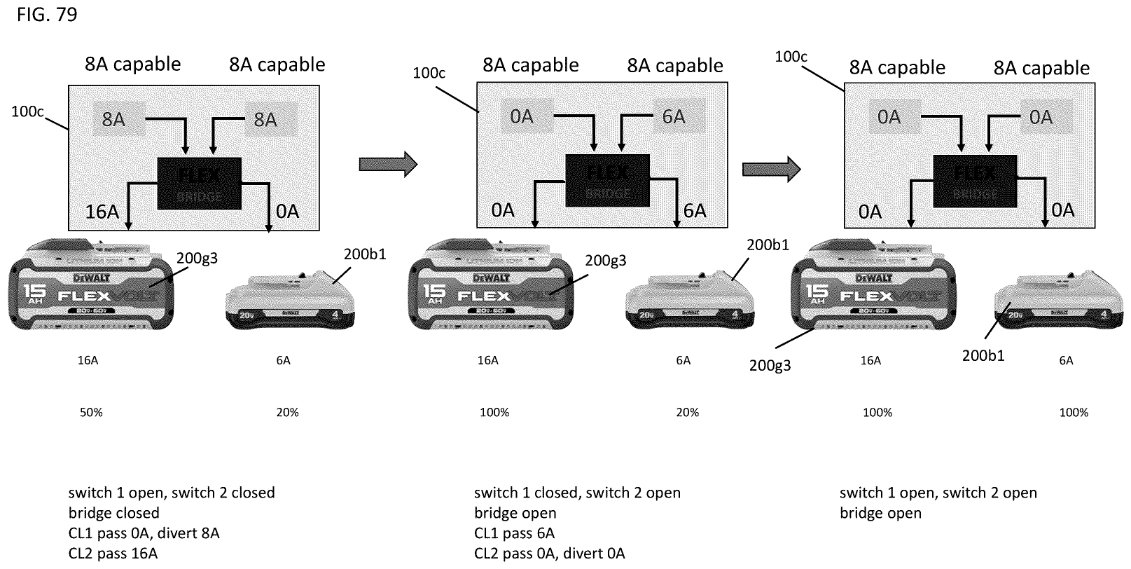

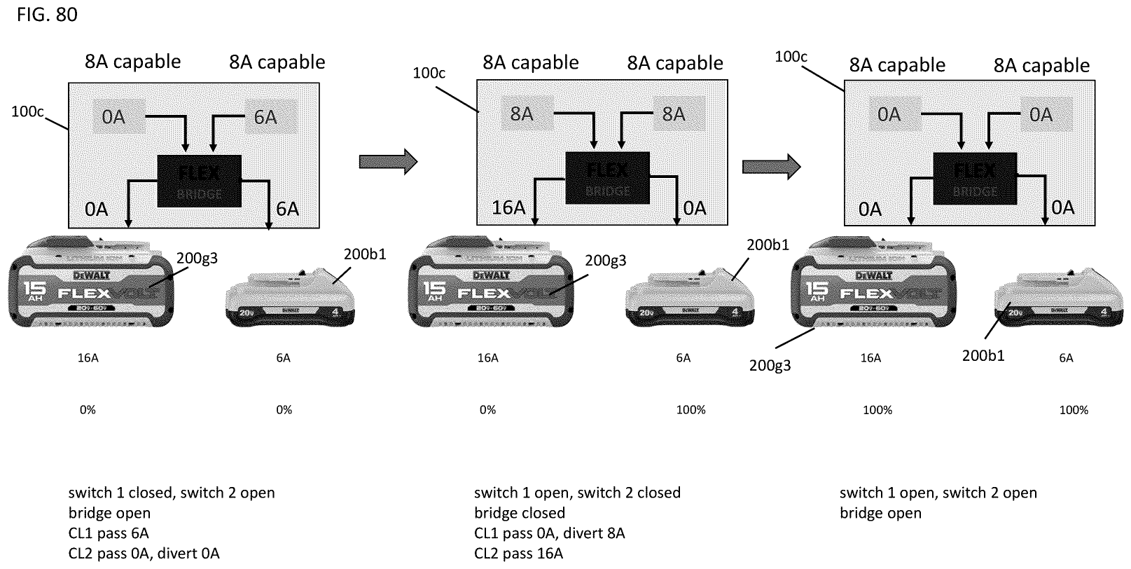

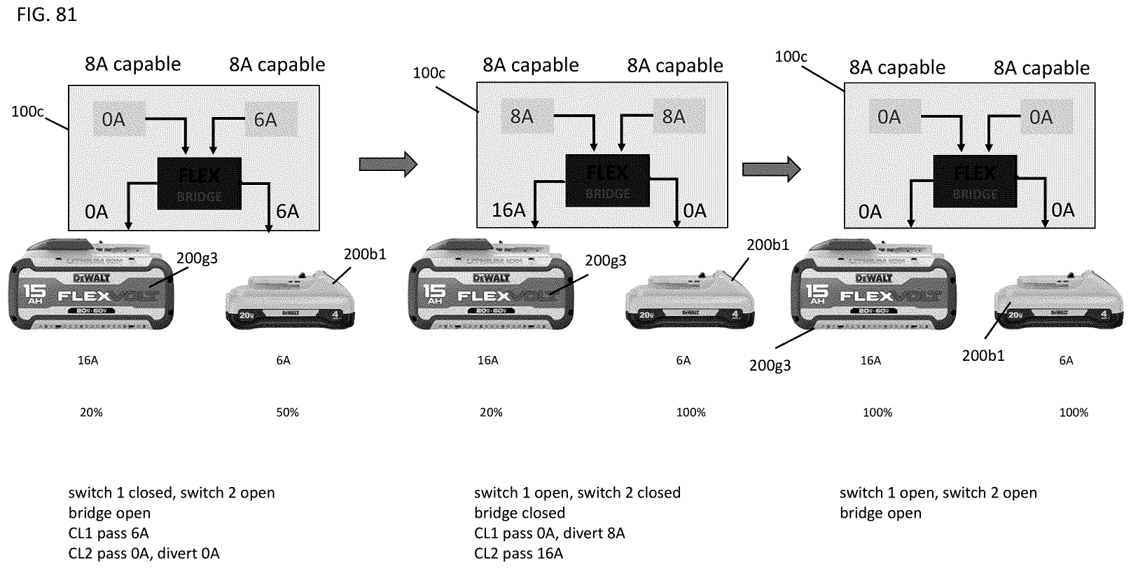

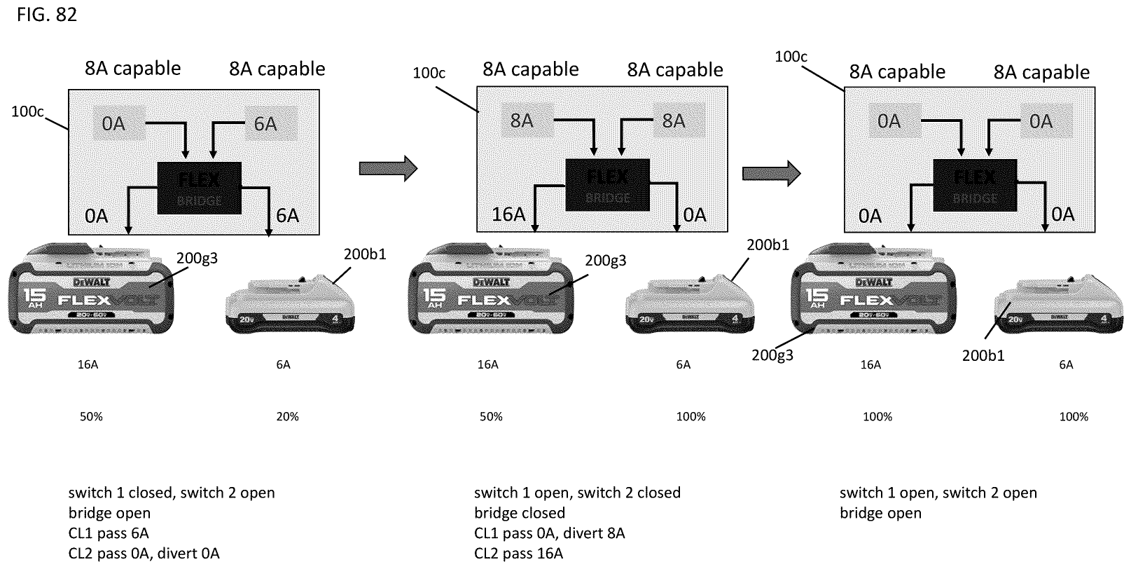

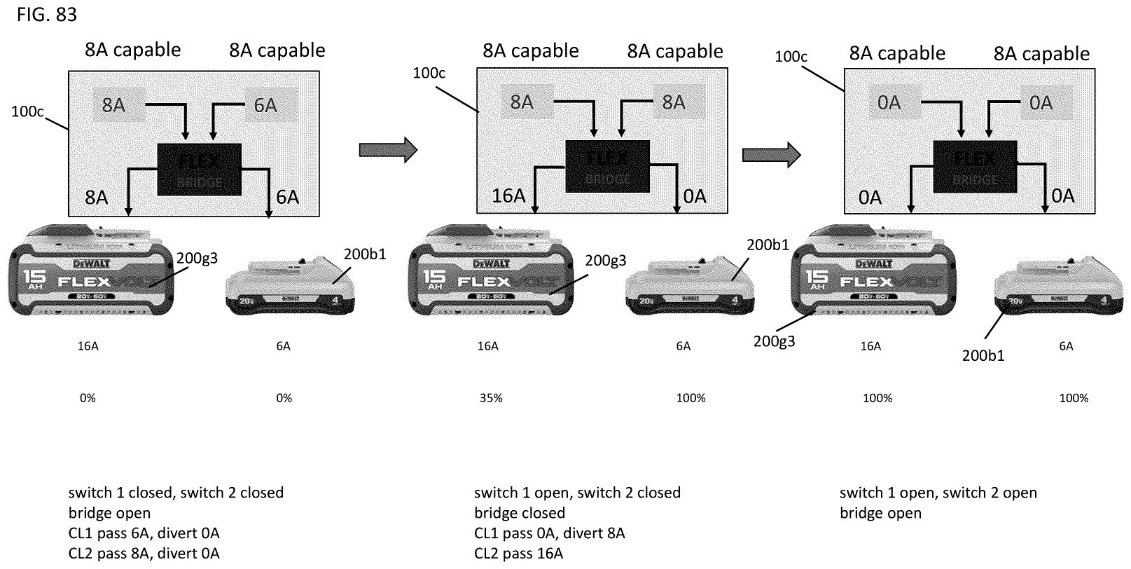

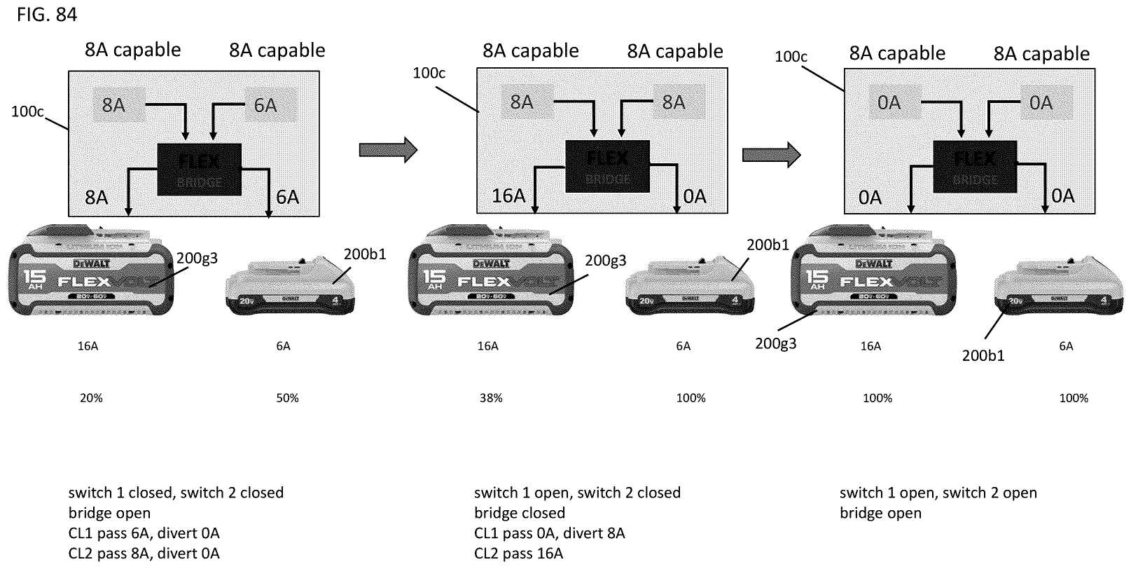

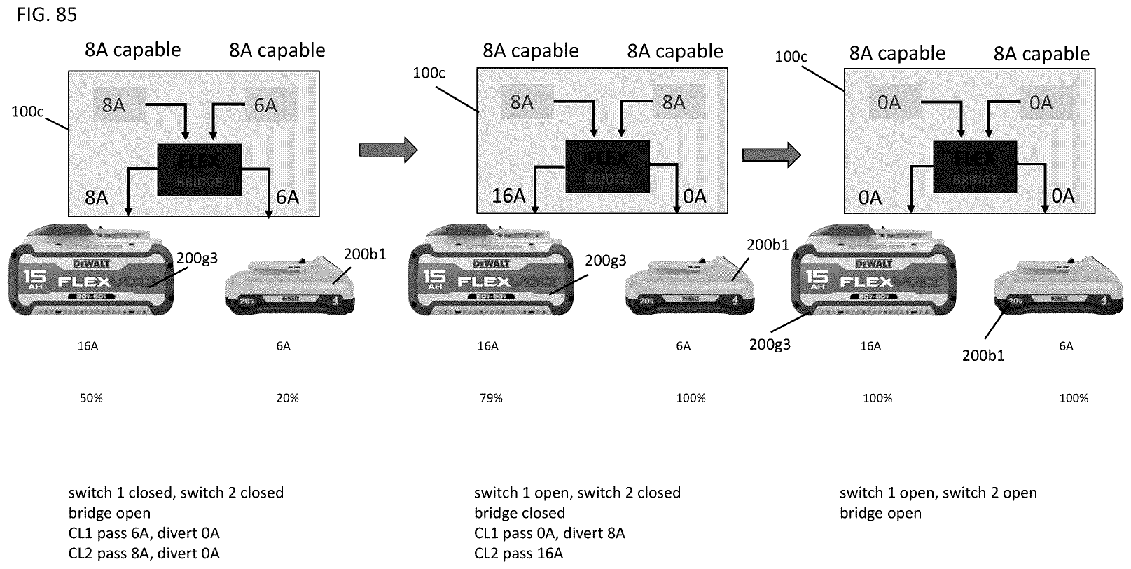

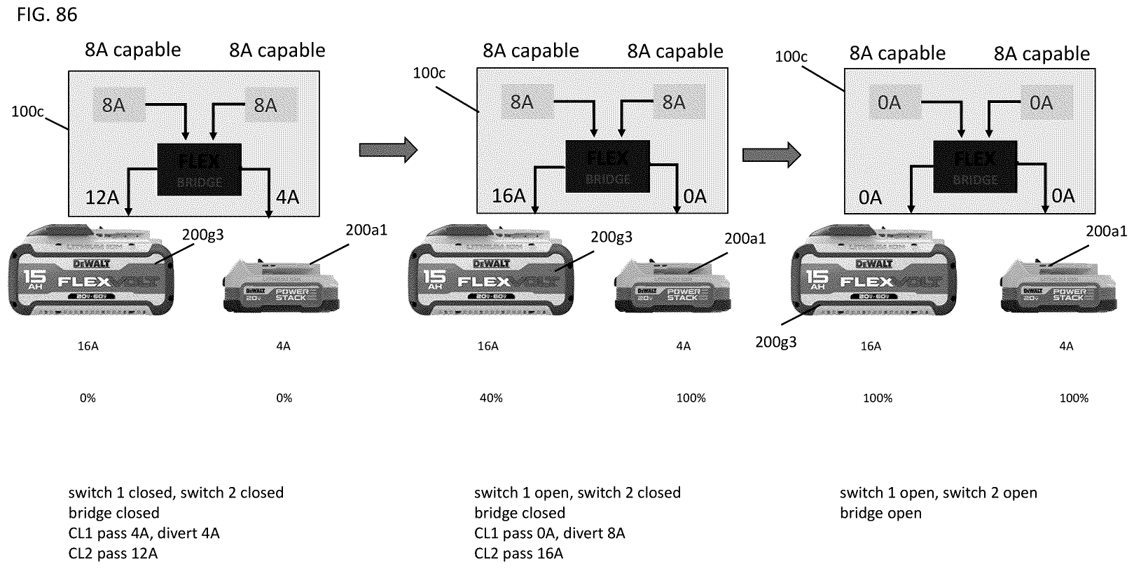

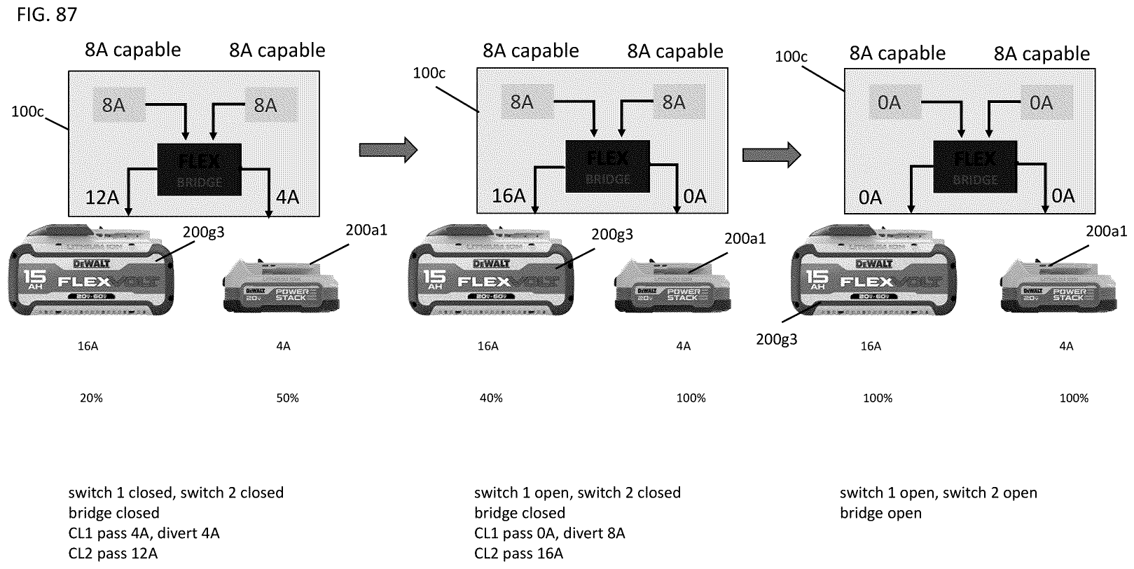

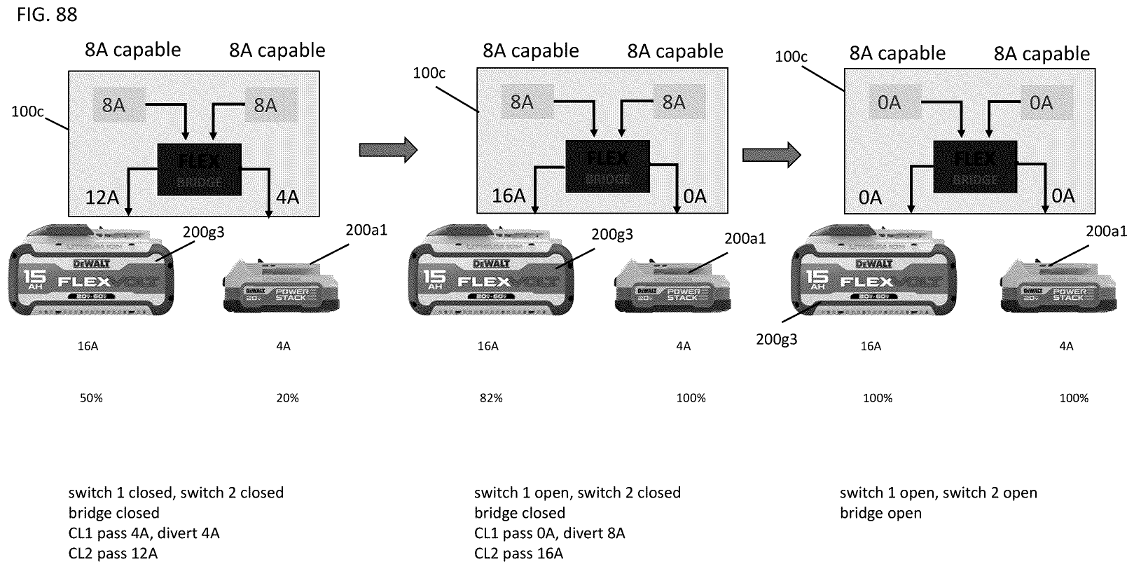

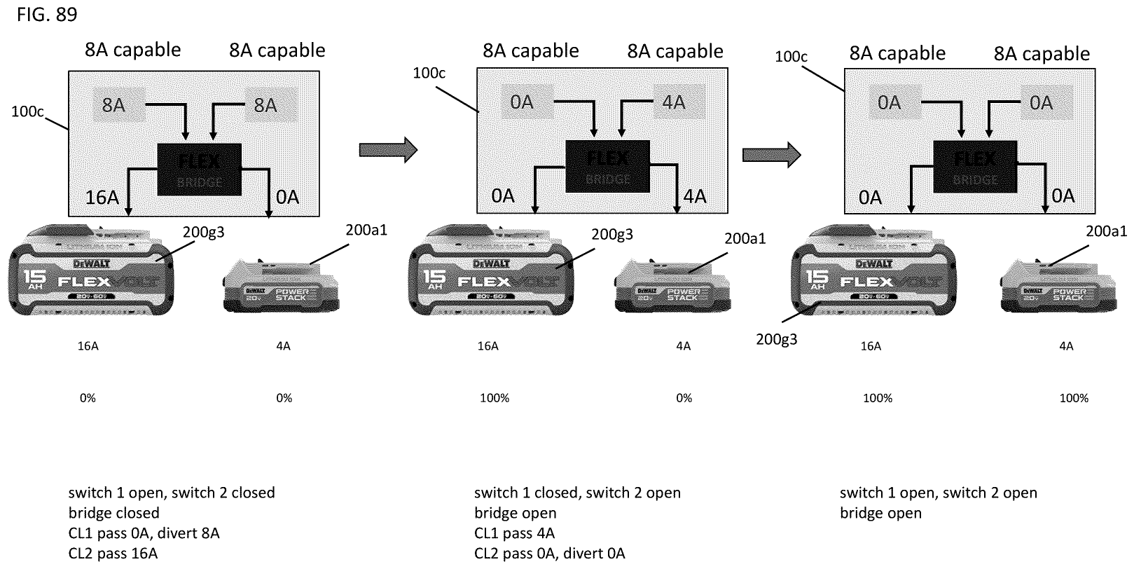

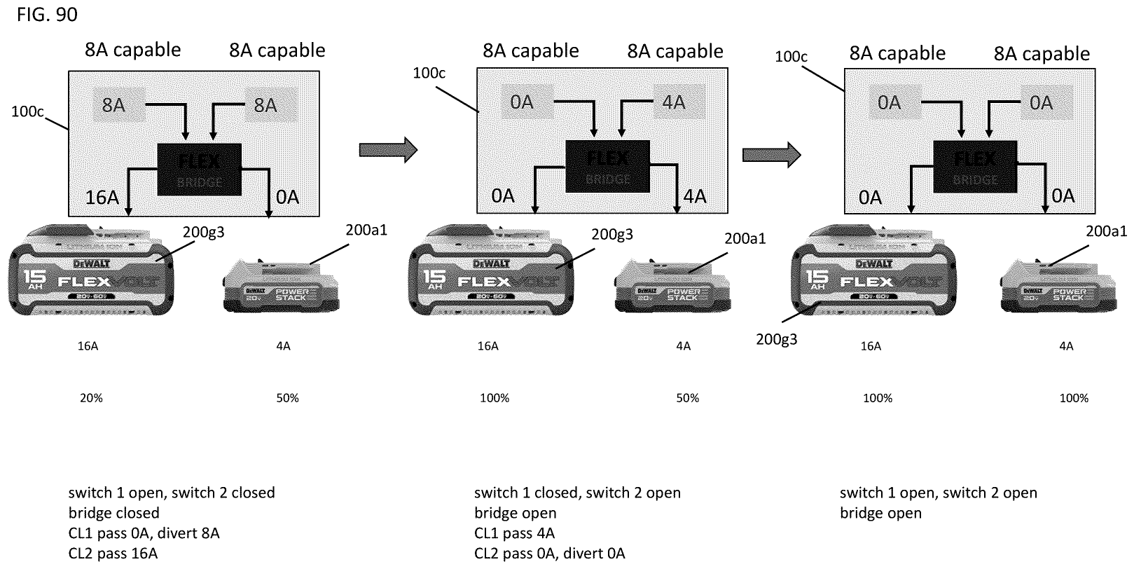

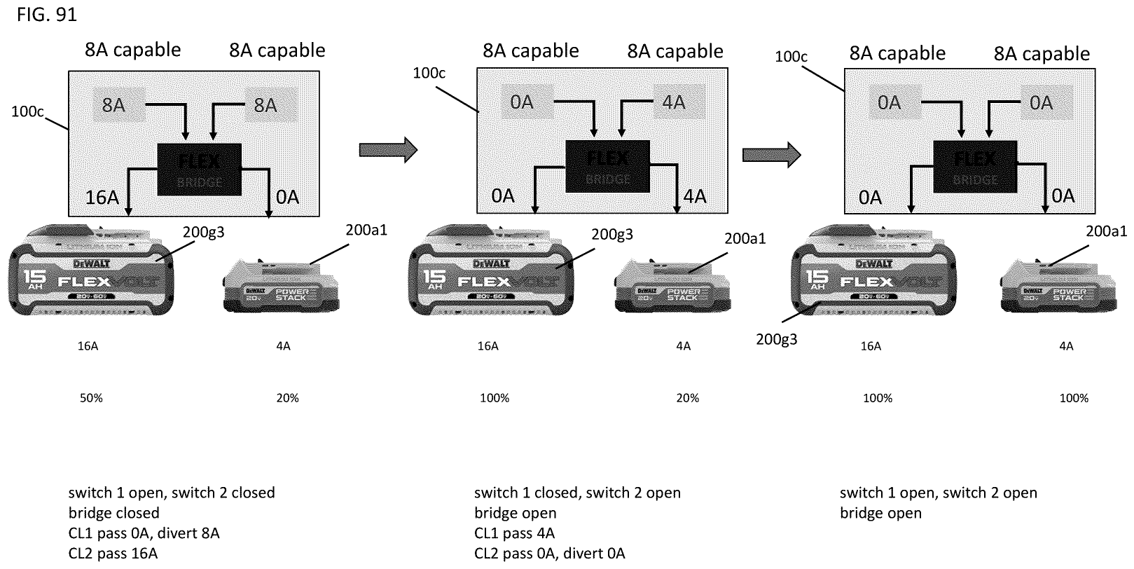

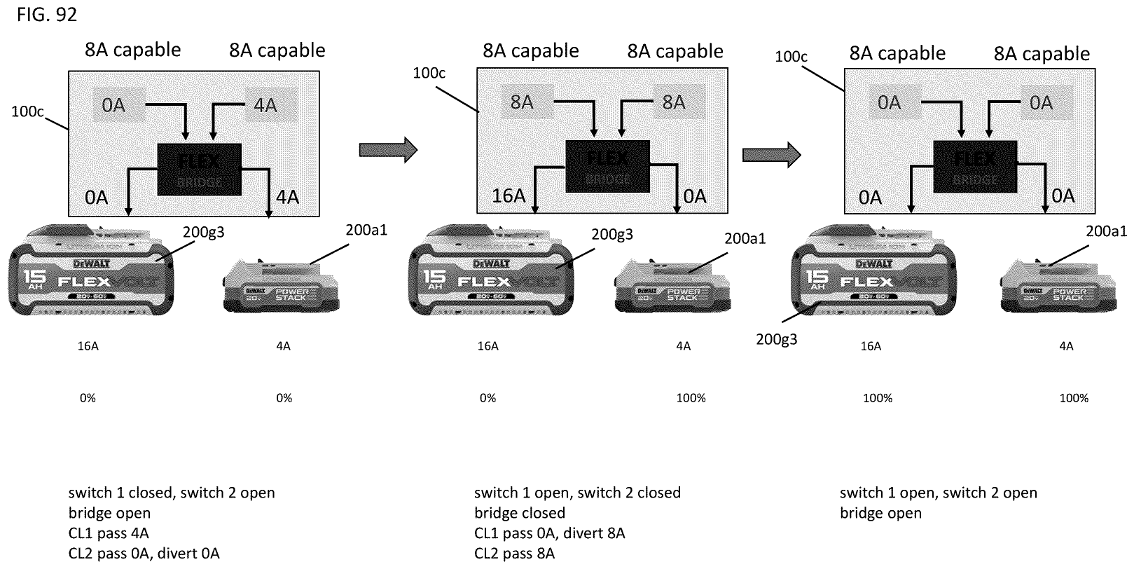

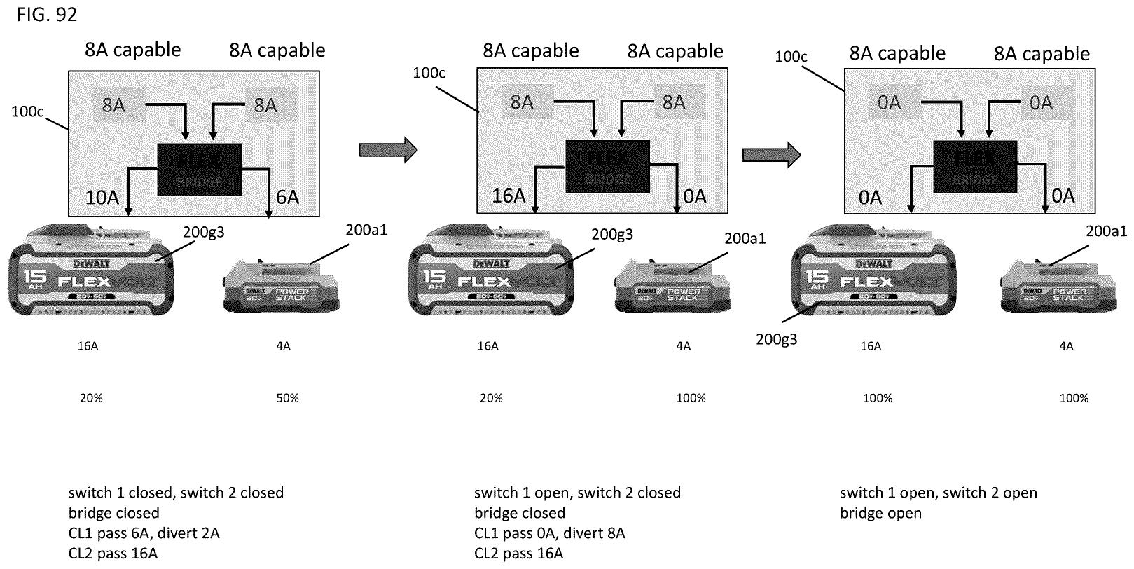

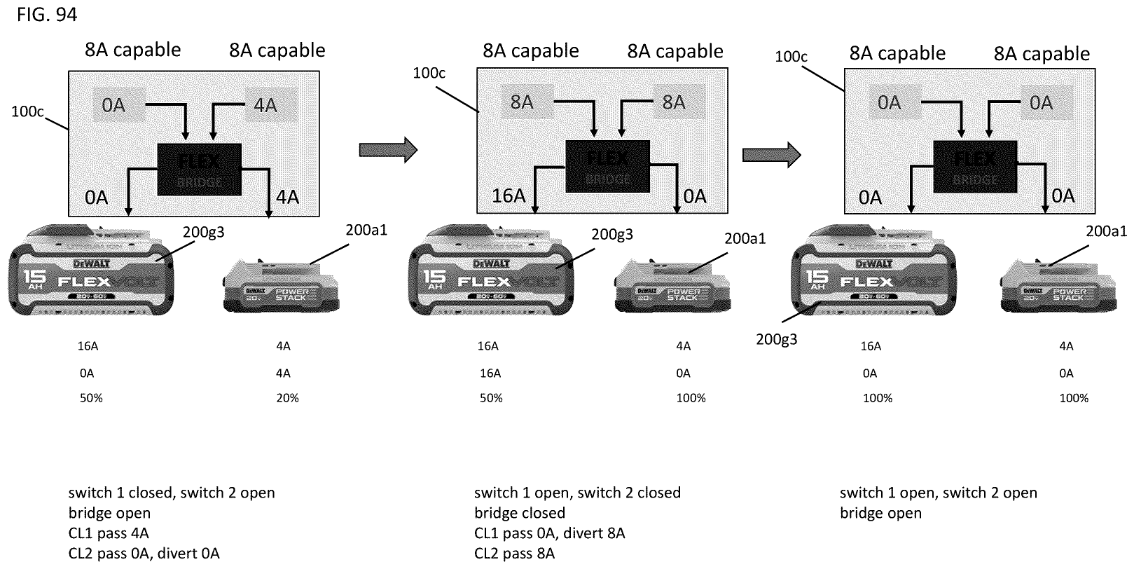

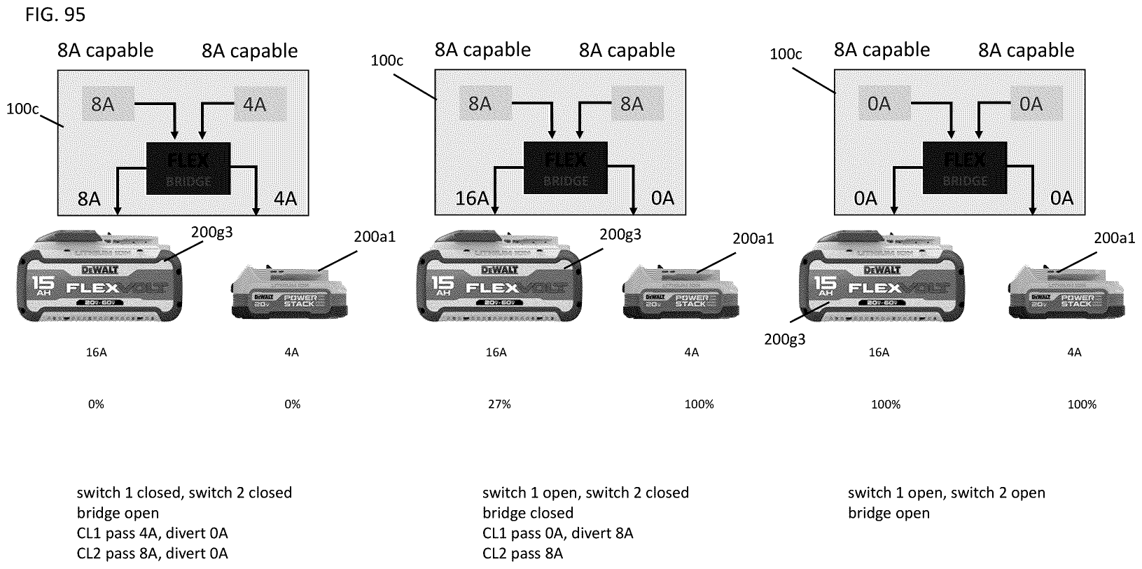

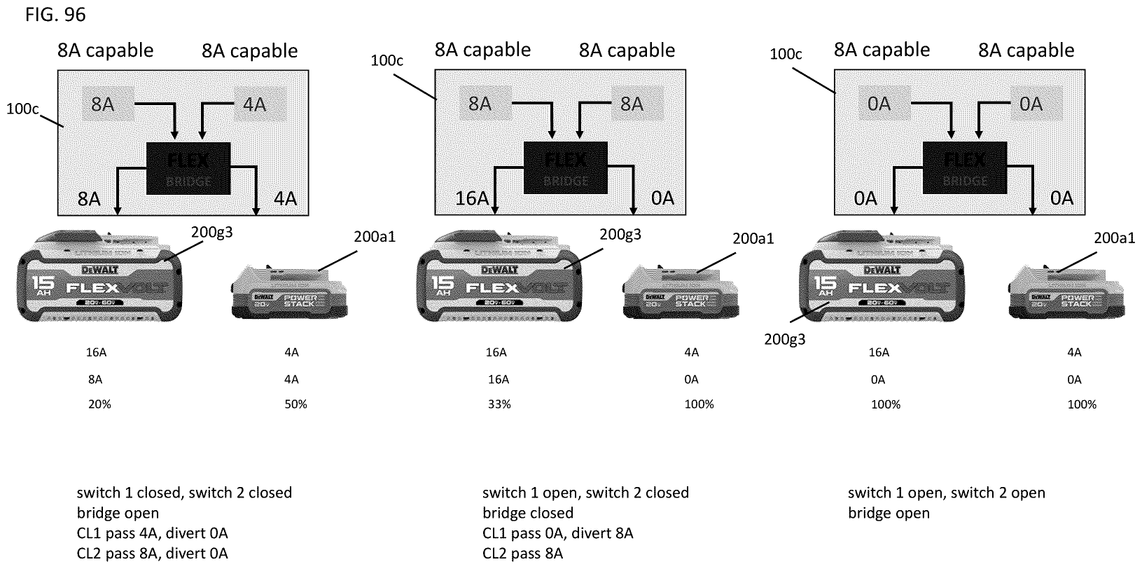

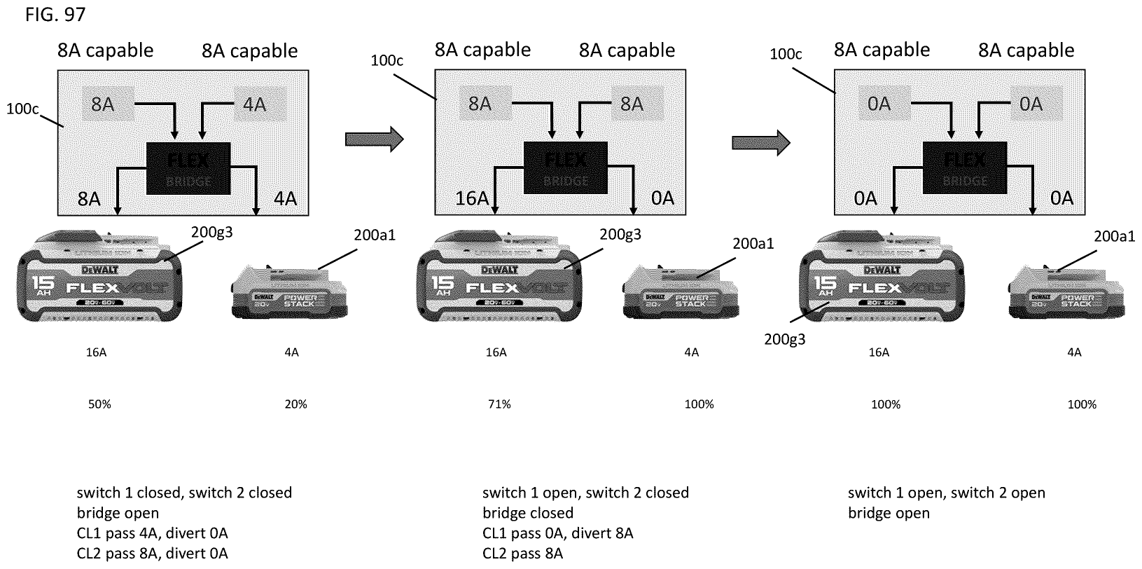

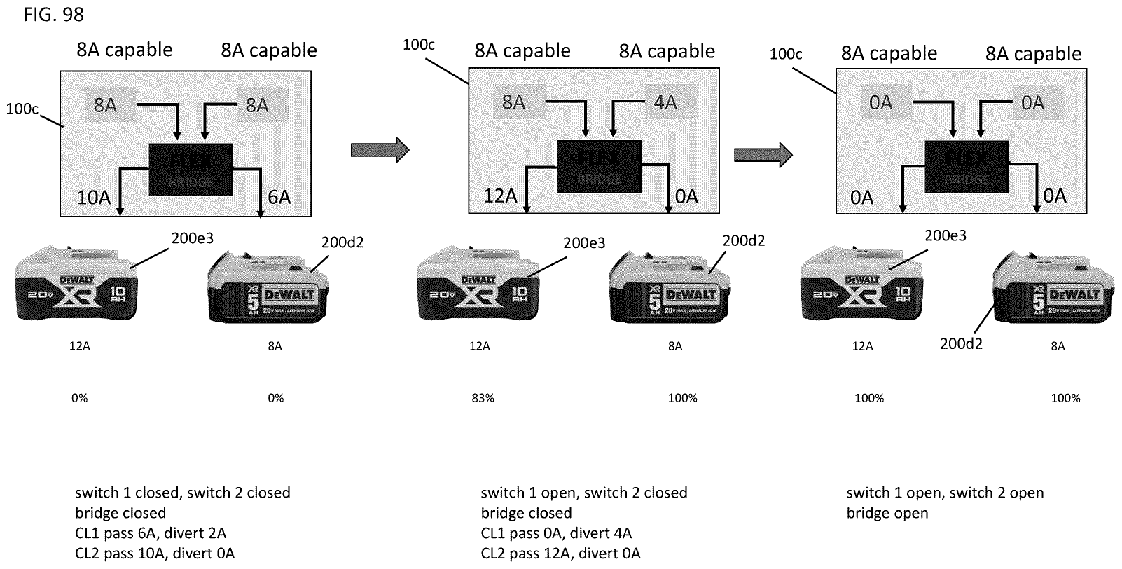

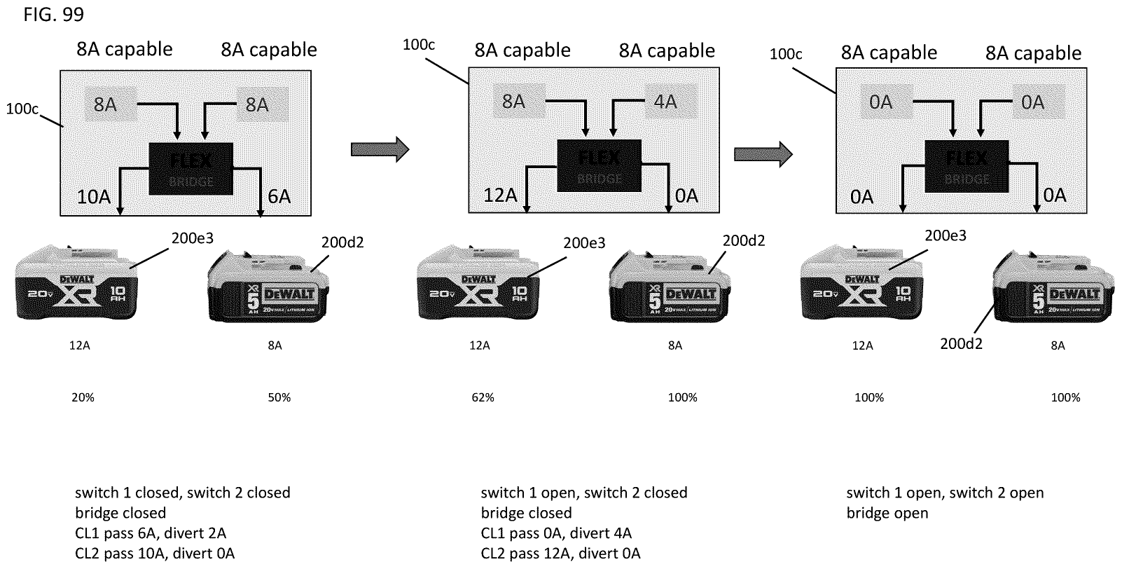

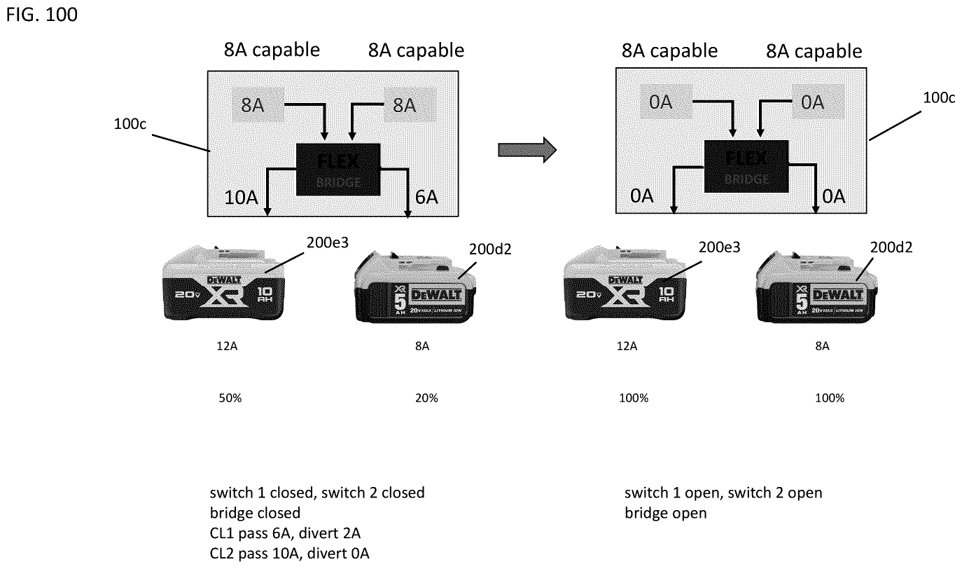

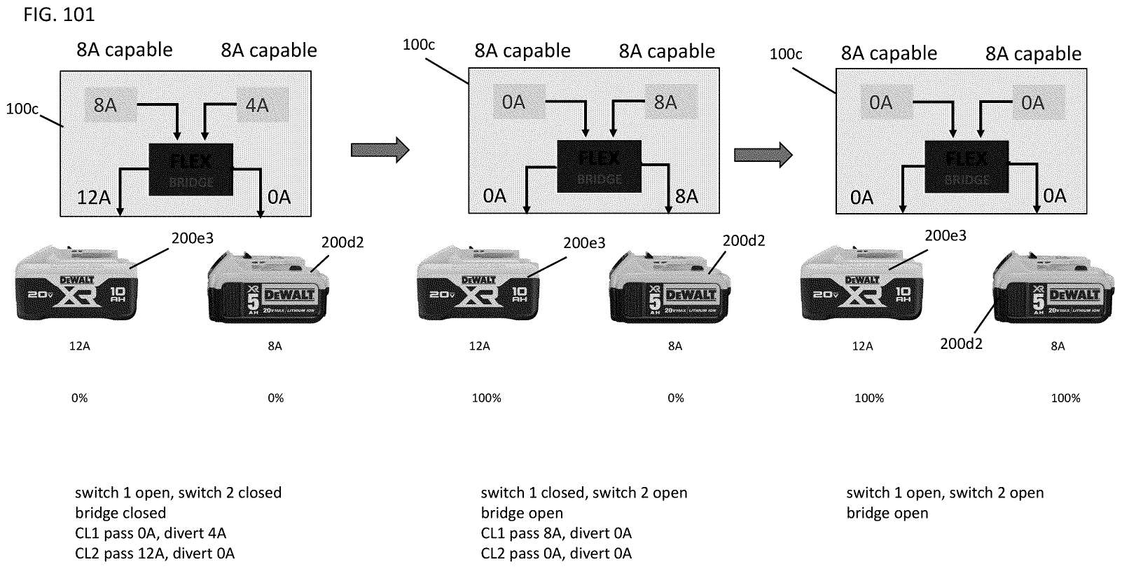

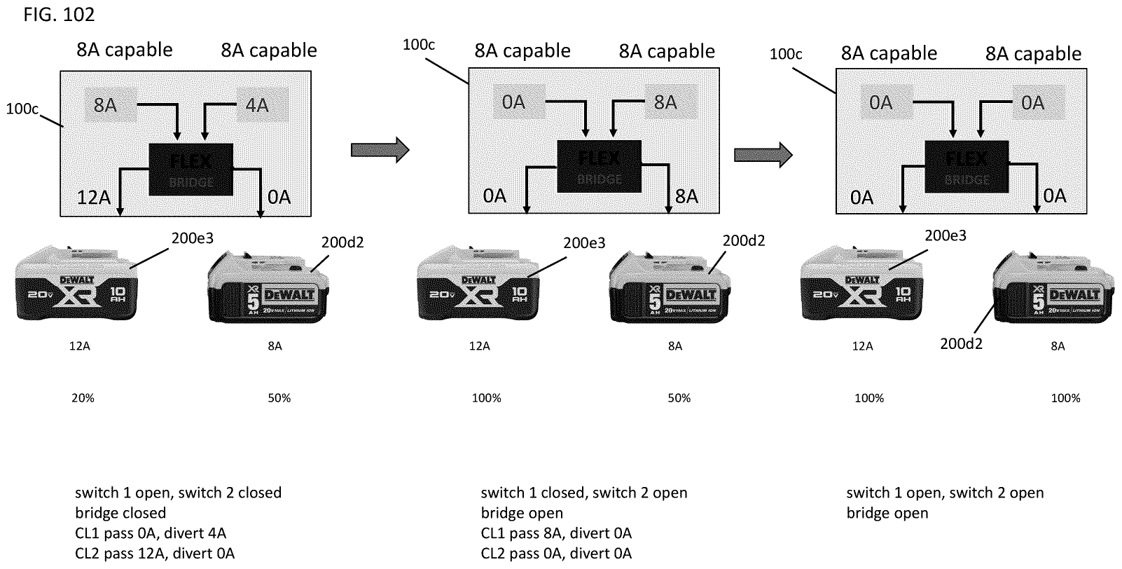

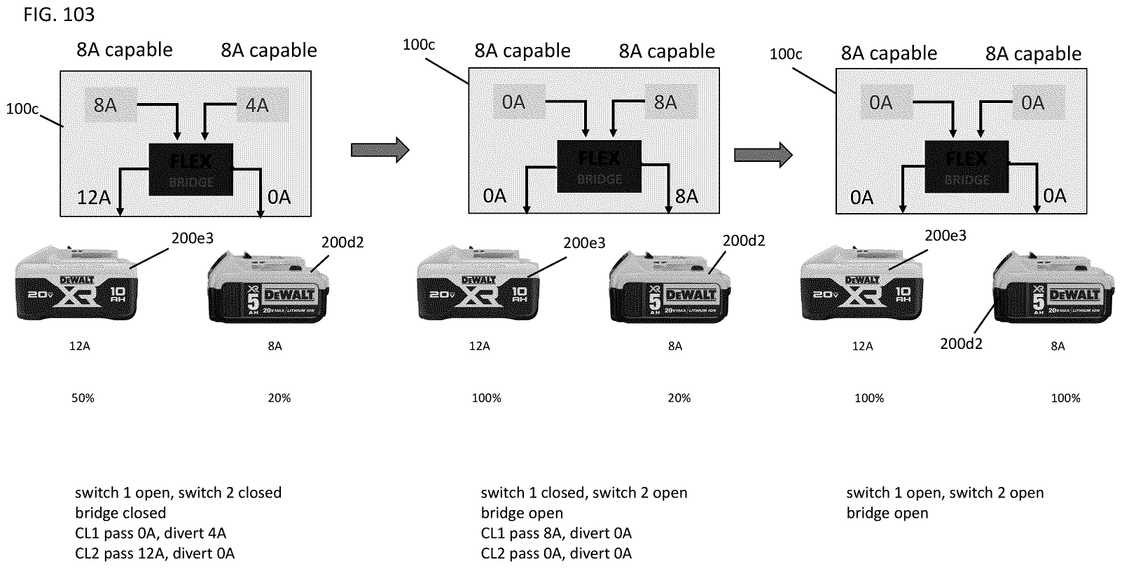

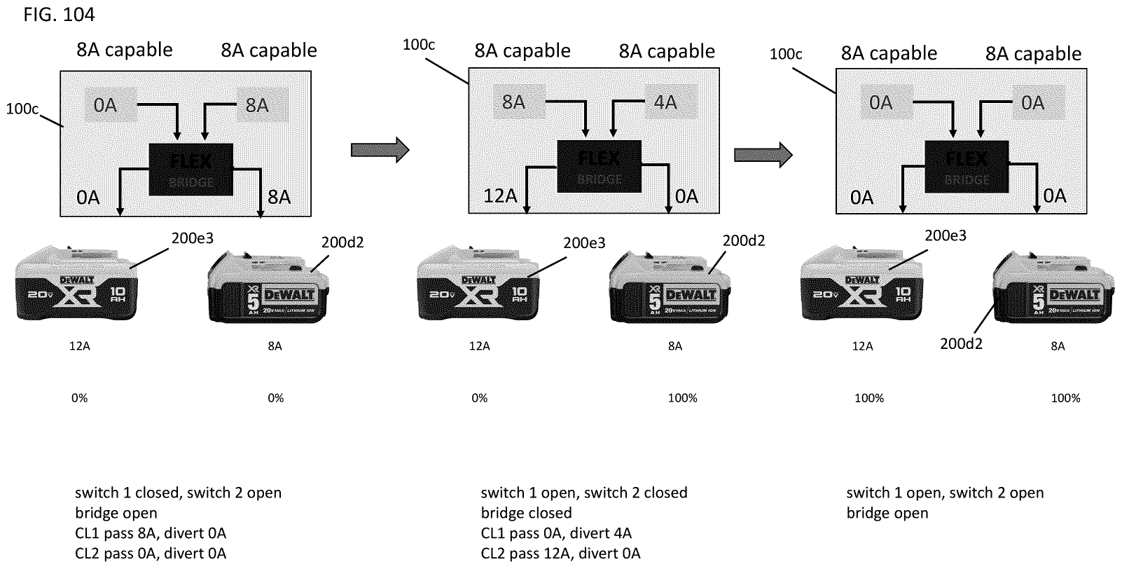

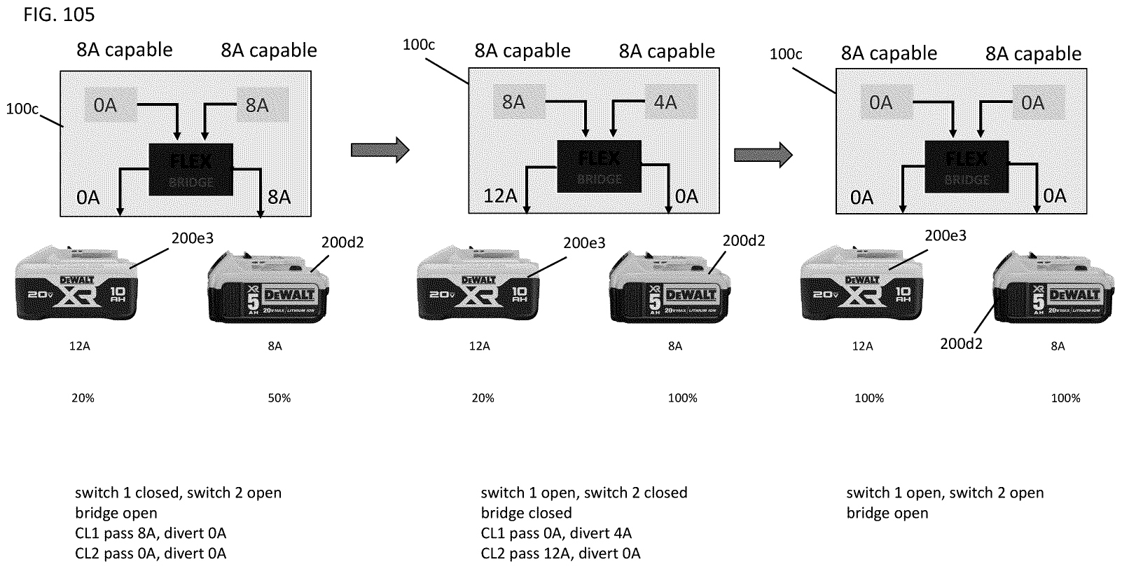

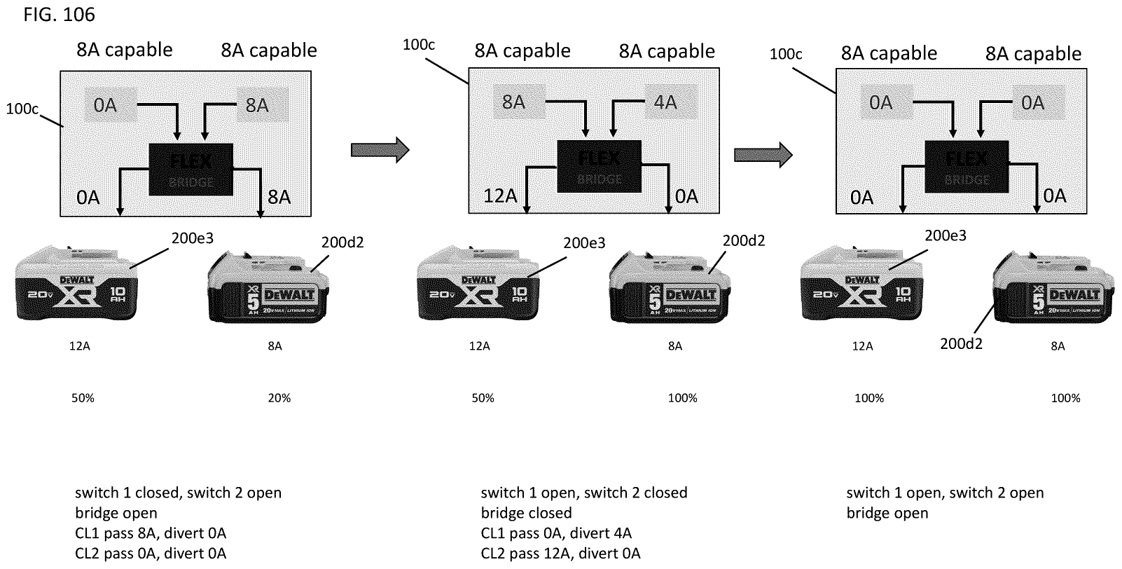

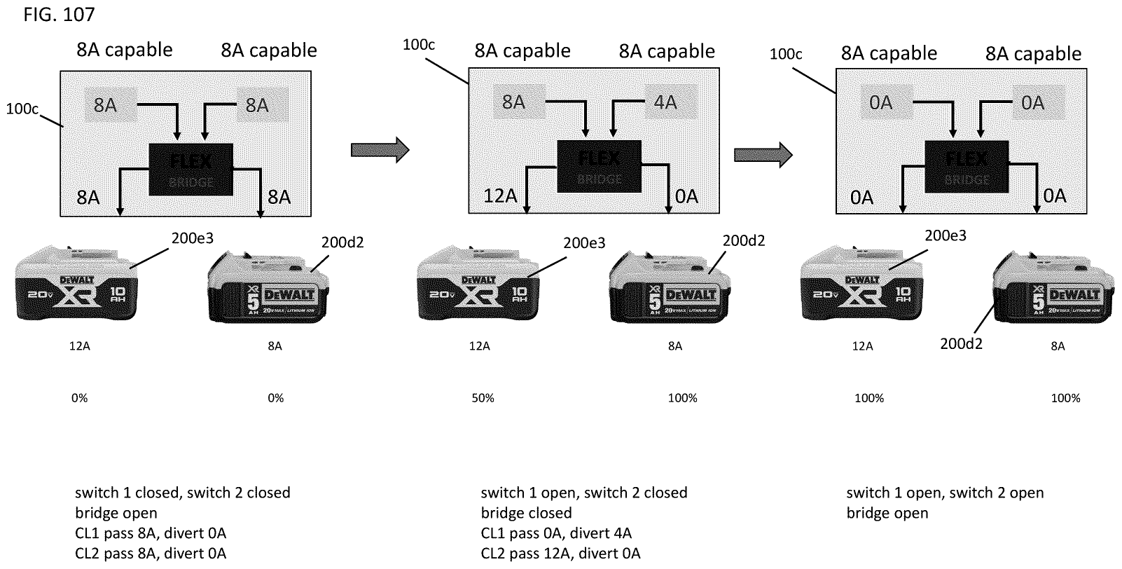

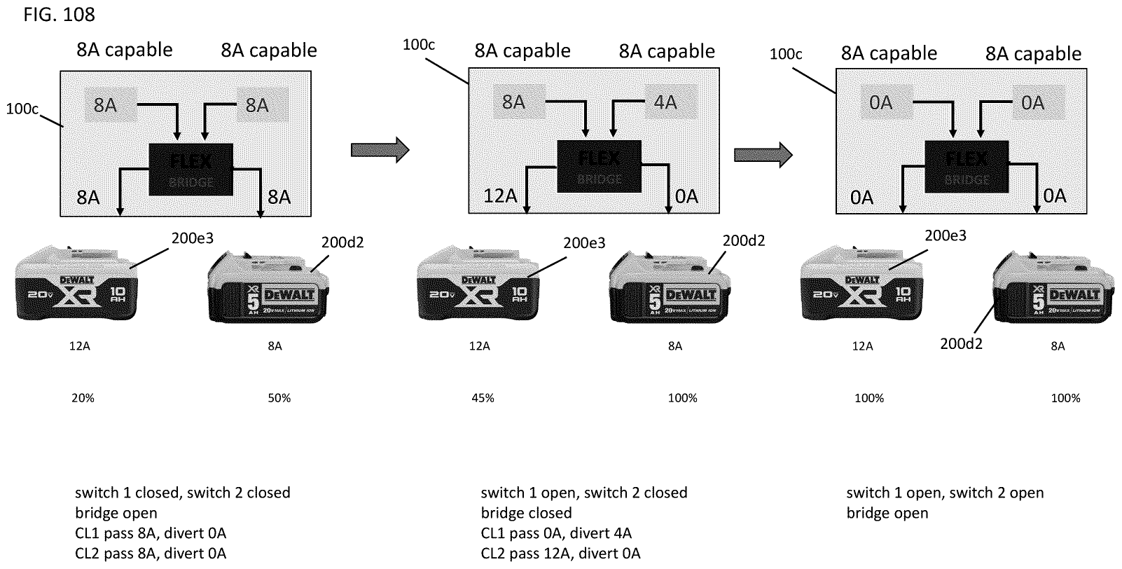

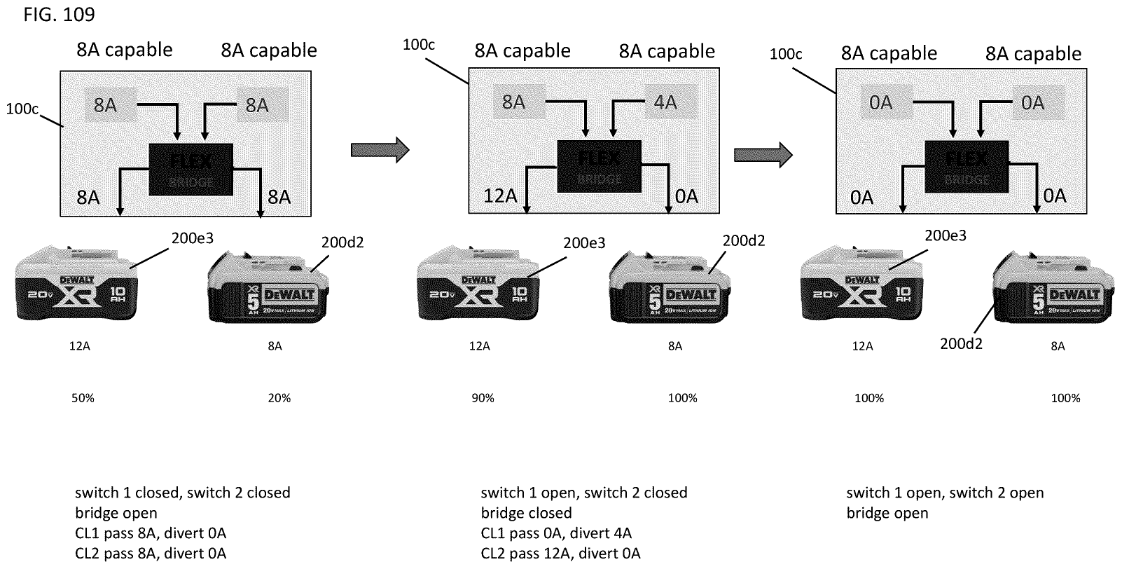

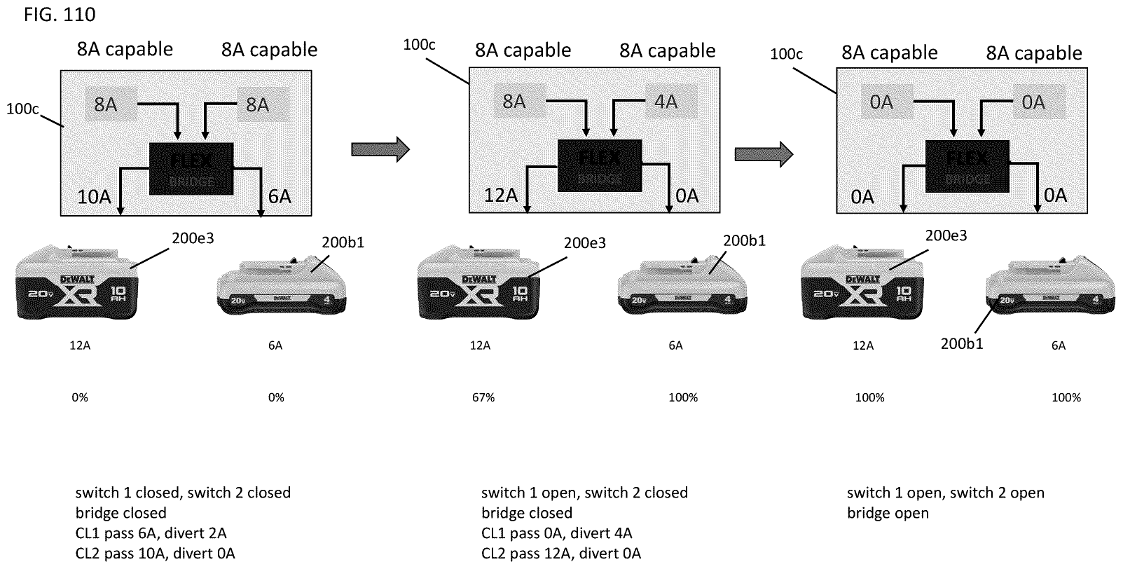

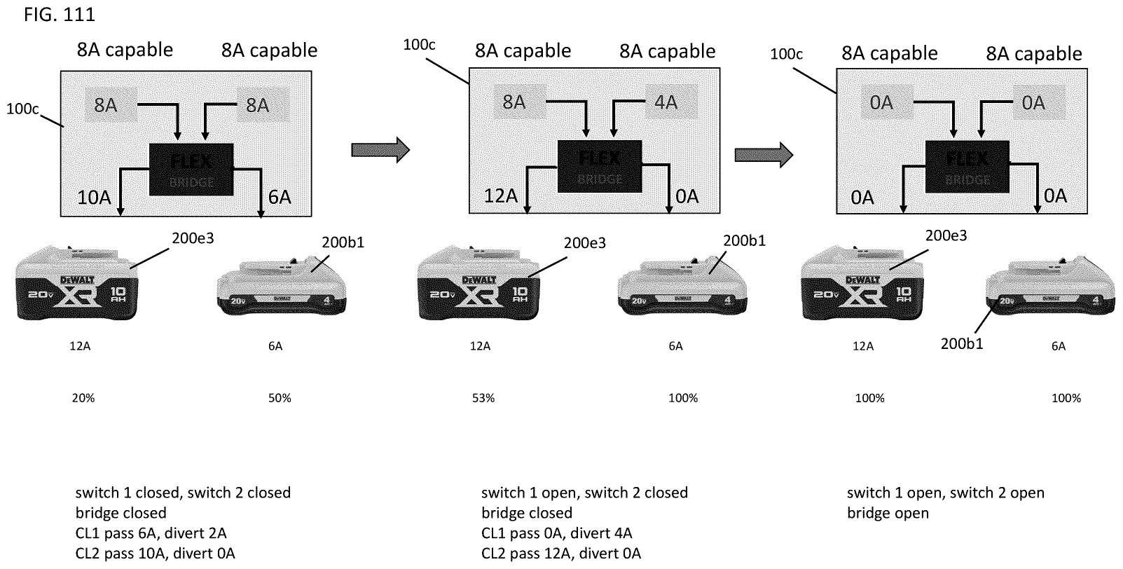

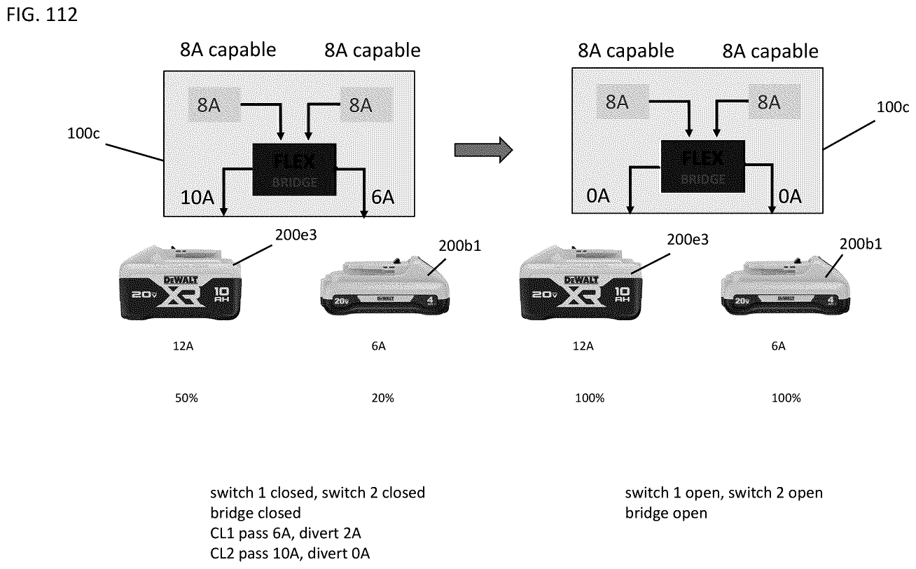

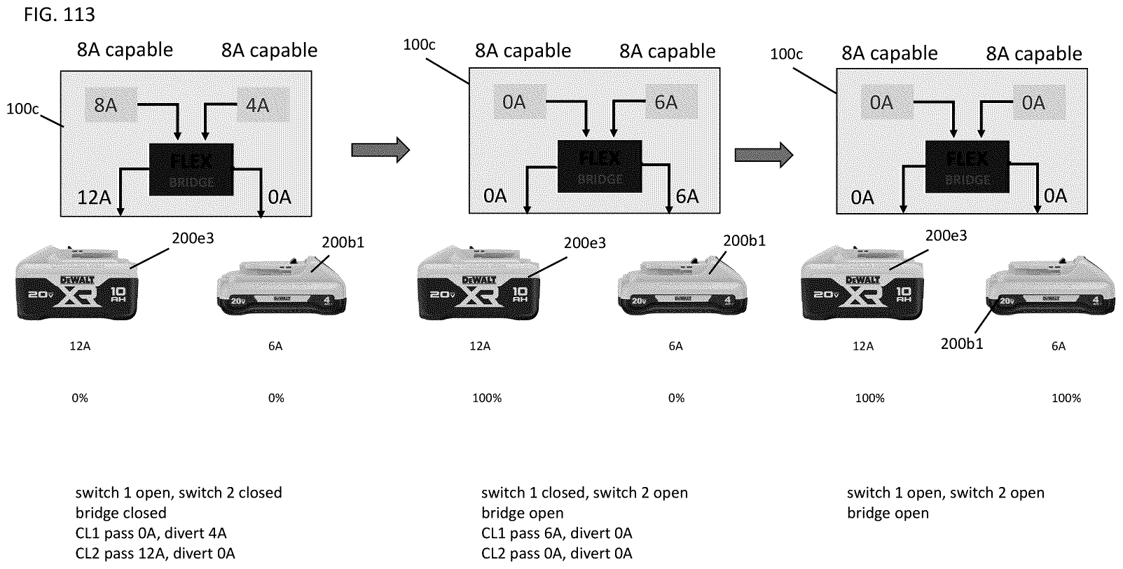

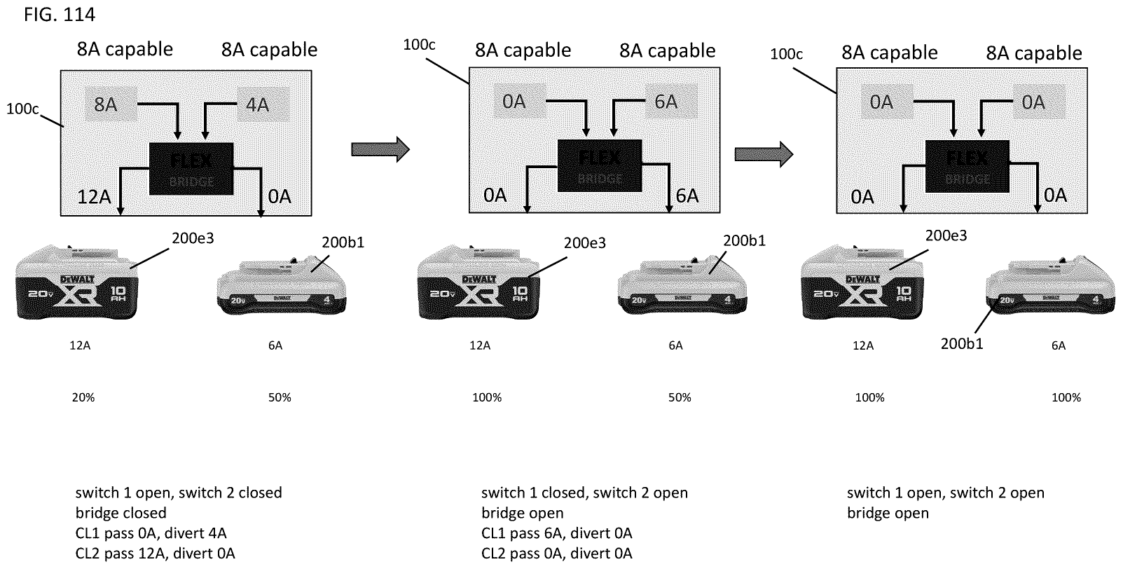

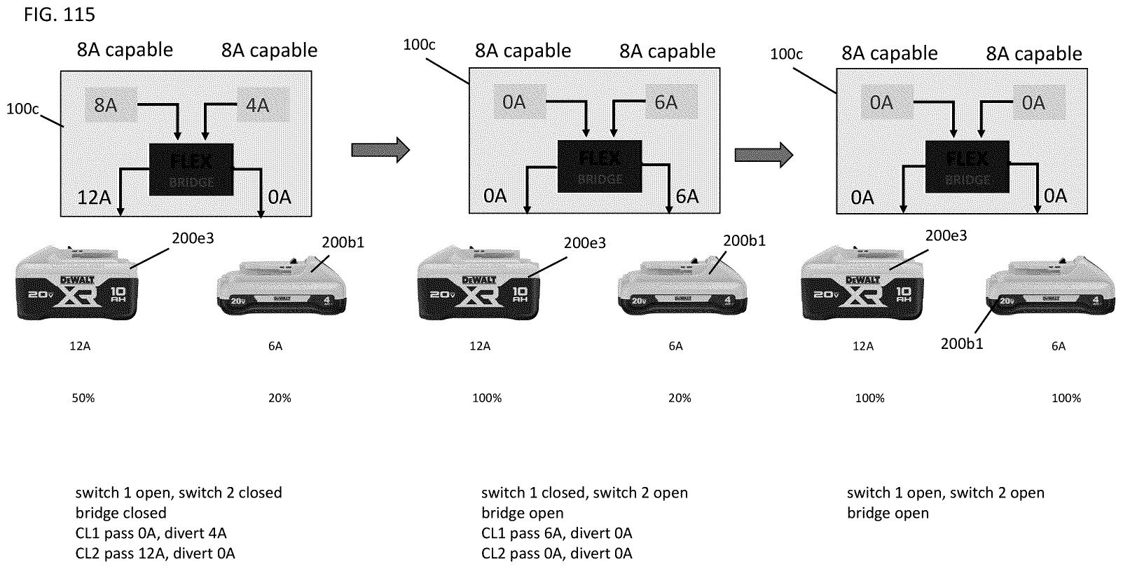

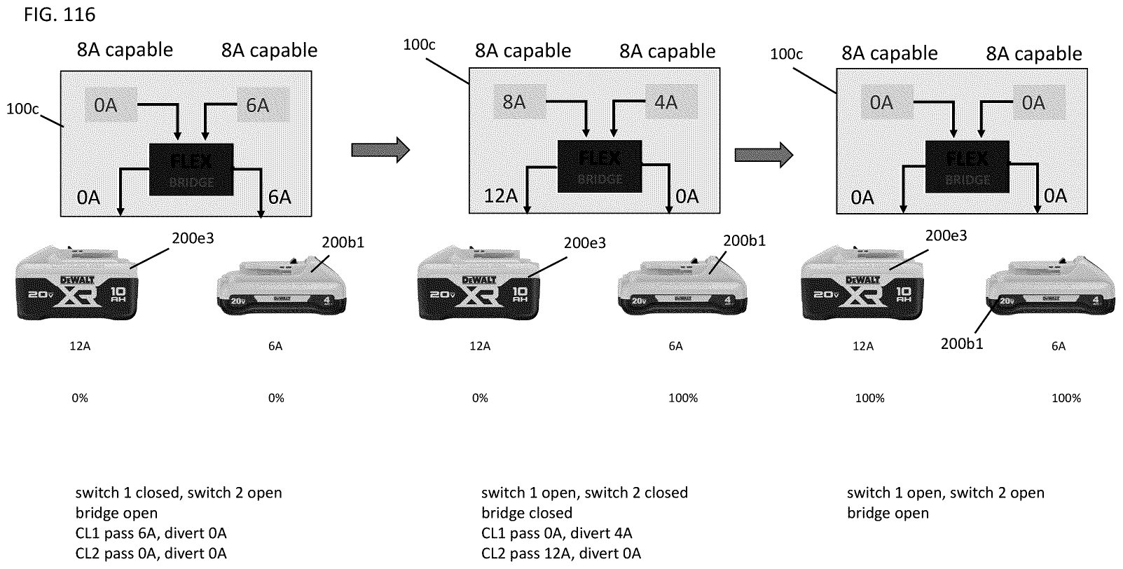

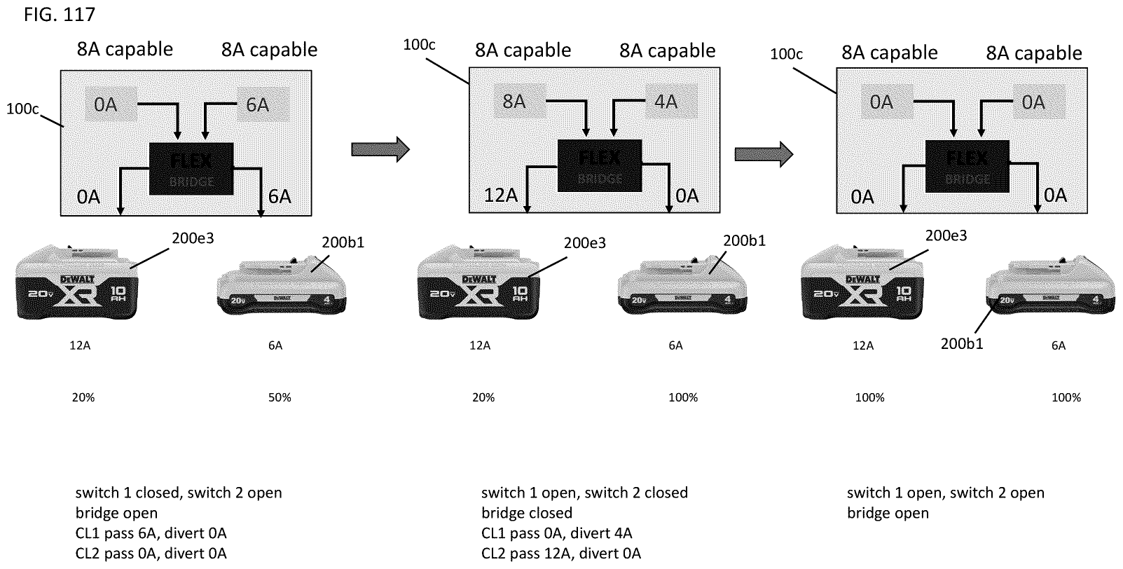

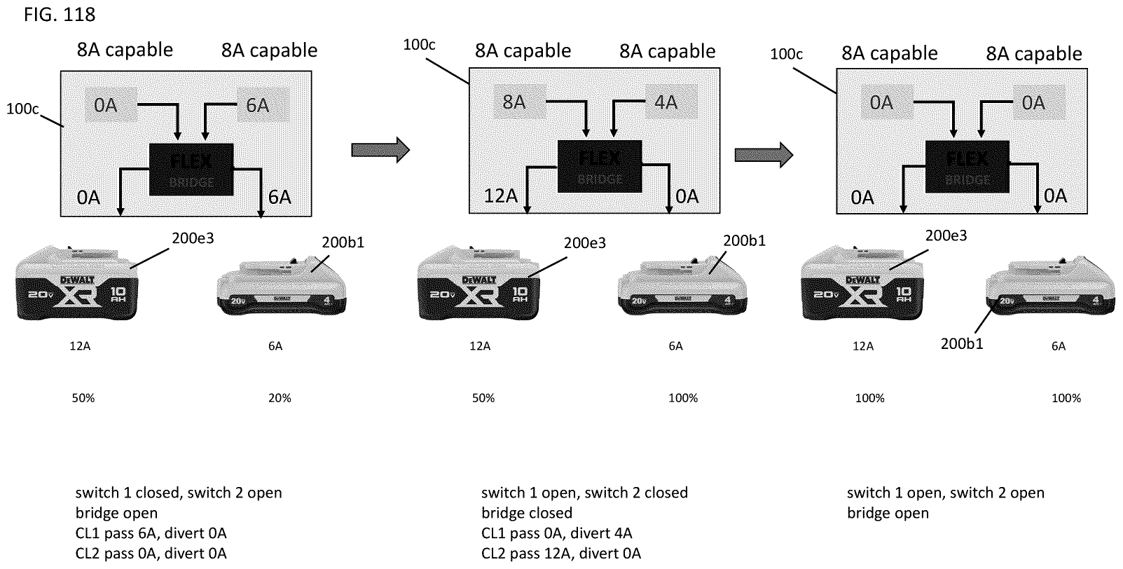

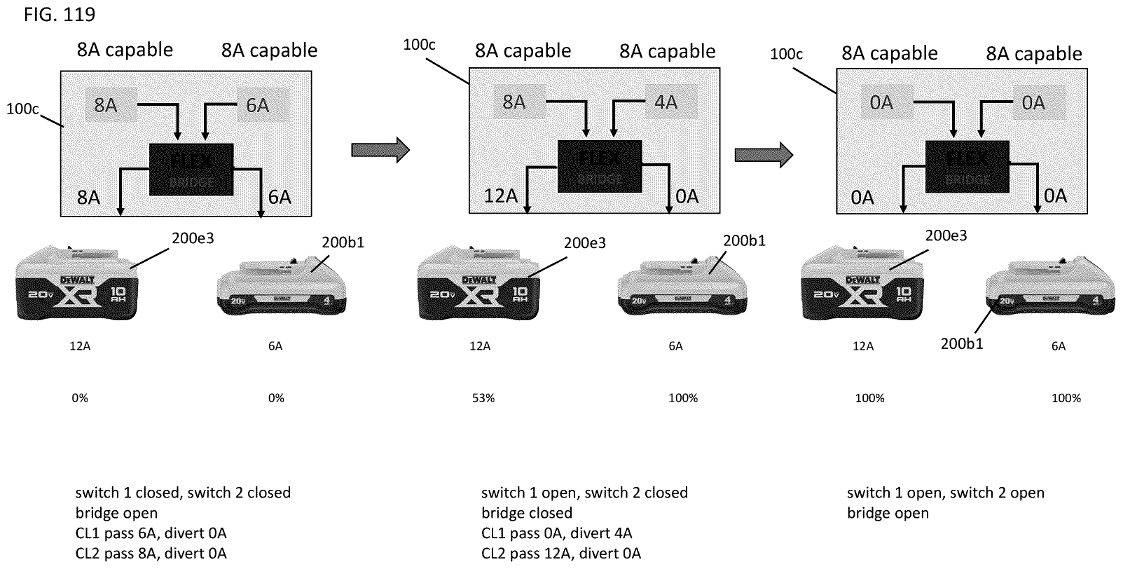

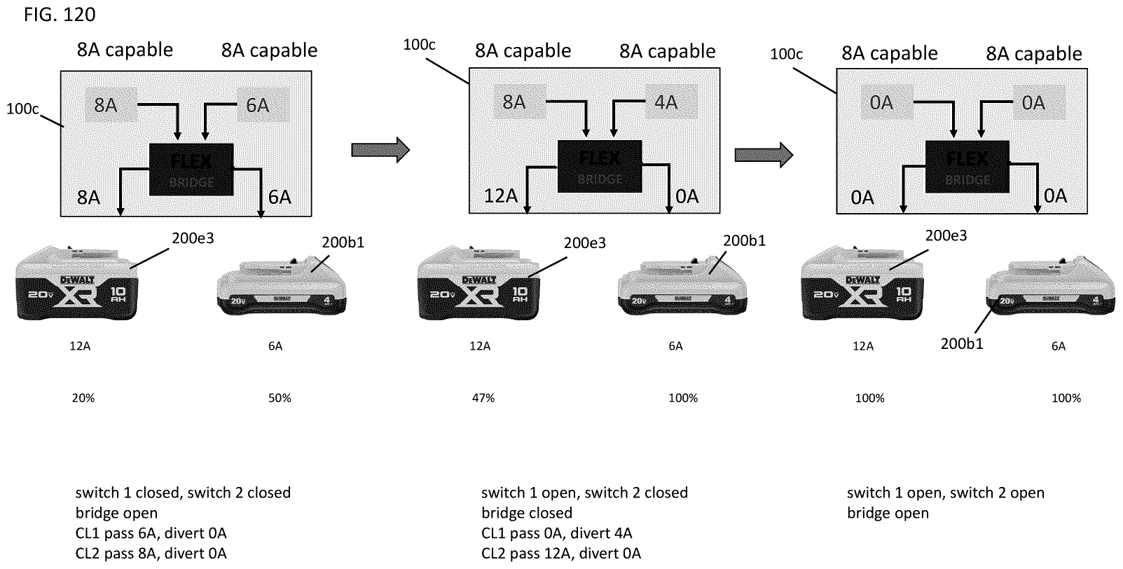

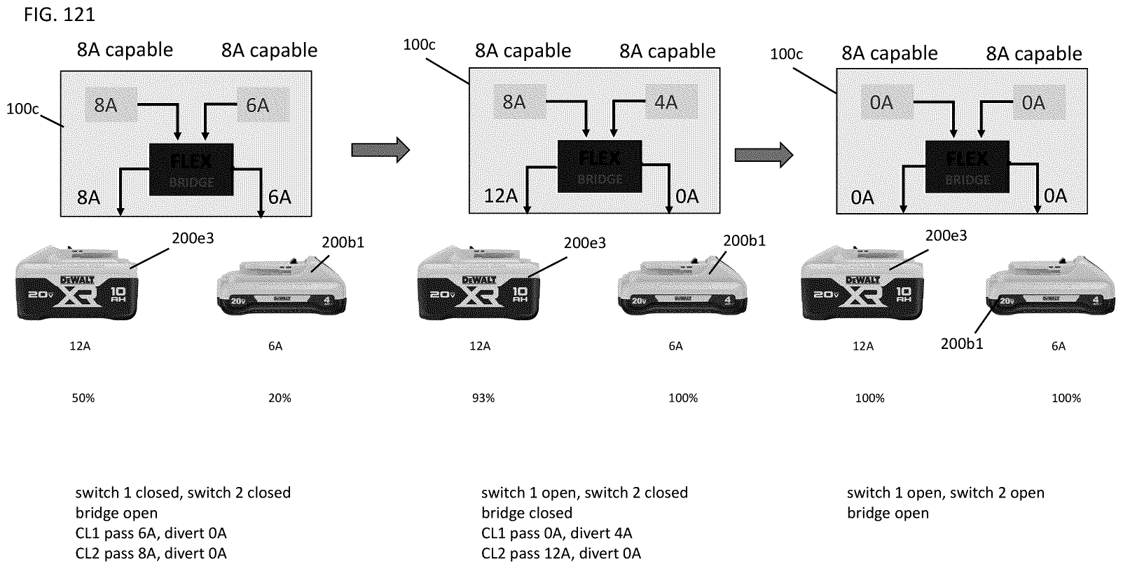

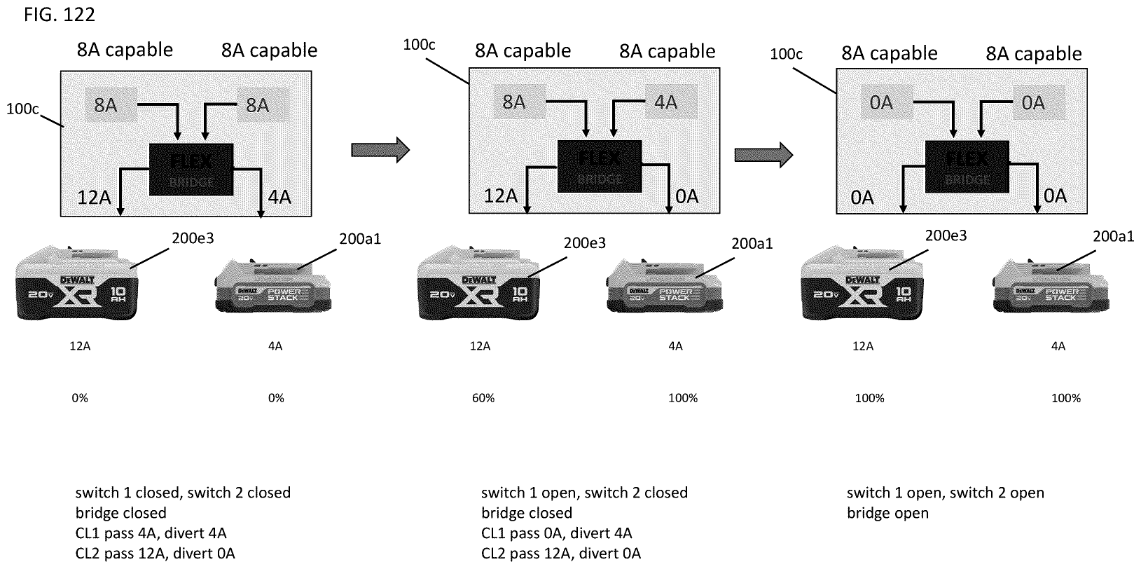

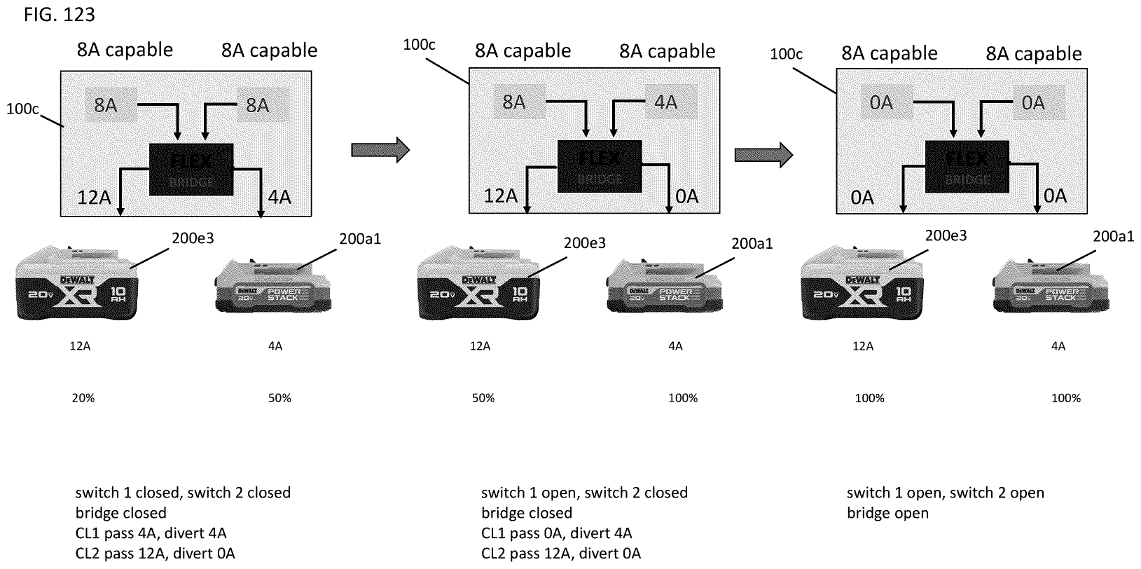

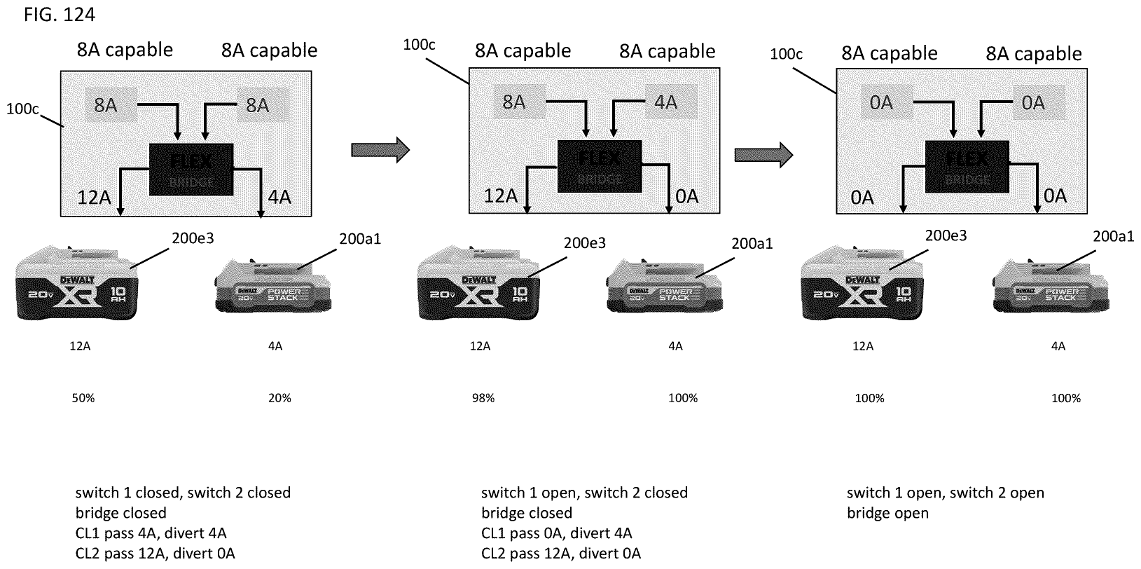

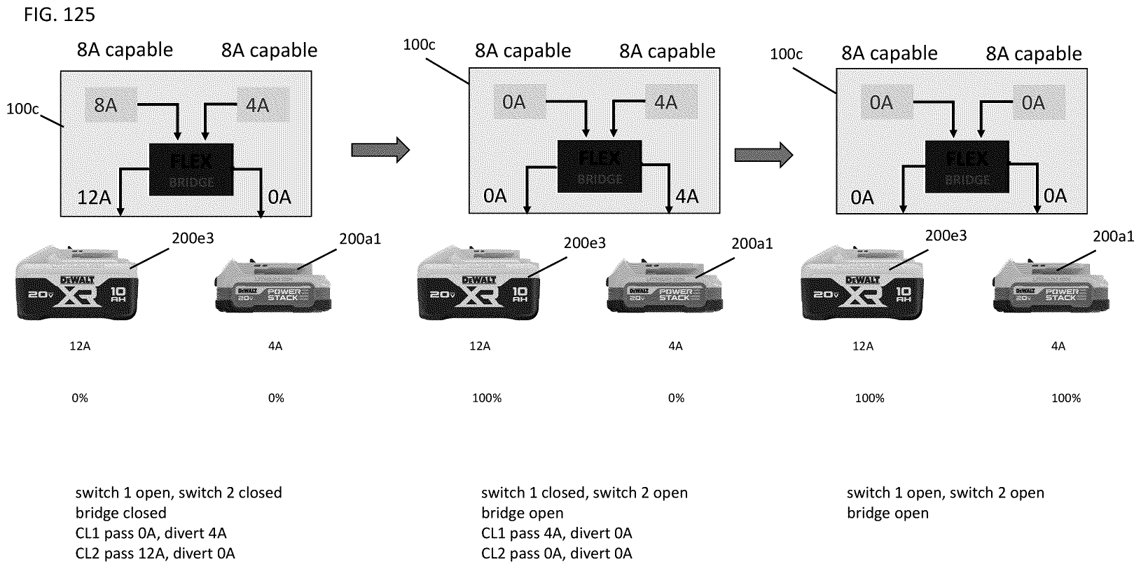

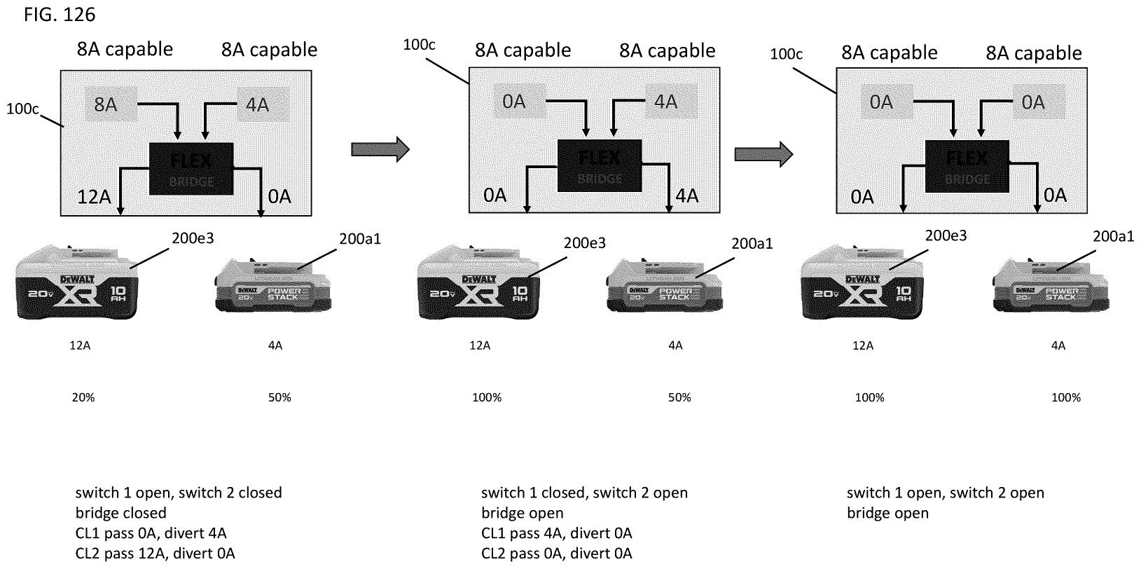

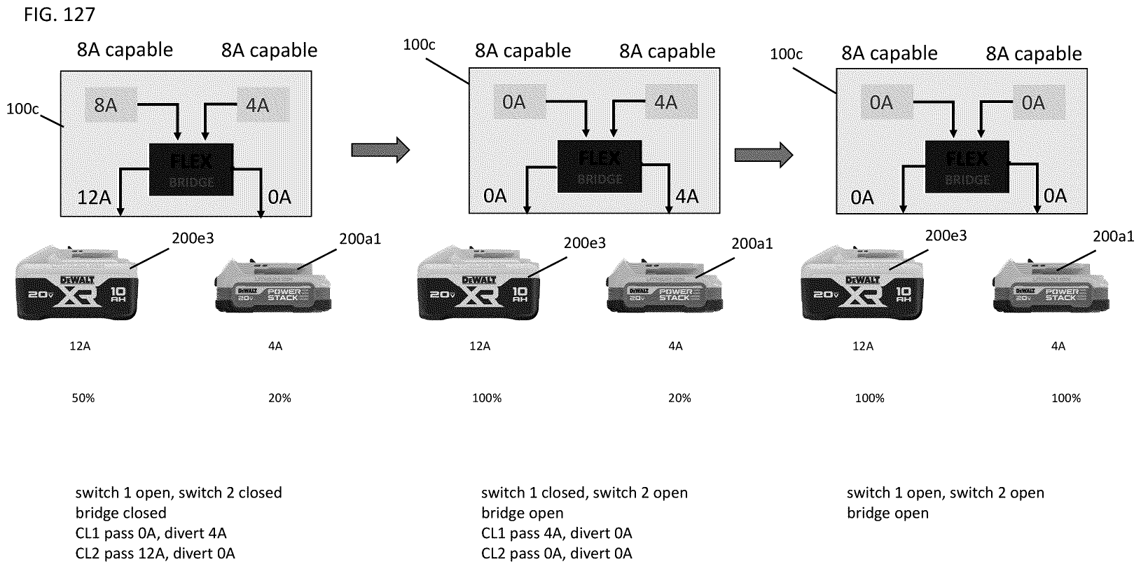

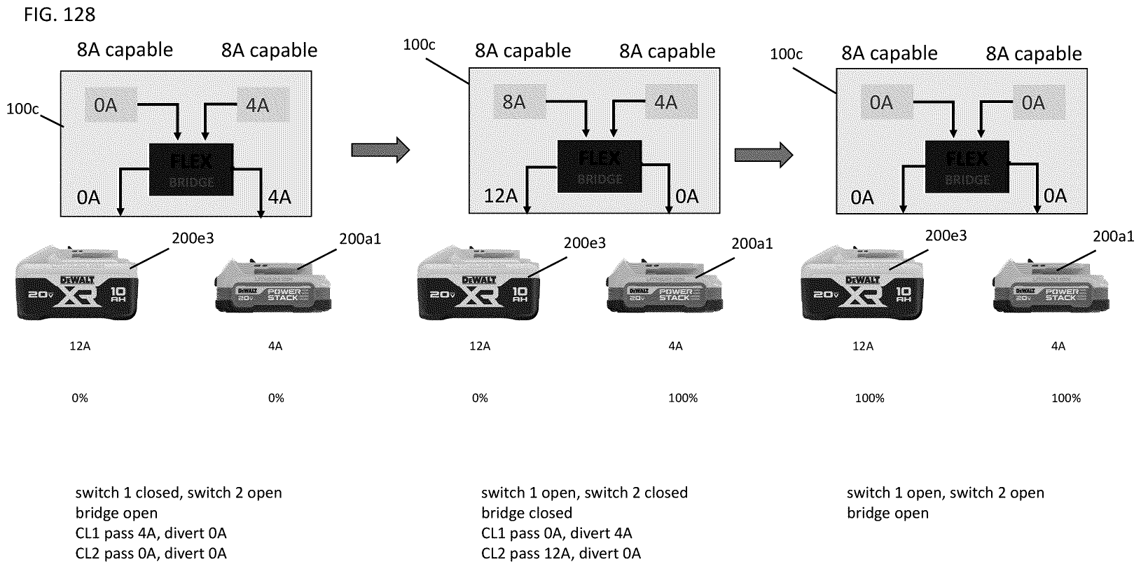

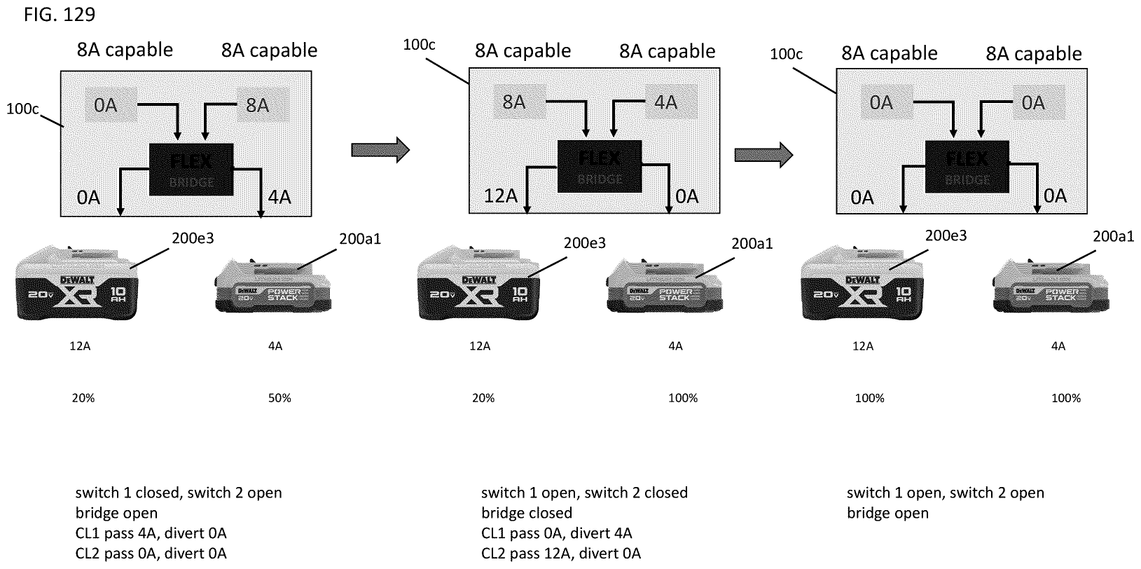

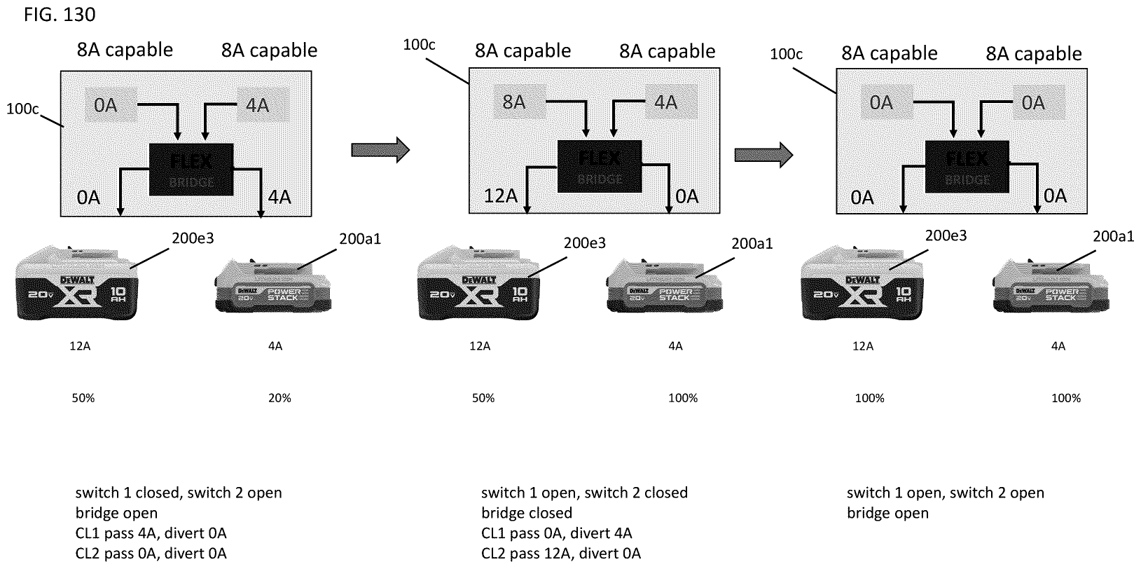

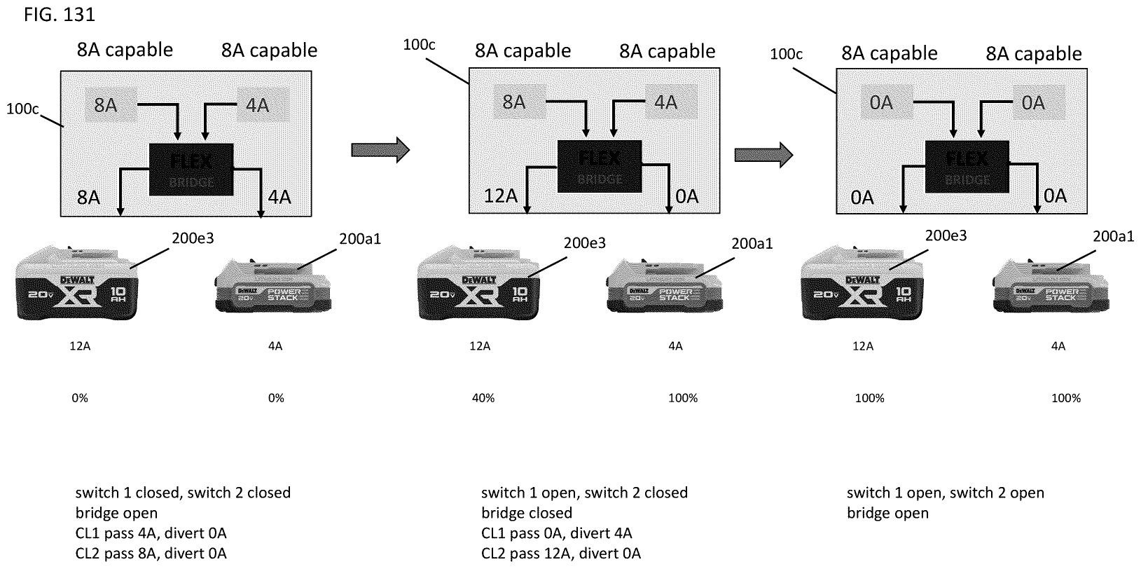

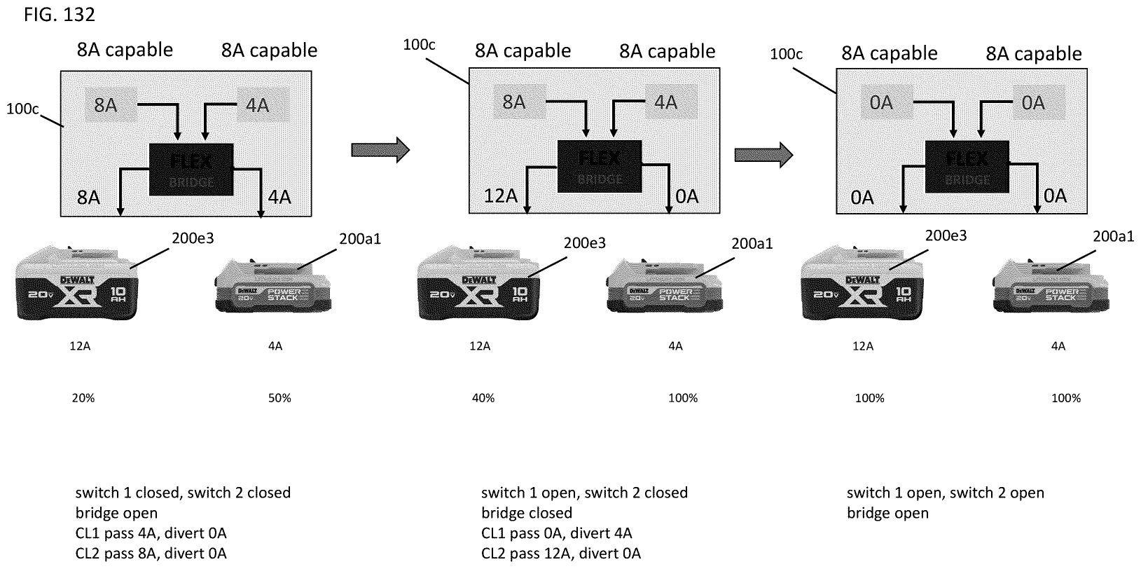

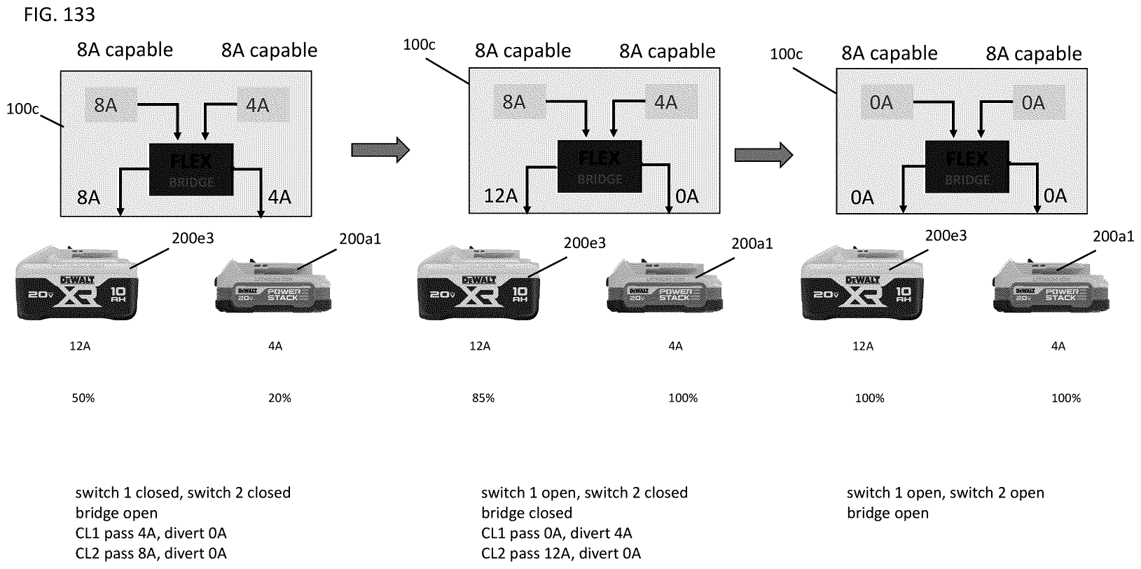

With reference to FIG. 33, there is illustrated an example charger 100d and a two pack, simultaneous power sharing charging scheme. The charger 100d includes a single power supply 104 capable of providing a maximum charging current of 16 A. In alternate embodiments, the charger 100d may include a power supply that is capable of providing a maximum charging current greater than 16 A or less than 16 A. In this example embodiment, with reference to FIG. 134B, the bridge assembly circuit 108 may include a pair of buck converter circuits electrically connected to the power supply 104. Furthermore, each of the buck converter circuits is electrically coupled to the MCU 106 in order to enable the MCU 106 to configure the buck converter circuit to adjust the amount of charging current the buck converter circuit allows to pass to a respective port 102a, 102b. In this charging scheme, a first battery pack 200a1 having a maximum capable charge rate of 4 A is coupled to the first port 102a and a second battery pack 200g3 having a maximum capable charge rate of 16 A is coupled to the second port 102b. In this example, both battery packs may be coupled to the charger 100d, for all intents and purposes, at the same time or the second battery pack may be coupled to the charger after charging has already begun on the first battery pack or the first battery pack may be coupled to the charger after charging has already begun on the second battery pack. In this example, the power supply 104 is configured to provide a charging current of 16 A. Furthermore, the bridge assembly circuit 108 is configured to direct 4 A of the charging current from the power supply 104 to the first port 102a such that the first battery pack 200a1 is charged at a 4 A charge rate and direct 12 A of charging current from the power supply 104 to the second port 102b to charge the second battery pack 200g3 is charged at a 12 A charge rate. As illustrated in FIG. 34, if the first battery pack 200a1 is fully charged before the second battery pack 200g3 is fully charged, the bridge assembly circuit 108 is reconfigured to direct OA of the charging current from the power supply 104 to the first port 102a so that the first battery pack 200a1 is not charged and direct 16 A of the charging current to the second port 102b such that the second battery pack 200g3 is charged at a 16 A rate. In this instance, any time there are two battery packs coupled to the charger, the charger 100c is configured to first charge the battery pack having the lower capacity at its maximum capable charge rate while charging the battery pack having the higher capacity using the remaining available charging current and once the battery pack having the lower capacity has been fully charged then charge the battery pack having the higher capacity at its maximum charge rate until it has been fully charged. In this embodiment, the MCU 106 initially configures the first buck converter circuit to pass 4 A of charging current to the first port 102a and configures the second buck converter circuit to pass 12 A of charging current to the second port 102b. Once the first battery pack 200a1 has been fully charged, the MCU 106 reconfigures the first buck converter circuit to pass OA of charging current to the first port 102a and reconfigures the second buck converter circuit to pass 16 A to the second port 102b.

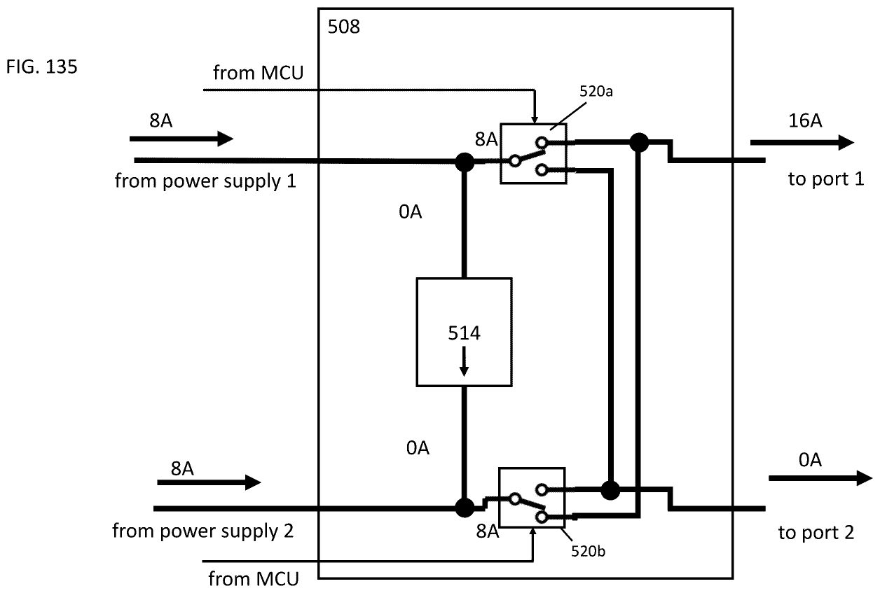

Referring to FIGS. 135-139, there is illustrated an alternate embodiment of the bridge assembly circuit 108. Similar to the previously described bridge assembly circuit 108, this bridge assembly circuit 508 is electrically coupled to the MCU 106 and receives charging current from the first power supply 104a and the second power supply 104b. The bridge assembly circuit 508 may include a first switch 520a and a second switch 520b. The first switch 520a and the second switch 520b may be single throw, double pole switches. Each switch 520a, 520b may have a first state in which the input terminal is connected to a first output terminal and a second state in which the input terminal is connect to a second output terminal. With regard to the first switch 520a, the first output terminal is electrically coupled to the first port 102a and the second output terminal is electrically coupled to the second port 102b. With regard to the second switch 520b, the first output terminal is electrically coupled to the second port 102b and the second output terminal is electrically coupled to the first port 102a. The switches may also be implemented as relays. The switches 520a, 520b are electrically coupled to the MCU 106 and the MCU 106 controls the switches 520a, 520b to change the switches 520a, 520b from the first state to the second state or vice versa. The bridge assembly circuit 508 may also include a current limiting circuit 514. The current limiting circuit 514 may be implemented as a buck converter circuit. In this example embodiment, the current limiting circuit 514 has an input terminal coupled to the first power supply 104a to receive charging current from the first power supply 104a and an output terminal coupled to the second power supply 104b to pass charging current to add to charging current provided by the second power supply 104b.

In a first instance, as illustrated in FIG. 135, the charger 100c having a bridge assembly circuit 508, is to be configured to provide 8 A of charging current to the first port 102a and 8 A of charging current to the second port 102b. As such, the first power supply 104a is configured to provide 8 A of charging current and the second power supply 104b is configured to provide 8 A of charging current. The current limiting circuit 514 is configured not to pass any charging current. The first switch 520a is configured to be in a first state and the second switch 520b is configured to be in a first state. In this configuration, the 8 A of charging current from the first power supply 104a is provided to the first port 102a and the 8 A of charging current from the second power supply 104b is provided to the second port 102b.

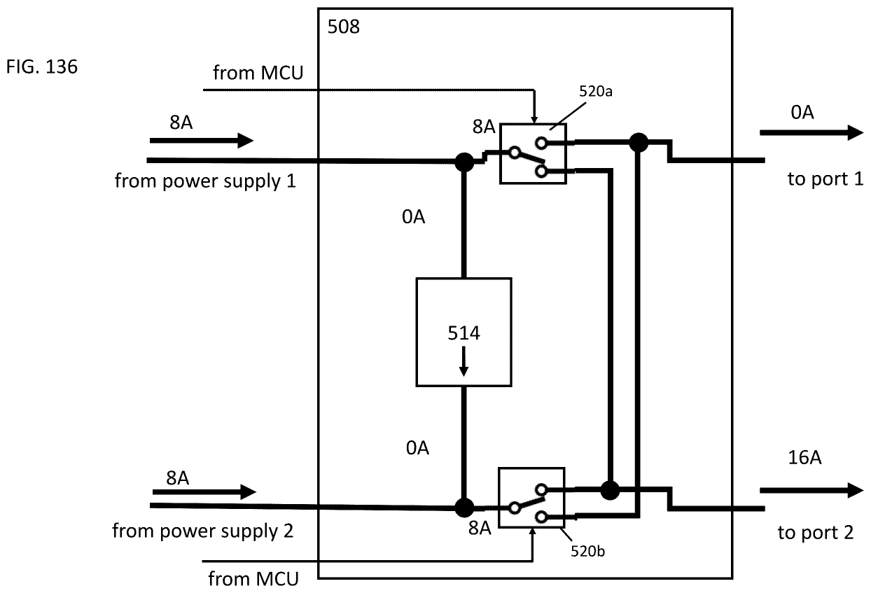

In a second instance, as illustrated in FIG. 136, the charger 100c having a bridge assembly circuit 508, is to be configured to provide 16 A of charging current to the first port 102a and OA of charging current to the second port 102b. As such, the first power supply 104a is configured to provide 8 A of charging current and the second power supply 104b is configured to provide 8 A of charging current. The current limiting circuit 514 is configured not to pass any charging current. The first switch 520a is configured to be in a first state and the second switch 520b is configured to be in a second state. In this configuration, 8 A of charging current from the first power supply 104a is passed through the first switch 520a and provided to the first port 102a and 8 A of charging current from the second power supply 104b is passed through the second switch 520b and provided to the first port 102a (for a total of 16 A of charging current to the first port 102a) and OA of charging current is provided to the second port 102b.

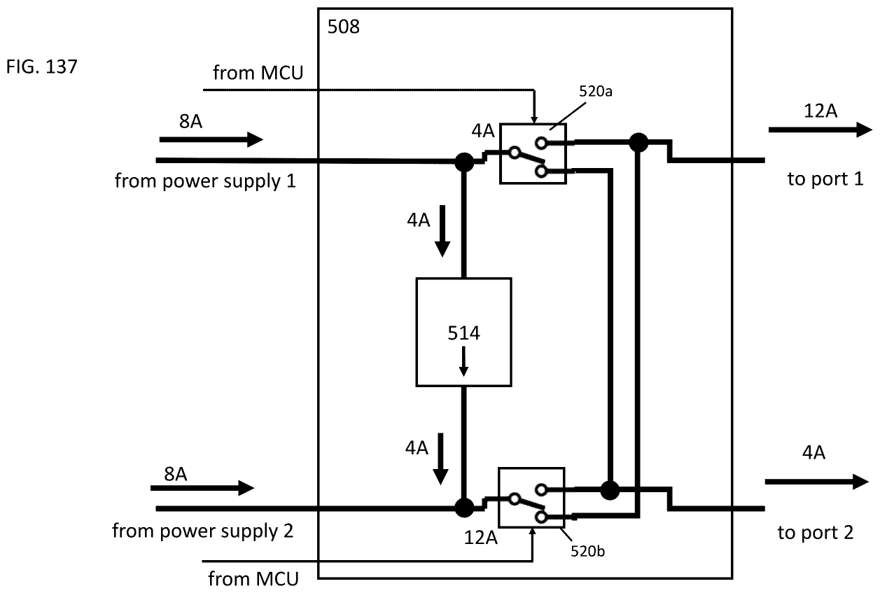

In a third instance, as illustrated in FIG. 137, the charger 100c having a bridge assembly circuit 508, is to be configured to provide OA of charging current to the first port 102a and 16 A of charging current to the second port 102b. As such, the first power supply 104a is configured to provide 8 A of charging current and the second power supply 104b is configured to provide 8 A of charging current. The current limiting circuit 514 is configured not to pass any charging current. The first switch 520a is configured to be in a second state and the second switch 520b is configured to be in a first state. In this configuration, 8 A of charging current from the first power supply 104a is passed through the first switch 520a and provided to the second port 102b and 8 A of charging current from the second power supply 104b is passed through the second switch 520b and provided to the second port 102b (for a total of 16 A of charging current to the second port 102b) and OA of charging current is provided to the first port 102a.

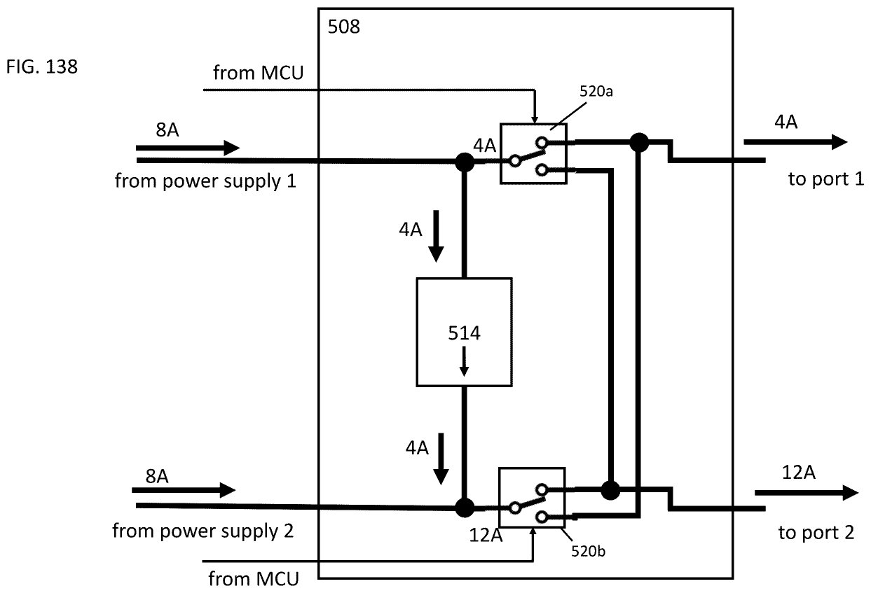

In a fourth instance, as illustrated in FIG. 138, the charger 100c having a bridge assembly circuit 508, is to be configured to provide 12 A of charging current to the first port 102a and 4 A of charging current to the second port 102b. As such, the first power supply 104a is configured to provide 8 A of charging current and the second power supply 104b is configured to provide 8 A of charging current. The current limiting circuit 514 is configured to pass 4 A of charging current from the first power supply 104a to add to the charging current provided by the second power supply 104b. The first switch 520a is configured to be in a second state and the second switch 520b is configured to be in a second state. In this configuration, 4 A of charging current from the first power supply 104a is passed through the first switch 520a and provided to the second port 102b and 4 A of charging current from the first power supply 104a and 8 A of charging current from the second power supply 104b is passed through the second switch 520b and provided to the first port 102a (for a total of 12 A of charging current to the first port 102a).

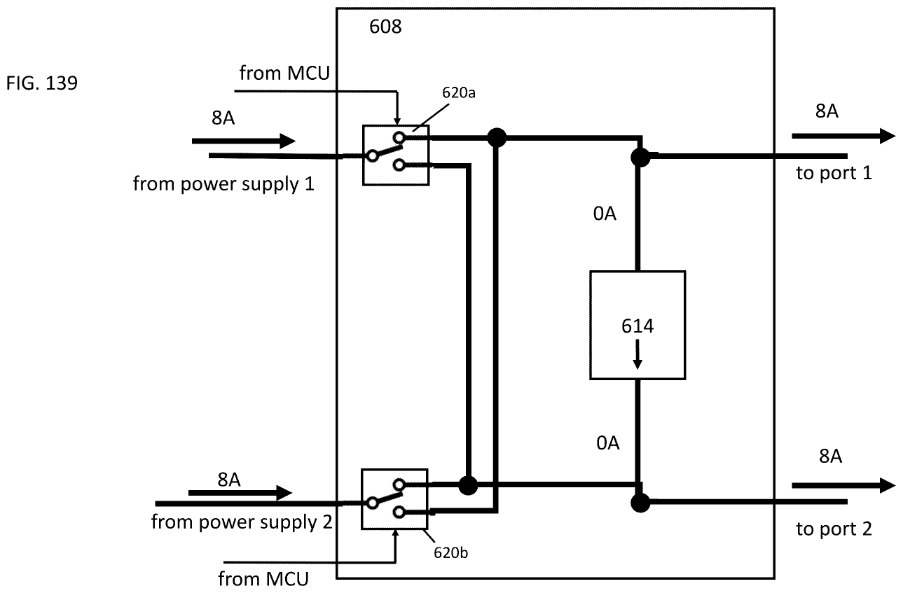

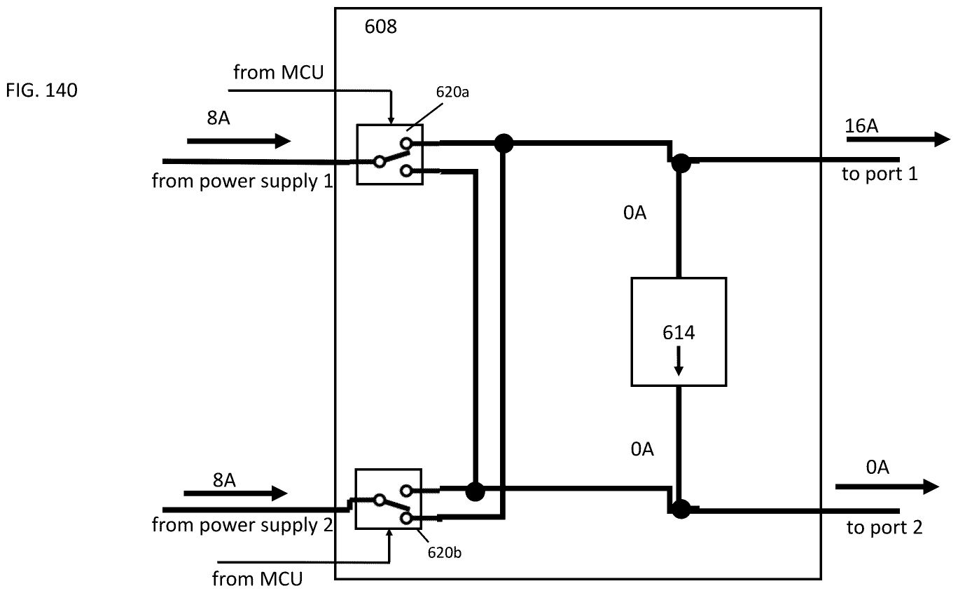

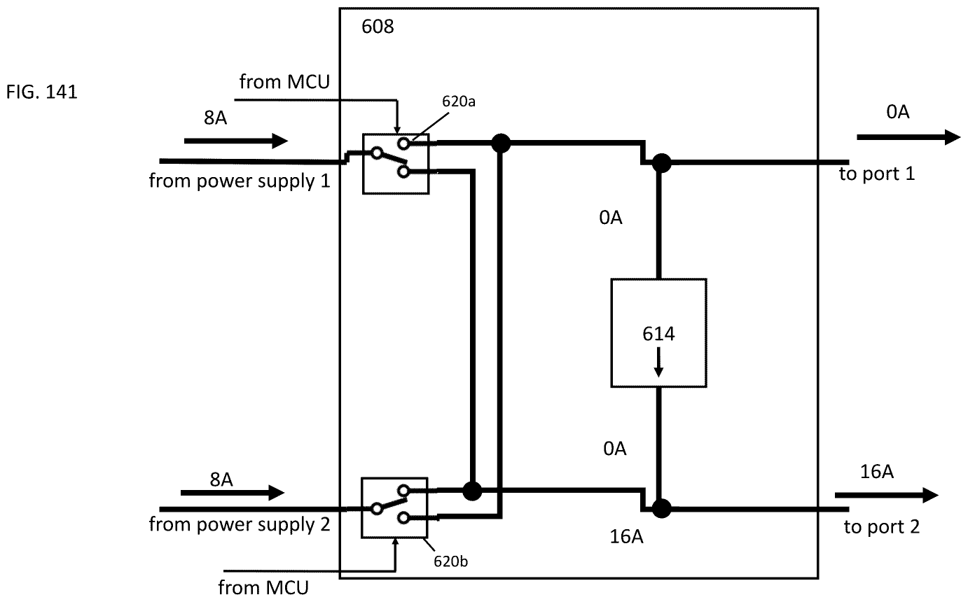

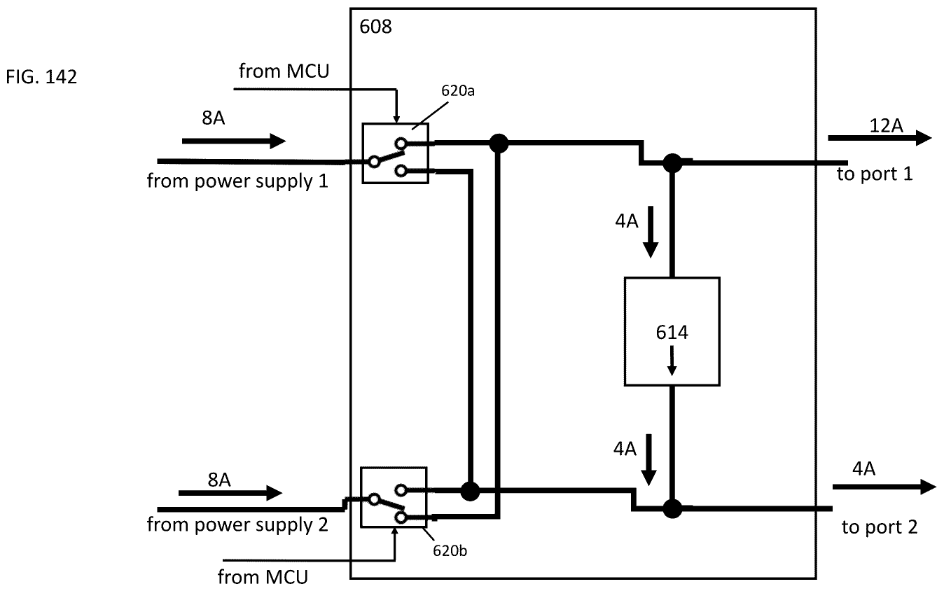

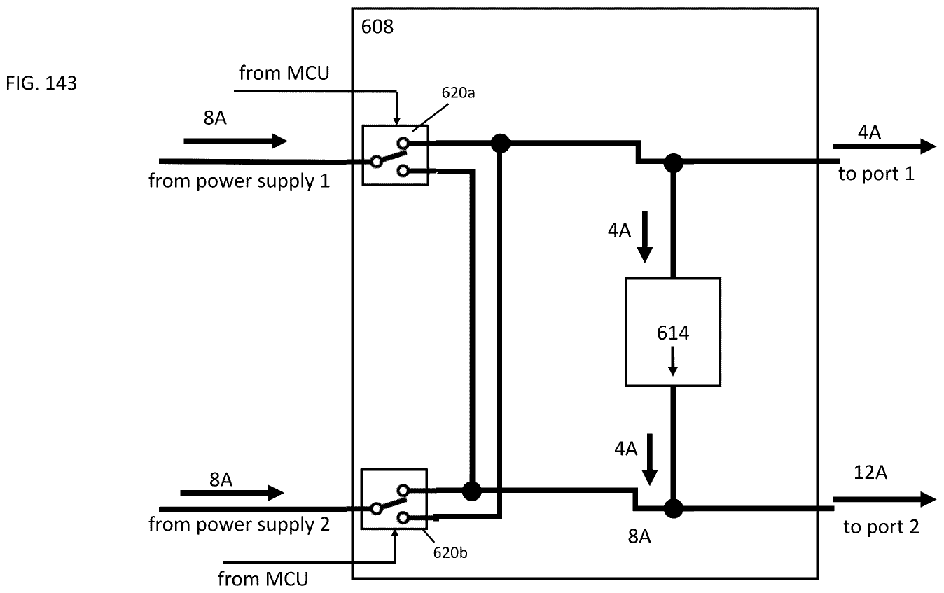

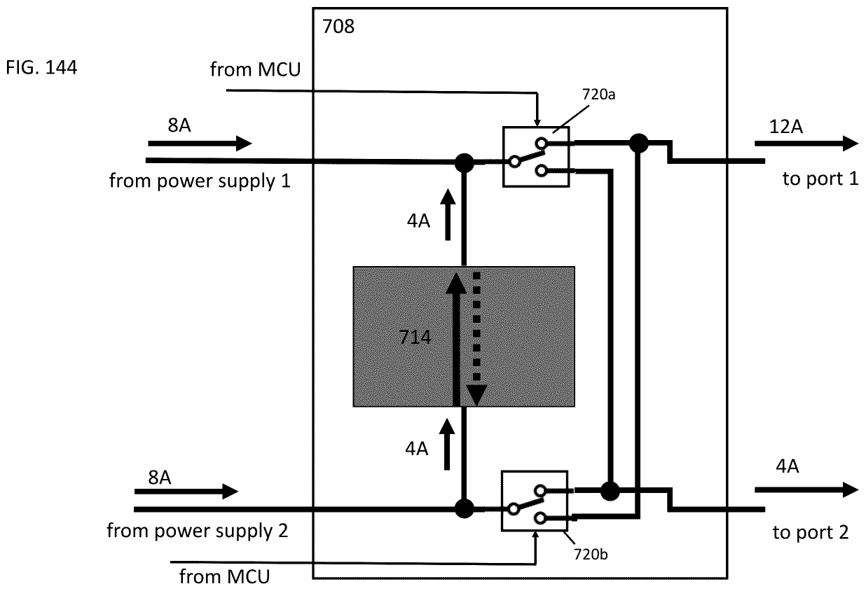

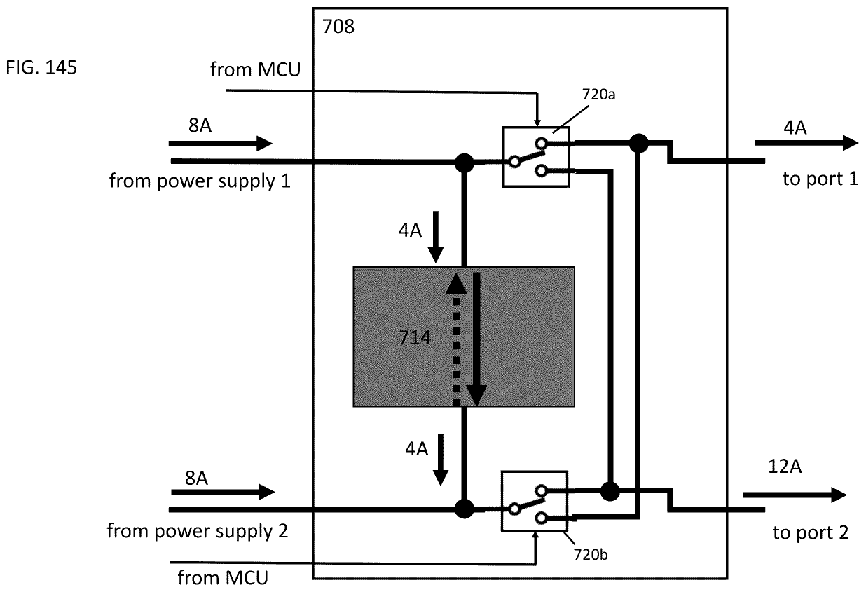

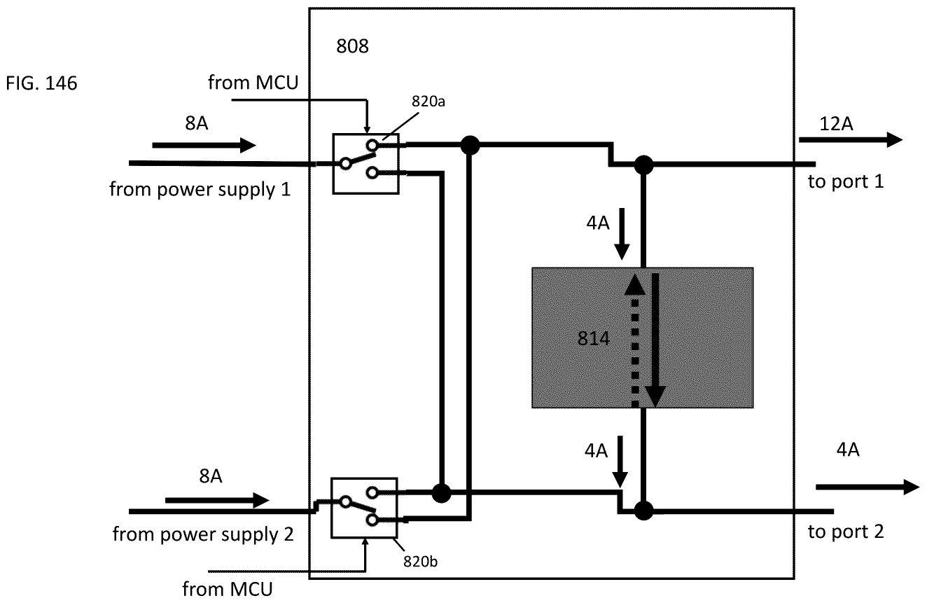

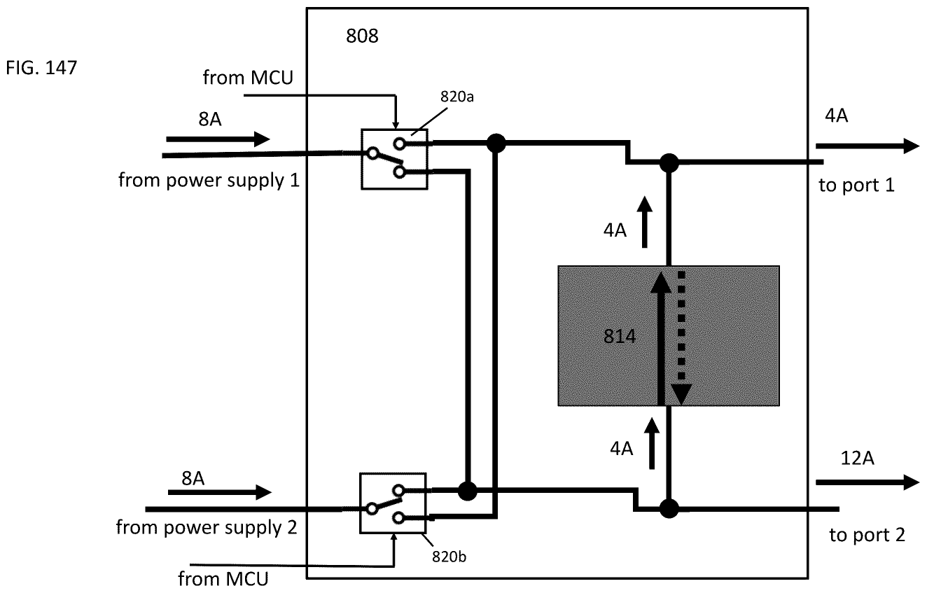

In a fifth instance, as illustrated in FIG. 139, the charger 100c having a bridge assembly circuit 508, is to be configured to provide 4 A of charging current to the first port 102a and 12 A of charging current to the second port 102b. As such, the first power supply 104a is configured to provide 8 A of charging current and the second power supply 104b is configured to provide 8 A of charging current. The current limiting circuit 514 is configured to pass 4 A of charging current from the first power supply 104a to add to the charging current provided by the second power supply 104b. The first switch 520a is configured to be in a first state and the second switch 520b is configured to be in a first state. In this configuration, 4 A of charging current from the first power supply 104a is passed through the first switch 520a and provided to the first port 102a and 4 A of charging current from the first power supply 104a and 8 A of charging current from the second power supply 104b is passed through the second switch 520b and provided to the second port 102b (for a total of 12 A of charging current to the second port 102b).

In other instances, similar to the examples described above, the power supplies 104a, 104b may be configured to provide less than the maximum charging current that they are capable of in order to reduce the amount of charging current received at the ports 102a, 102b and the current limiting circuit 514 may be configured to pass more or less charging current to adjust the amount of charging current received at the ports 102a, 102b.

Numerous modifications may be made to the exemplary implementations described above. These and other implementations are within the scope of this application.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A battery pack charger, comprising:
a housing;
a first receptacle incorporated in the housing for receiving a battery pack;
a second receptacle incorporated in the housing for receiving a battery pack;
a first AC to DC power supply housed within the housing;
a second AC to DC power supply housed within the housing;
a processing unit housed within the housing, the processing unit electrically coupled to the first power supply to enable the processing unit to configure the first power supply to provide an amount of charging current and electrically coupled to the second power supply to configure the second power supply to provide an amount of charging current; and
a bridge assembly circuit housed within the housing, the bridge assembly circuit electrically coupled to the first power supply and the second power supply to receive the amount charging current from the first power supply and the amount of charging current from the second power supply and electrically coupled to the processing unit to enable the processing unit to configure the bridge assembly circuit to direct all of or less than all of the amount of charging current from the first power supply to the first receptacle and all of or less than all of the amount of charging current from the second power supply to the first receptacle and all of or less than all of the amount of charging current from the first power supply to the second receptacle and all of or less than all of the amount of charging current from the second power supply to the second receptacle.

2. The battery pack charger, as recited in claim 1, wherein the bridge assembly circuit directs all of the amount of charging current from the first power supply and all of the amount of charging current from the second power supply to the first receptacle.

3. The battery pack charger, as recited in claim 2, wherein the bridge assembly circuit directs all of the amount of charging current from the first power supply and less than all of the amount of charging current from the second power supply to the first receptacle and less than all of the amount of charging current from the second power supply to the second receptacle.

4. The battery pack charger, as recited in claim 1, wherein the bridge assembly circuit comprises at least one current limiting circuit.

5. The battery pack charger, as recited in claim 4, wherein the at least one current limiting circuit is a buck converter circuit.

6. The battery pack charger, as recited in claim 1, wherein the bridge assembly circuit comprises a first switch and a second switch to direct the amount of charging current from the first power supply and the amount of charging current from the second power supply to the first receptacle and/or the second receptacle.
